(19) United States
(12) Patent Application Publication
(10) Pub. No.: US 2008/0248220 A1
(43) Pub. Date: Oct. 9, 2008

(54) Light-Emitting Material and Light-Emitting Device Using the Same

(75) Inventors: Chizu Sekine, Ibaraki (JP); Nobuhiko Akino, Saitama (JP); Satoshi Mikami, Ibaraki (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY,LIMITED

(21) Appl. No.: 10/571,352

(22) PCT Filed: Sep. 10, 2004
(86) PCT No.: PCT/JP04/13589

§ 371 Date: Mar. 10, 2006

(30) Foreign Application Priority Data
Sep. 12, 2003 (JP) 2003-321520
Sep. 29, 2003 (JP) 2003-337306

(51) Int. Cl. C09K 19/38; C08F 228/06; C08F 26/06; H01J 1/63; C08F 32/08

(52) U.S. Cl. 428/1.4; 526/259; 526/256; 526/280; 428/500

(57) ABSTRACT

A light emitting material comprising a conjugated polymer compound (A) containing an aromatic ring in the main chain and a compound (B) showing light emission from the triplet excited state, wherein an energy difference between the vacuum level and the lowest unoccupied orbital (LUMO) level in the ground state, calculated by a computational chemical means, is 1.3 eV or more, or an energy difference between the vacuum level and the lowest unoccupied orbital (LUMO) level in the ground state, experimentally measured, is 2.2 eV or more, in the polymer compound (A), and either the following (Condition 1) or the following (Condition 2) or both of them are satisfied.

(Condition 1): Energy (ES_{A0}) in the ground state of the polymer compound (A), energy (ET_{A}) in the lowest excited triplet state of the polymer compound (A), energy (ES_{B0}) in the ground state of the compound (B) and energy (ET_{B}) in the lowest excited triplet state of the compound (B) satisfy the relation (Eq1):

ET_{A}−ES_{A0}>ET_{B}−ES_{B0} (Eq1)

(Condition 2): The ratio PL_{A}/PL_{B} of photoluminescence intensity (PL_{A}) of the polymer compound (A) to photoluminescence intensity (PL_{B}) of the compound (B) showing light emission from the triplet excited state is 0.8 or less.

### TECHNICAL FIELD

The present invention relates to a light emitting material and a polymer light emitting device.

### BACKGROUND ART

There is known a device using in a light emitting layer a compound showing light emission from the triplet excited state (hereinafter, referred to as triplet light emitting compound in some cases) as a light emitting material used in a light emitting layer of a light emitting device.

When a triplet light emitting compound is used in a light emitting layer, a light emitting material as a composition containing a matrix in addition to this compound is usually used. It is known that a non-conjugated polymer such as polyvinyl carbazole can be suitably used as the matrix (for example, Japanese Patent Application Laid-Open (JP-A) No. 2002-50483).

A conjugated polymer shows high degree of carrier mobility, and when this is used as a matrix, low driving voltage is expected, however, the conjugated polymer is said to be unsuitable for use as a matrix generally because of small lowest excited triplet energy (for example, JP-A No. 2002-241455). Practically, for example, a light emitting material composed of polyfluorene as a conjugated polymer, and a triplet light emitting compound (APPLIED PHYSICS LETTERS, 80, 13, 2308 (2002)) had extremely low light emitting efficiency.

### DISCLOSURE OF THE INVENTION

The present invention has an object of providing a light emitting material comprising a conjugated polymer and a triplet compound, which gives, when used in a light emitting layer of a light emitting device, excellent light emitting efficiency and the like to the device.

That is, the present invention provides a light emitting material comprising a conjugated polymer compound (A) containing an aromatic ring in the main chain and a compound (B) showing light emission from the triplet excited state, wherein an energy difference between the vacuum level and the lowest unoccupied orbital (LUMO) level in the ground state, calculated by a computational chemical means, is 1.3 eV or more, or an energy difference between the vacuum level and the lowest unoccupied orbital (LUMO) level in the ground state, experimentally measured, is 2.2 eV or more, in the polymer compound (A), and either the following (Condition 1) or the following (Condition 2) or both of them are satisfied. (Condition 1): Energy (ES_{A0}) in the ground state of the polymer compound (A), energy (ET_{A}) in the lowest excited triplet state of the polymer compound (A), energy (ES_{B0}) in the ground state of the compound (B) and energy (ET_{B}) in the lowest excited triplet state of the compound (B) satisfy the relation (Eq1):

ET_{A}−ES_{A0}>ET_{B}−ES_{B0} (Eq1)

(Condition 2): The ratio PL_{A}/PL_{B} of photoluminescence intensity (PL_{A}) of the polymer compound (A) to photoluminescence intensity (PL_{B}) of the compound (B) showing light emission from the triplet excited state is 0.8 or less.

### BEST MODES FOR CARRYING OUT THE INVENTION

The light emitting material of the present invention is a light emitting material comprising a conjugated polymer compound (A) containing an aromatic ring in the main chain and a compound (B) showing light emission from the triplet excited state.

The conjugated polymer compound (A) used in the light emitting material of the present invention requires that an energy difference between the vacuum level and the lowest unoccupied orbital (LUMO) level in the ground state, calculated by a computational chemical means, is 1.3 eV or more, or an energy of the lowest unoccupied orbital (LUMO), experimentally measured, is 2.2 eV or more.

A matrix is believed to perform a role of injecting and transporting charges, and an energy difference between the vacuum level and LUMO in the ground state as an indication for easiness of electron injection exerts in influence on driving voltage and light emitting efficiency.

When an energy of LUMO in the ground state of the conjugated polymer compound (A) (energy difference between the vacuum level and LUMO level in the ground state) is experimentally measured, for example, it can be measured by cyclic voltammetry. Namely, a thin film of a light emitting material as a measurement subject is formed on an electrode and reduction wave is measured, and LUMO in the ground state can be obtained from potential of its first reduction wave.

The light emitting material of the present invention requires that either the following (Condition 1) or the following (Condition 2) or both of them are satisfied. (Condition 1): Energy (ES_{A0}) in the ground state of the polymer compound (A), energy (ET_{A}) in the lowest excited triplet state of the polymer compound (A), energy (ES_{B0}) in the ground state of the compound (B) and energy (ET_{B}) in the lowest excited triplet state of the compound (B) satisfy the relation (Eq1):

ET_{A}−ES_{A0}>ET_{B}−ES_{B0} (Eq1)

(Condition 2): The ratio PL_{A}/PL_{B} of photoluminescence intensity (PL_{A}) of the polymer compound (A) to photoluminescence intensity (PL_{B}) of the compound (B) showing light emission from the triplet excited state is 0.8 or less.

The light emitting material of the present invention preferably satisfies both (Condition 1) and (Condition 2).

There is an actual measurement method for determining an energy difference between the ground state and the lowest excited triplet state of the conjugated polymer compound (A) and the compound (B) showing light emission from the triplet excited state in (Eq1) of (Condition 1) (ET_{A}−ES_{A0}, ET_{B}−ES_{B0}, in this order), however, in the present invention, the difference is usually determined by a computational chemical means since relative magnitude correlation between the above-mentioned energy difference of the compound (B) and the above-mentioned energy difference of the conjugated polymer (A) used as a matrix is important for obtaining higher light emission efficiency.

The photoluminescence intensities of the conjugated polymer compound (A) and the compound (B) showing light emission from the triplet excited state in (Condition 2) can be measured by commercially available fluorescence and phosphorescence measuring apparatuses and the like.

A sample can be obtained by using a solution prepared by dissolving a light emitting material as a measurement subject in an organic solvent and forming a thin film of this solution on a quartz substrate by a spin coating method.

The wavelength of exciting light for measuring photoluminescence intensity is usually selected from a wavelength range in which the absorption spectrum of the conjugated polymer compound (A) and the absorption spectrum of the compound (B) showing light emission from the triplet excited state overlap and which is near the longer peak wavelength among respective absorption spectrum peaks.

The light emitting material of the present invention includes a light emitting material comprising a conjugated polymer compound (A) containing an aromatic ring in the main chain and a compound (B) showing light emission from the triplet excited state, wherein energy (ES_{A0}) in the ground state of the polymer compound (A), energy (ET_{A}) in the lowest excited triplet state of the polymer compound (A), energy (ES_{B0}) in the ground state of the compound (B) and energy (ET_{B}) in the lowest excited triplet state of the compound (B) satisfy the relation (Eq1):

ET_{A}−ES_{A0}>ET_{B}−ES_{B0} (Eq1)

and an energy difference between the vacuum level and LUMO, calculated by a computational chemical means, is 1.3 eV or more; and a light emitting material comprising a conjugated polymer compound (A) containing an aromatic ring in the main chain and a compound (B) showing light emission from the triplet excited state, wherein the ratio PL_{A}/PL_{B} of photoluminescence intensity (PL_{A}) of the polymer compound (A) to photoluminescence intensity (PL_{B}) of the compound (B) showing light emission from the triplet excited state is 0.8 or less and an energy difference between the vacuum level and the lowest unoccupied orbital (LUMO), experimentally measured, is 2.2 eV or more.

Among the light emitting materials of the present invention, those satisfying a condition that an energy difference ET_{AB} between energy ET_{A} in the lowest excited triplet state of the polymer compound (A) and energy ET_{B} in the lowest excited triplet state of the compound (B), and a difference EH_{AB} between the highest monopolized orbital (HOMO) energy EH_{A} in the ground state of the polymer compound (A) and HOMO energy EH_{B} in the ground state of the compound (B) satisfy the relation (Eq2):

ET_{AB}≧EH_{AB} (Eq2);

and those satisfying a condition that ES_{A1} in the lowest excited singlet level of the polymer compound (A) and ES_{B1} in the lowest excited singlet level of the compound (B) satisfy the relation (Eq3):

ES_{A1}≧ES_{B1} (Eq3)

are preferable for obtaining higher light emitting efficiency.

Further, it is preferable that energy ET_{A} in the lowest excited triplet state of the polymer compound (A) is 2.6 eV or more and that the EL light emitting peak wavelength is 550 nm or less, for obtaining higher light emitting efficiency.

The mixing proportion of the polymer compound (A) and the compound (B) showing light emission from the triplet excited state is not particularly restricted since it varies depending on the kind of a polymer compound to be combined and a property to be optimized, however, it is usually 0.01 to 80 parts by weight, preferably 0.1 to 60 parts by weight when the amount of the polymer compound (A) is 100 parts by weight.

As the arithmetic chemical means used for obtaining an energy difference between the vacuum level and LUMO, a molecular orbital method, density functional method and the like based on semi-empirical means and non-empirical means are known. For example, for measuring excitation energy, a Hartree-Fock (HF) method or a density functional method may be used. Usually, an energy difference between the ground state and the lowest excited triplet state (hereinafter, referred to as lowest excited triple energy), an energy difference between the ground state and the lowest excited singlet state (hereinafter, referred to as lowest excited singlet energy), the HOMO energy level in the ground state and the LUMO energy level in the ground state, of a triplet light emitting compound and a conjugated polymer compound, are calculated using a quantum chemistry calculation program Gaussian 98.

The lowest excited triplet energy, lowest excited singlet energy, HOMO energy level in the ground state and the LUMO energy level in the ground state for a conjugated polymer compound are calcualted for a monomer (n=1), dimmer (n=2) and trimer (n=3), and for calculation of excitation energy of a conjugated polymer, a method is used in which the results at n=1 to 3 are converted into 1/n function E (1/n) (wherein, E represents an excitation energy value to be obtained such as the lowest excited singlet energy, lowest excited triplet energy and the like) and extrapolated linearly to n=0. When a side chain of longer chain length, for example, is contained in a repeating unit of a conjugated polymer, a chemical structure as a calculation subject can be simplified into a minimum unit at a side chain portion (for example, when an octyl group is carried as a side chain, the side chain is calculated as a methyl group). For HOMO, LUMO, single excitation energy and triplet excitation energy in a copolymer, the same calculation means as in the case of the above-mentioned homopolymer can be used using a minimum unit estimated from the copolymerization ratio as a unit.

A conjugated polymer compound (A) containing an aromatic ring in the main chain contained in a light emitting material of the present invention is described.

The conjugated polymer compound is a molecule in which multiple bonds and single bonds are connected in long repetition as described, for example, in “Yuki EL no hanashi” (Katsumi Yoshino, Nikkan Kogyo Shimbun), p. 23, and the conjugated polymer compound (A) used in the present invention is that in which an aromatic ring is contained in the main chain and an energy difference between the vacuum level and LUMO in the ground state calculated by a computational chemical means is 1.3 eV or more or energy of the lowest unoccupied orbital (LUMO) experimentally measured is 2.2 eV or more.

In the conjugated polymeric compound (A), those having the repeating unit represented by the below formula (1) are preferable, in view of high light emitting efficiency.

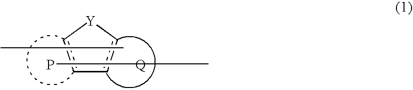

(wherein, Ring P and Ring Q each independently represent an aromatic ring, but Ring P may be either existent or non-existent. When Ring P is existent, two connecting bonds respectively are on Ring P and/or Ring Q, and when Ring P is non-existent, two connecting bonds respectively are on 5 membered ring containing Y, and/or Ring Q. The aromatic ring and/or a 5 membered ring containing Y may carry a substituent selected from an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group, and cyano group. Y represents —O—, —S—, —Si(R₁)(R₂)—, —P(R₃)—, or —PR₄(═O)—R₁, R₂, R₃ and R₄ each independently represent an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, silyloxy group, substituted silyloxy group, monovalent heterocyclic group, or halogen atom.)

As the aromatic ring in the above Formula (1), exemplified are: aromatic hydrocarbon rings, such as a benzene ring, naphthalene ring, anthracene ring, tetracene ring, pentacene ring, pyrene ring, and phenanthrene ring; and heteroaromatic rings, such as a pyridine ring, bipyridine ring, phenanthroline ring, quinoline ring, isoquinoline ring, thiophene ring, furan ring, and pyrrole ring.

As the structures represented by the above formula (1), exemplified are:

Structures represented by the below formula (1-1), (I-2) or (1-3);

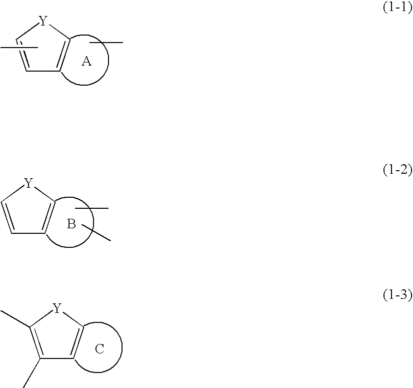

(wherein Ring A, Ring B and Ring C each independently represent an aromatic ring. Formulas (1-1), (1-2) and (1-3) may contain respectively, a substituent selected from the group consisting of alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acidimide group, monovalent heterocyclic group, carboxyl group, substituted carboxyl group, and cyano group. Y represents the same meaning as the above.)

Structures represented by the below formula (1-4) or (1-5);

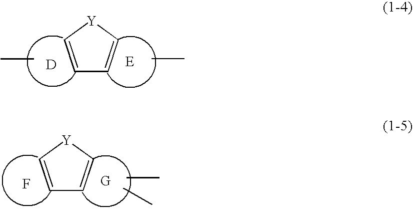

(wherein Ring D, Ring E, Ring F and Ring G each independently represent an aromatic ring, which may contain respectively, a substituent selected from the group consisting of alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acidimide group, monovalent heterocyclic group, carboxyl group, substituted carboxyl group, and cyano group. Y represents the same meaning as the above.), and structures represented by the below formula (I-4) or (1-5) are preferable.

Y is preferably a sulfur atom or an oxygen atom in view of high light emitting efficiency.

As the aromatic rings in the above formula (1-1), (I-2), (I-3), (I-4) and (I-5), exemplified are: aromatic hydrocarbon rings such as a benzene ring, naphthalene ring, anthracene ring, tetracene ring, pentacene ring, pyrene ring, and phenanthrene ring; and heteroaromatic rings such as pyridine ring, bipyridine ring, phenanthroline ring, quinoline ring, isoquinoline ring, thiophene ring, furan ring, and a pyrrole ring.

Concrete examples of formula (1-1), shown as unsubstituted structure, include followings.

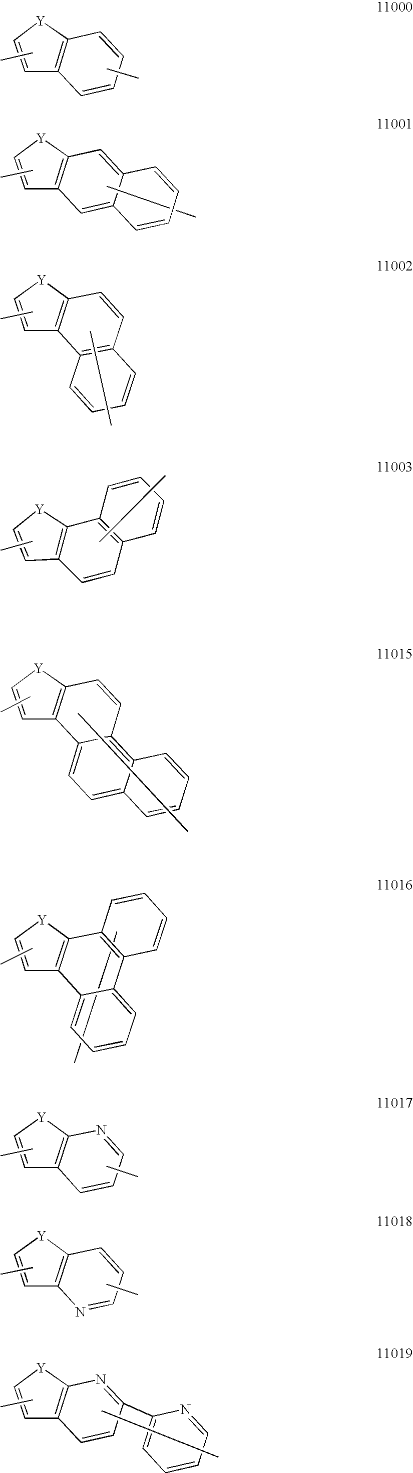

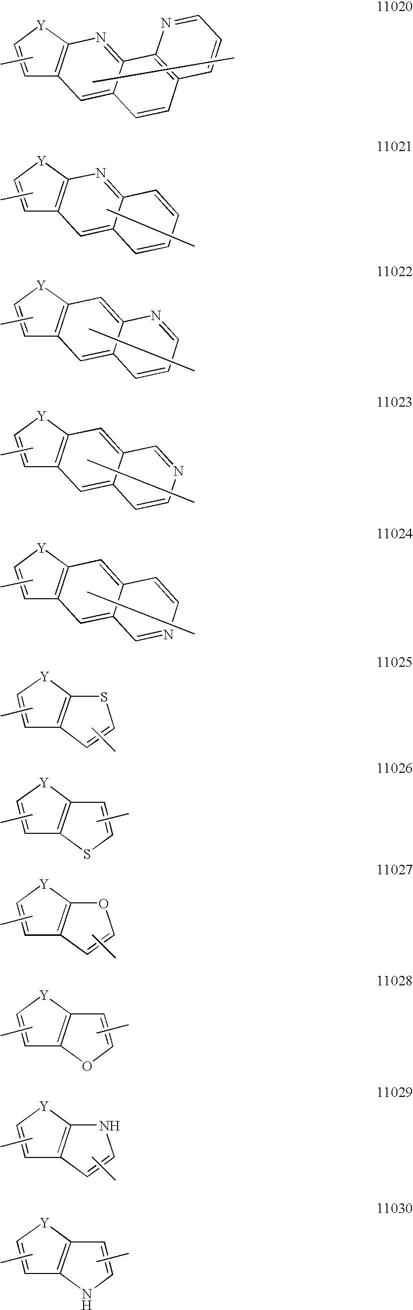

Concrete examples of formula (1-2), shown as unsubstituted structure, include followings.

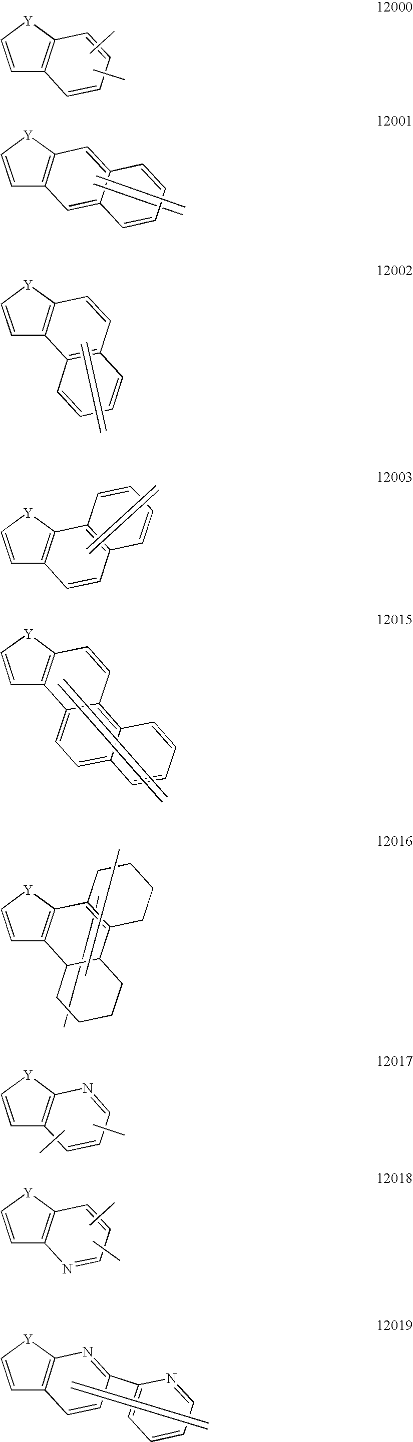

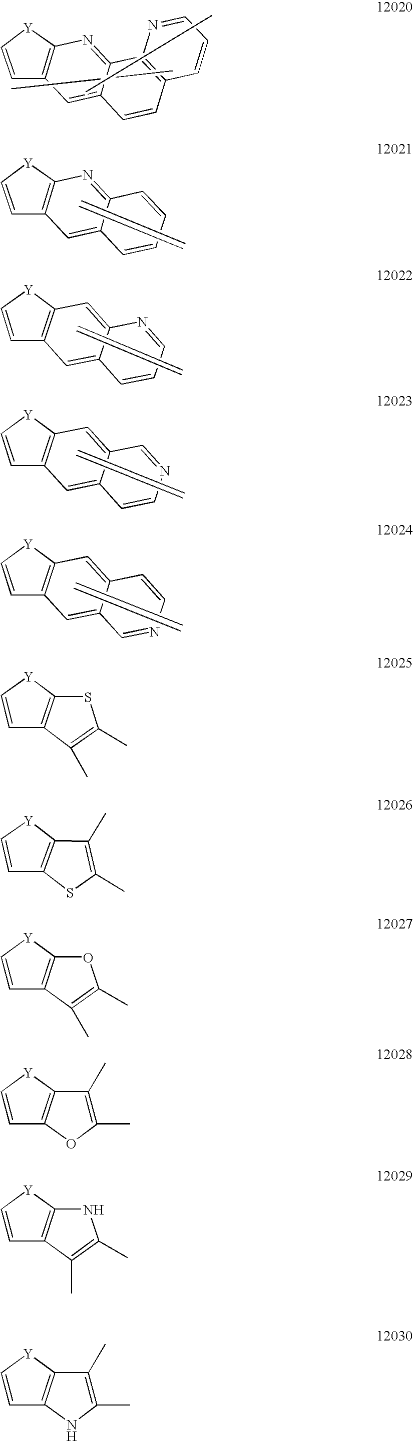

Concrete examples of formula (1-3), shown as unsubstituted structure, include followings.

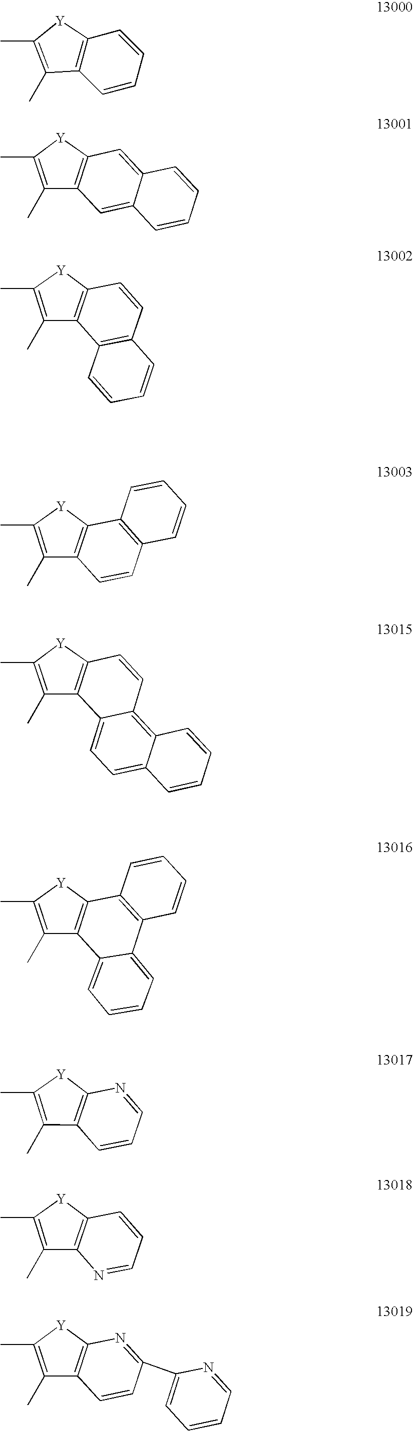

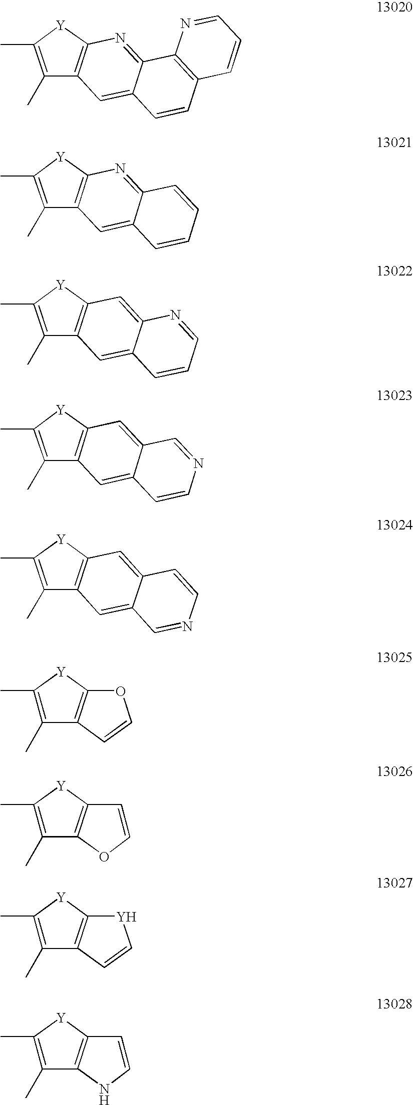

Concrete examples of formula (1-4), shown as unsubstituted structure, include followings.

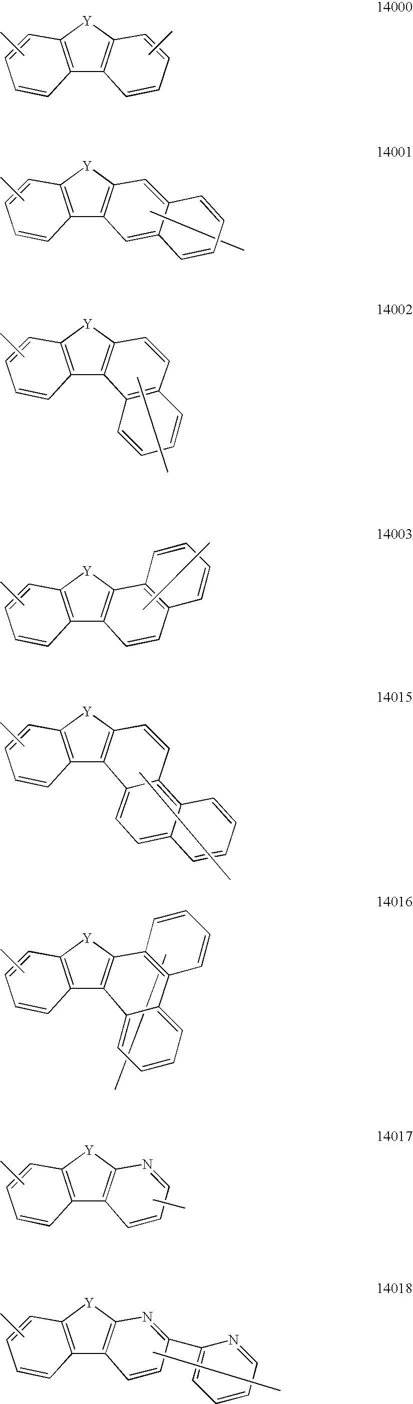

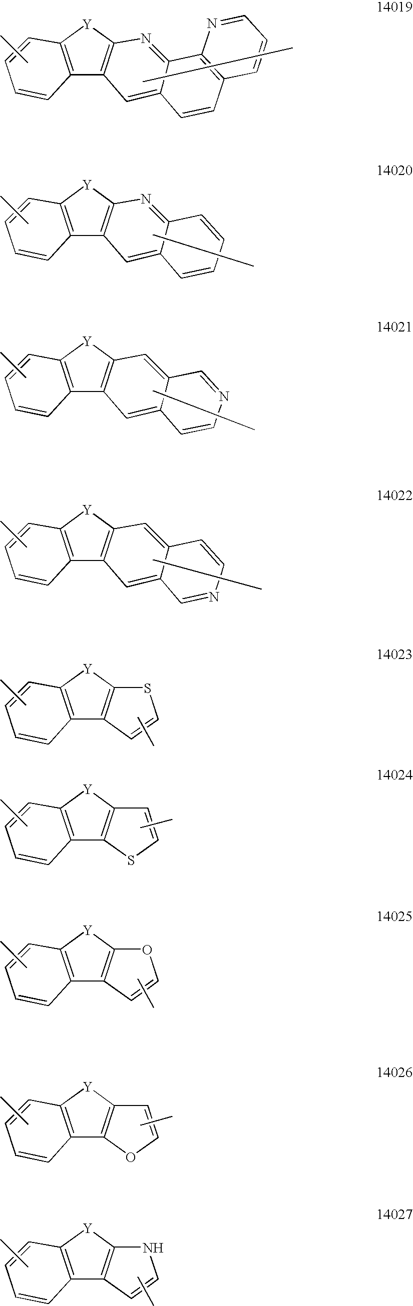

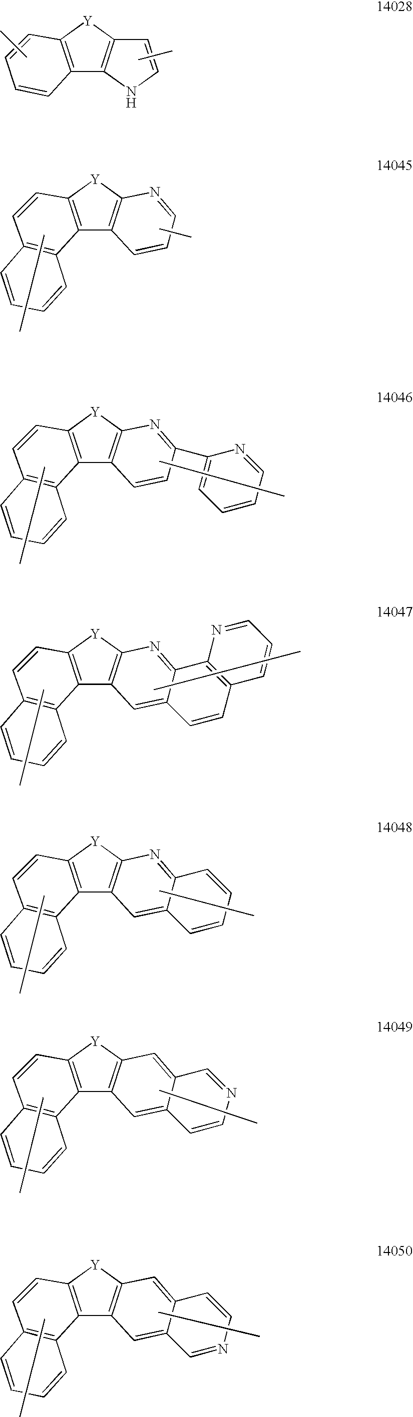

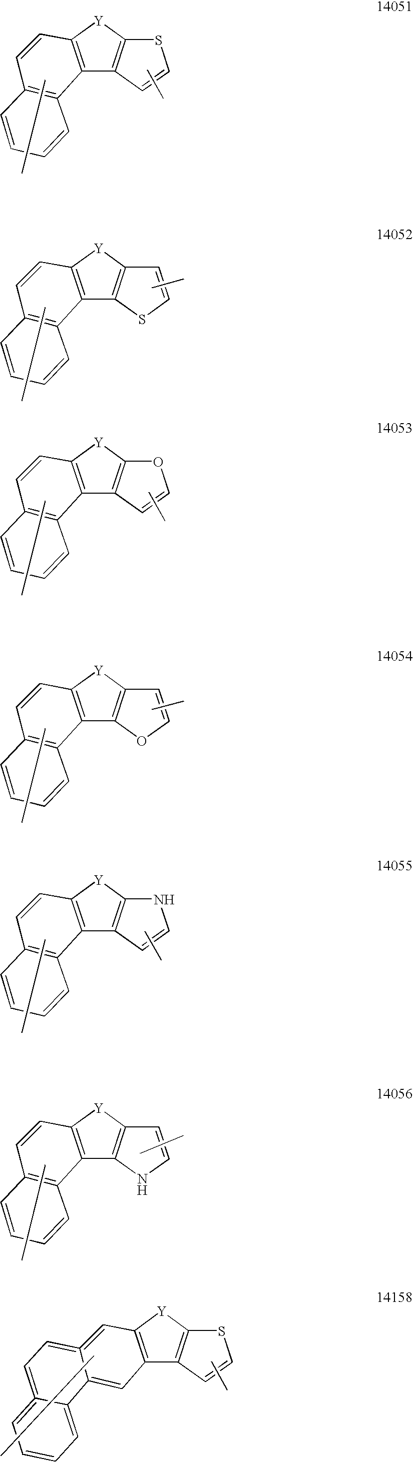

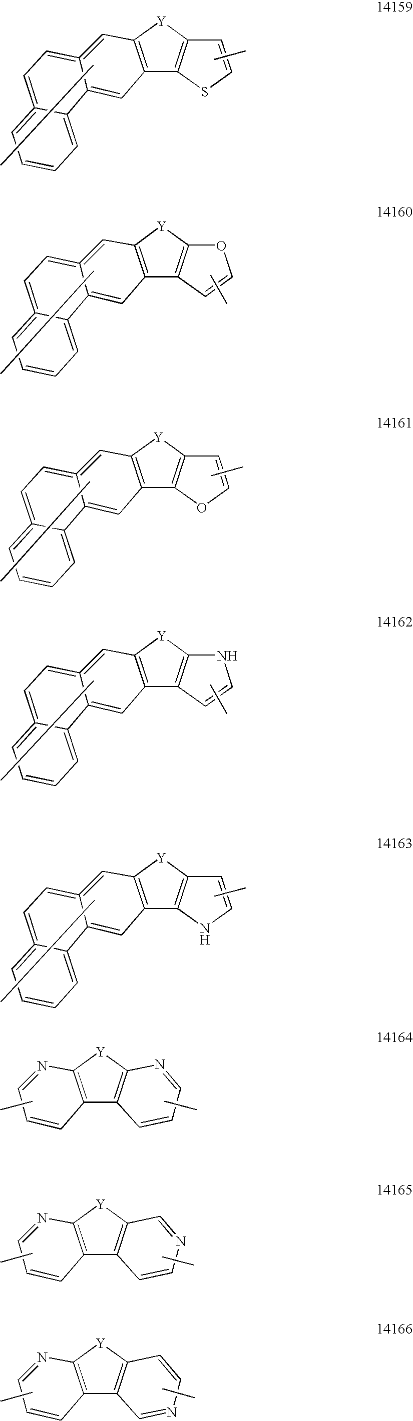

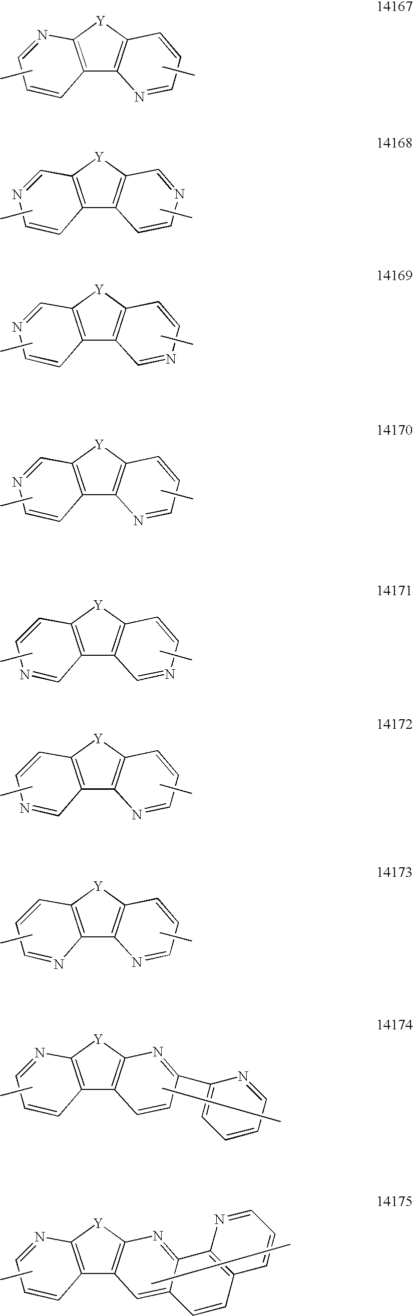

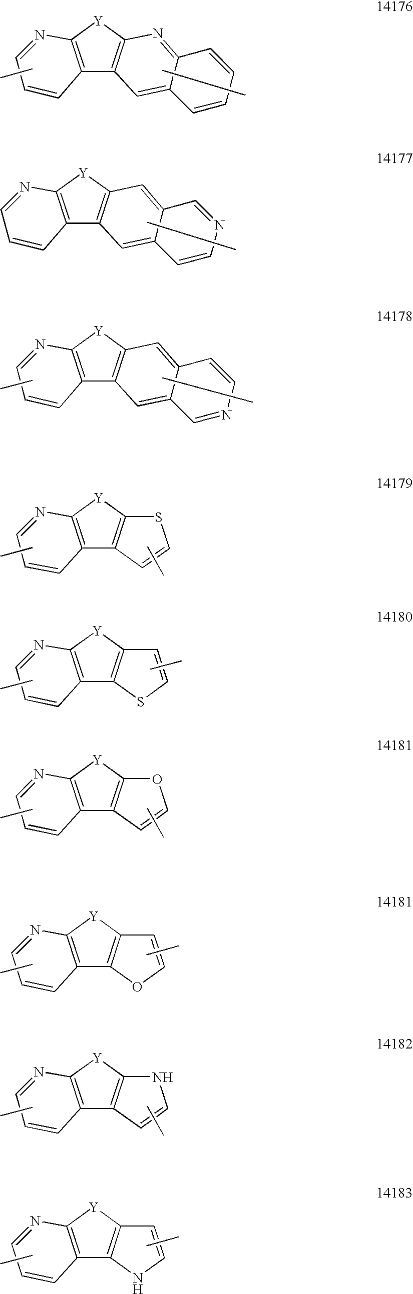

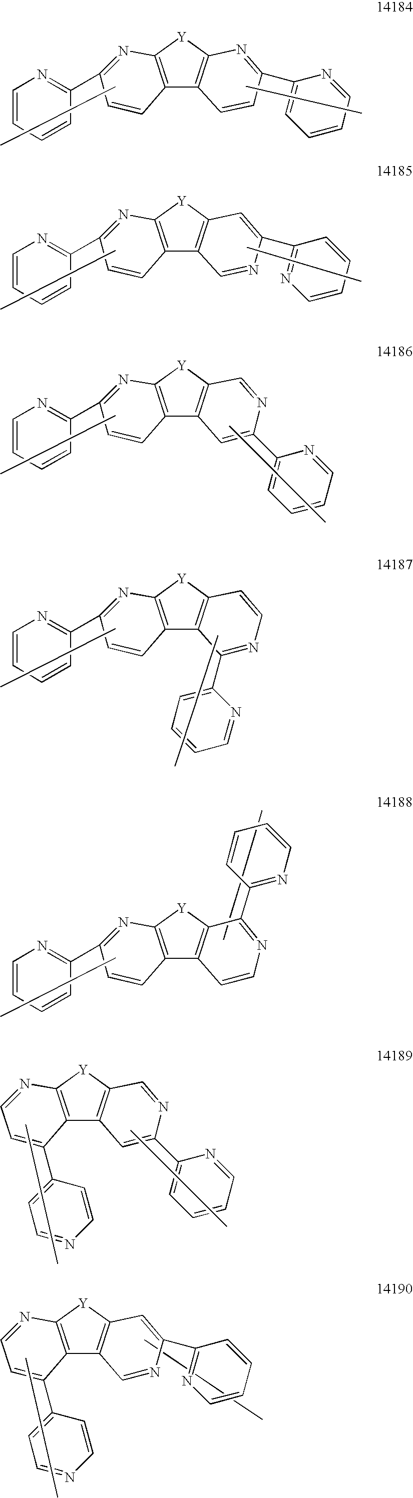

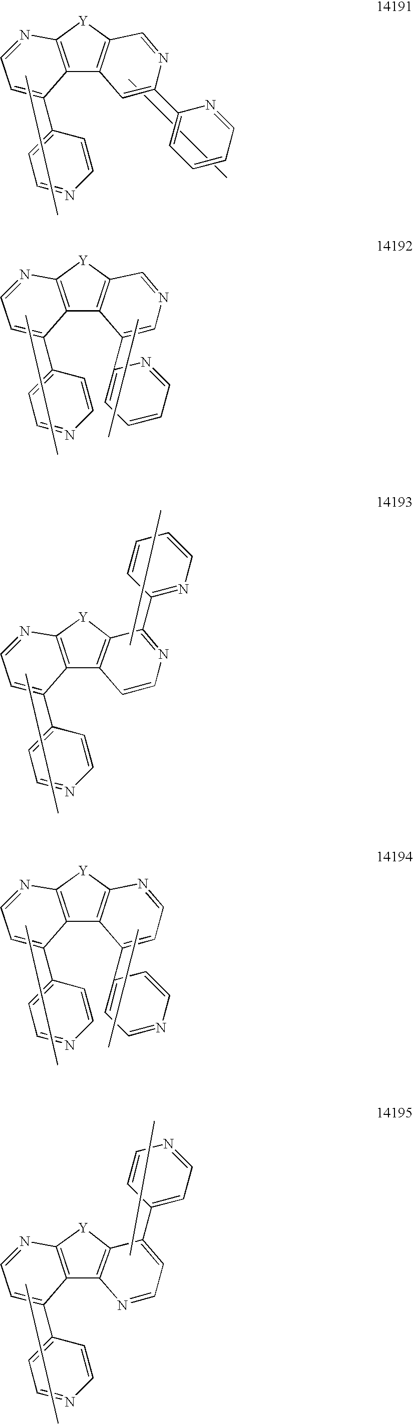

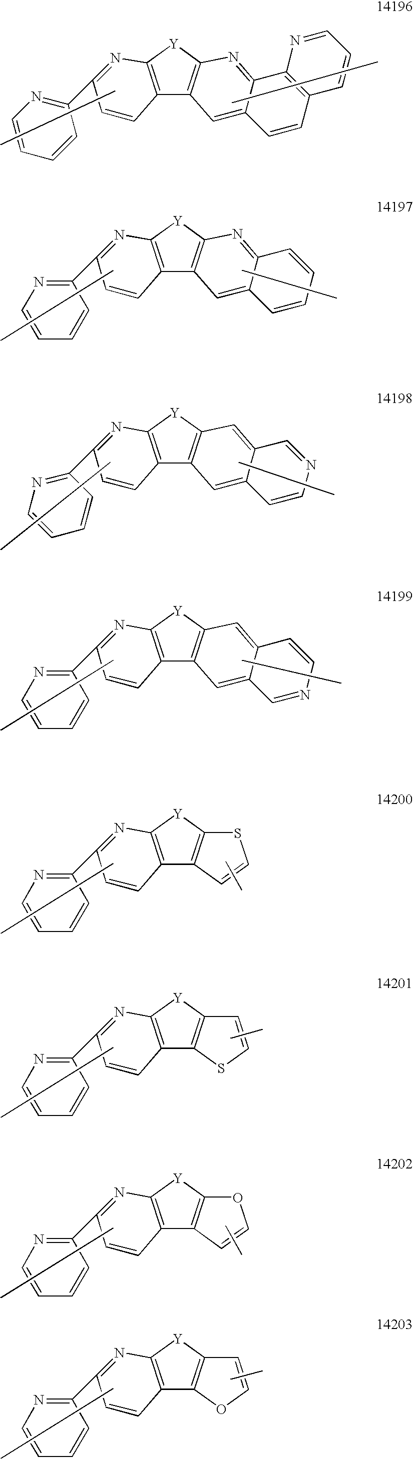

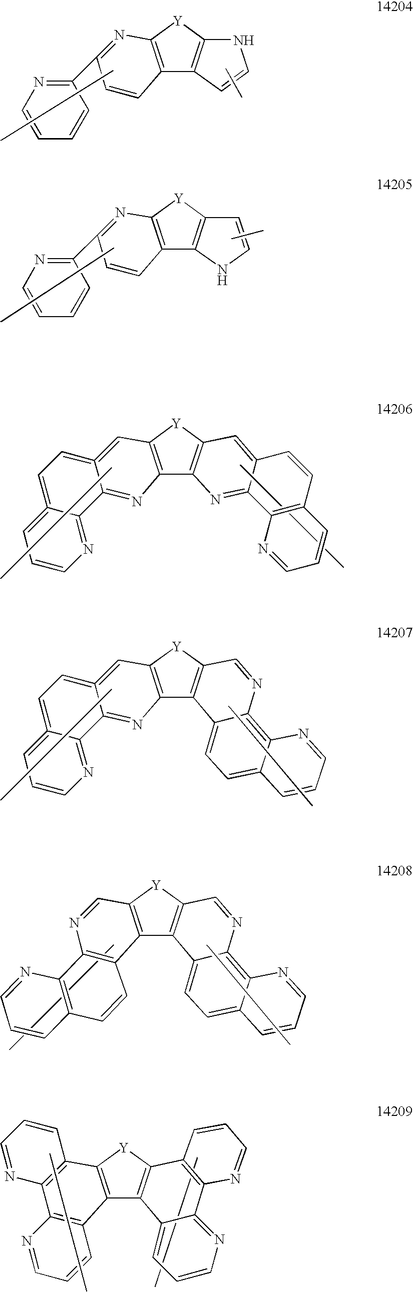

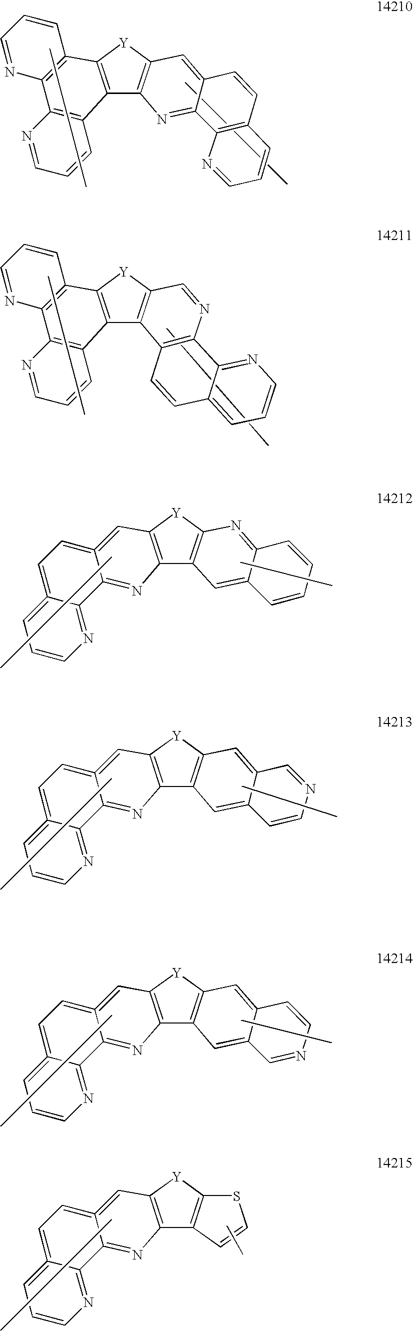

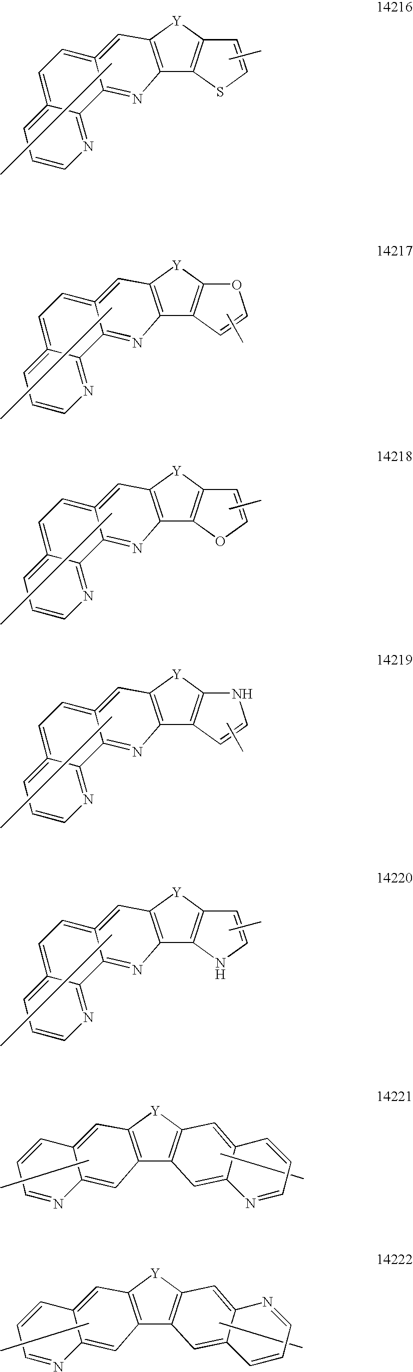

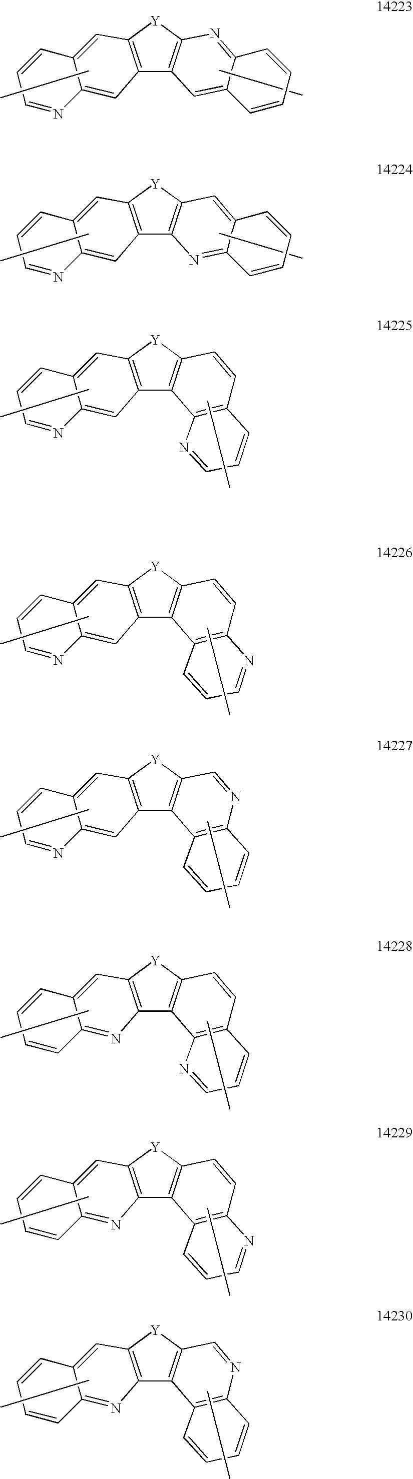

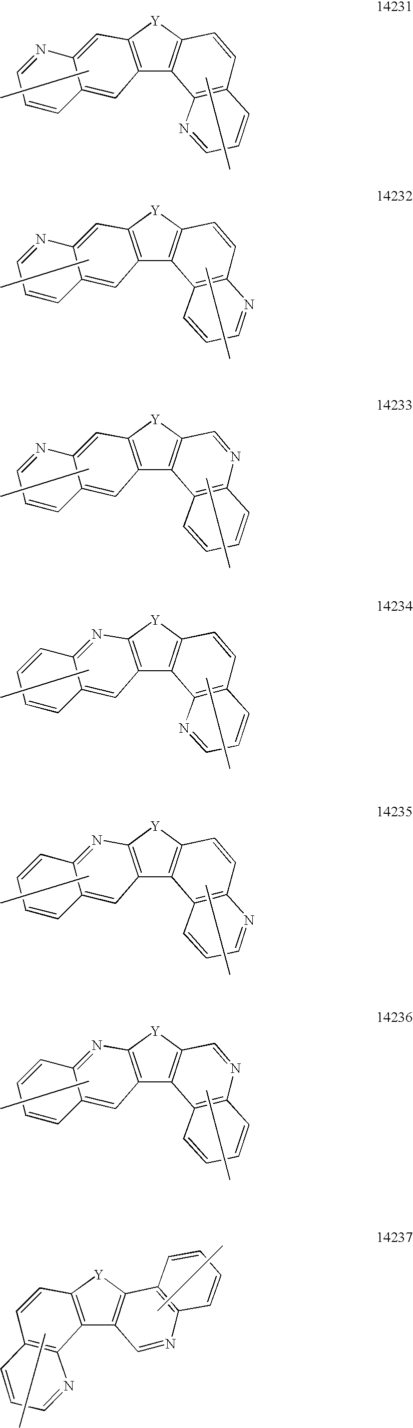

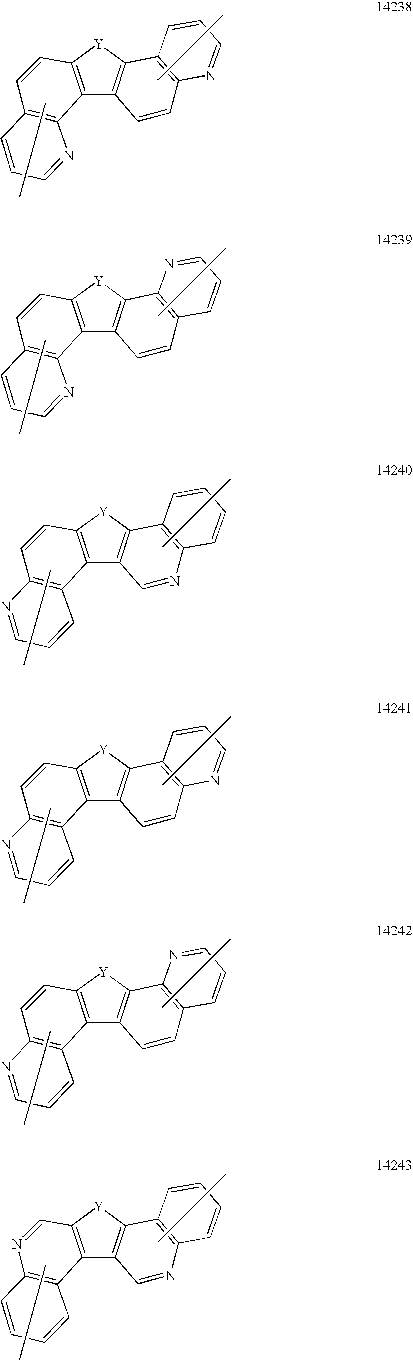

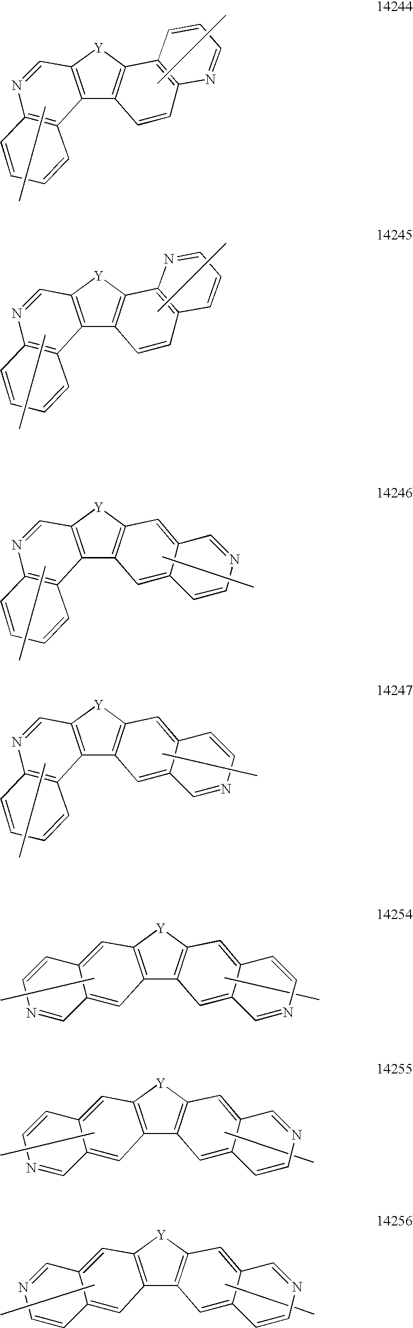

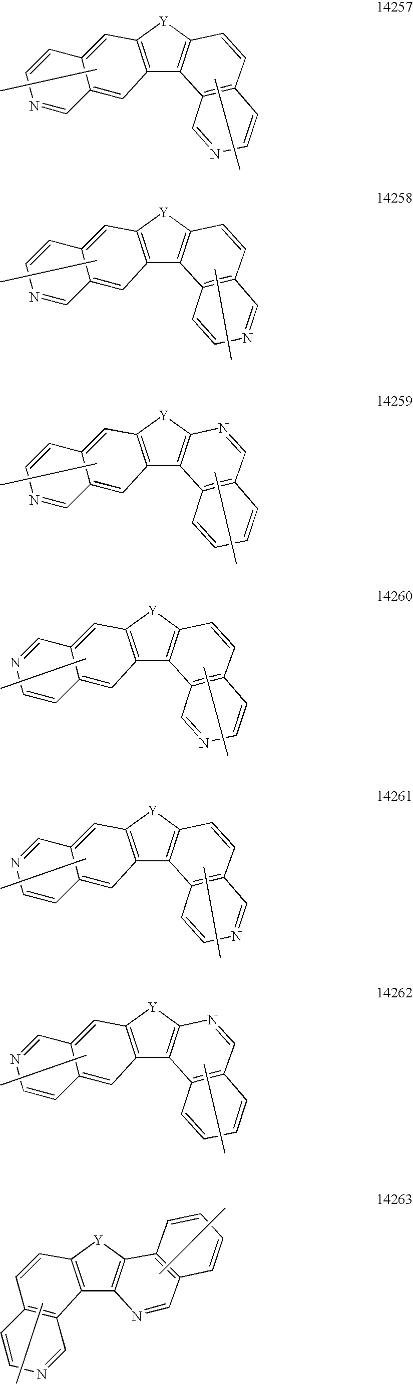

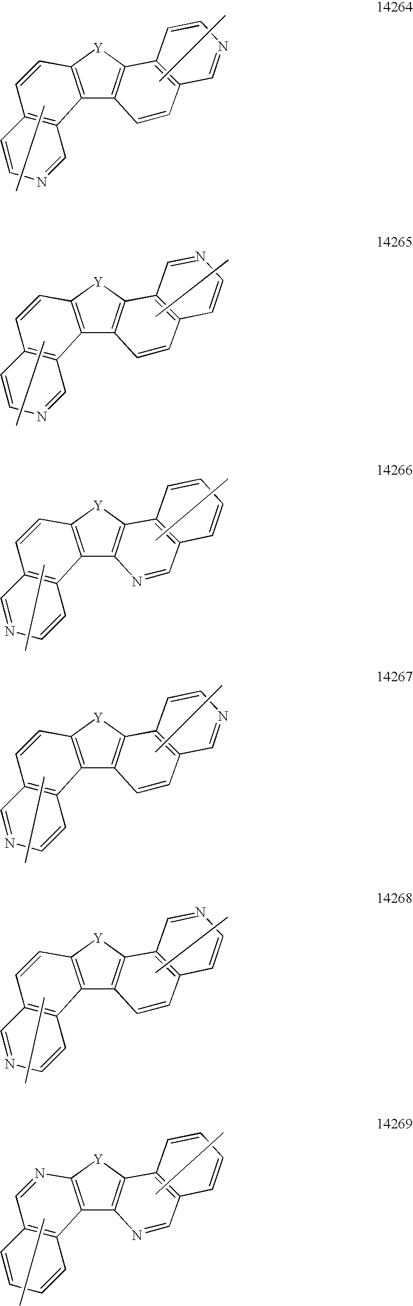

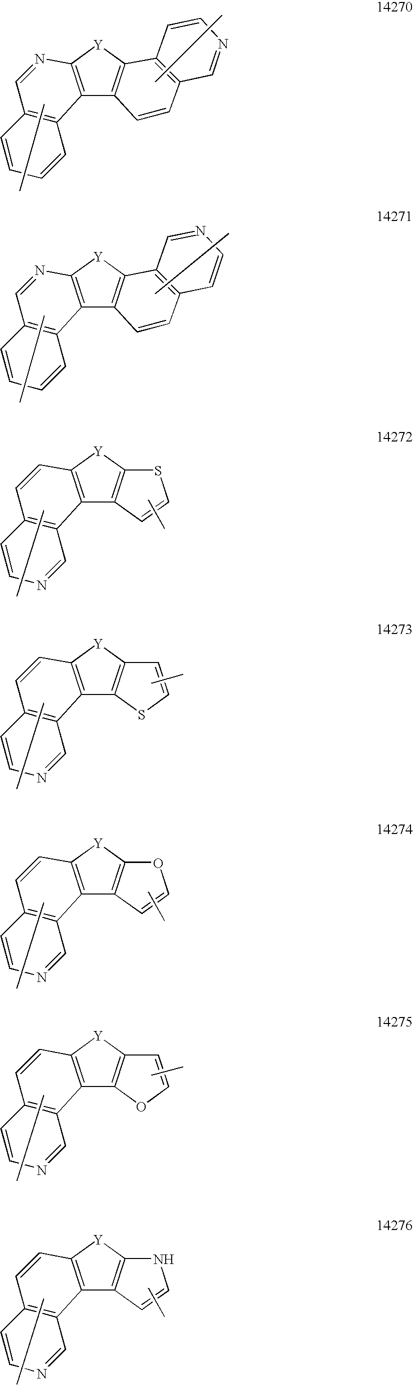

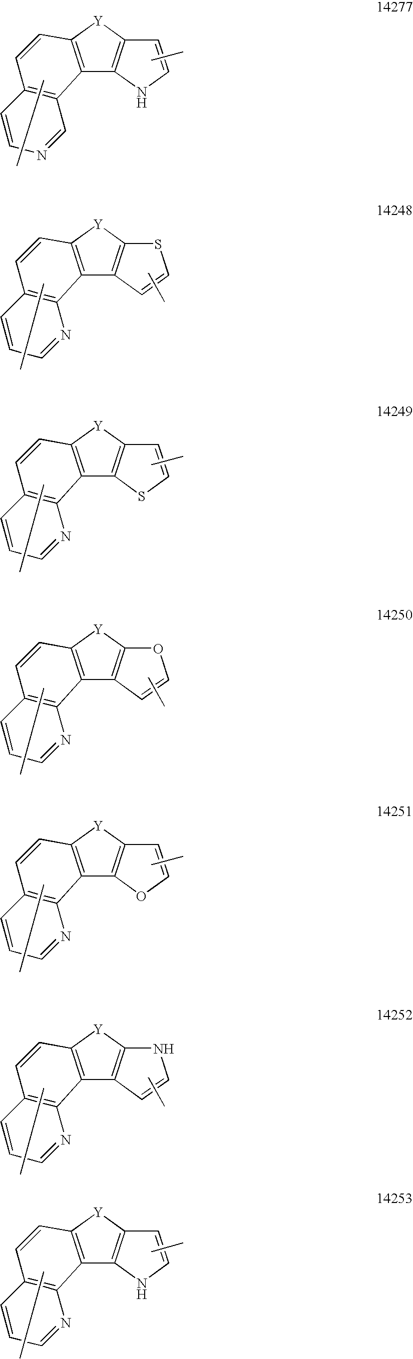

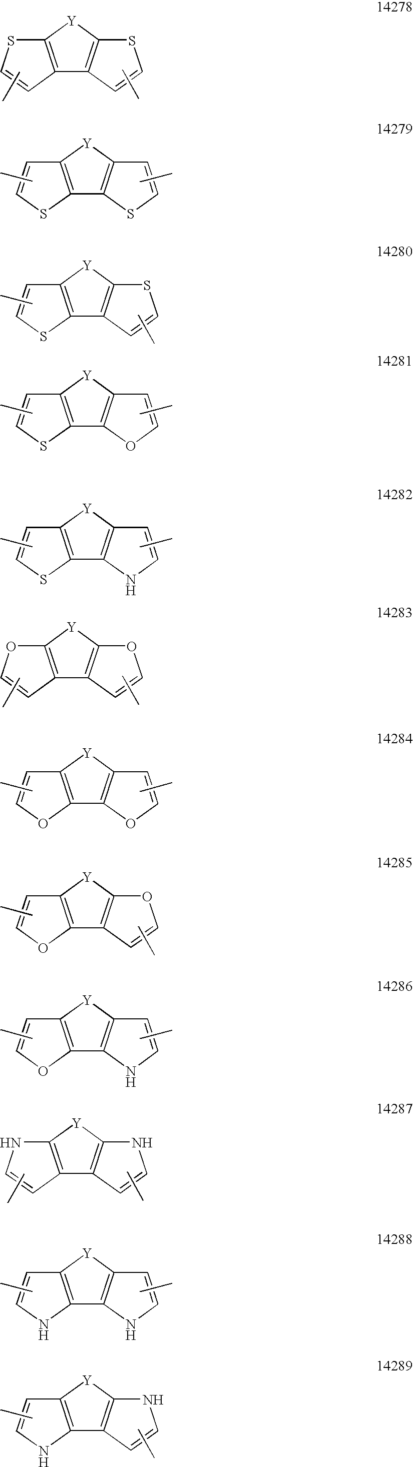

Concrete examples of formula (1-5), shown as unsubstituted structure, include followings.

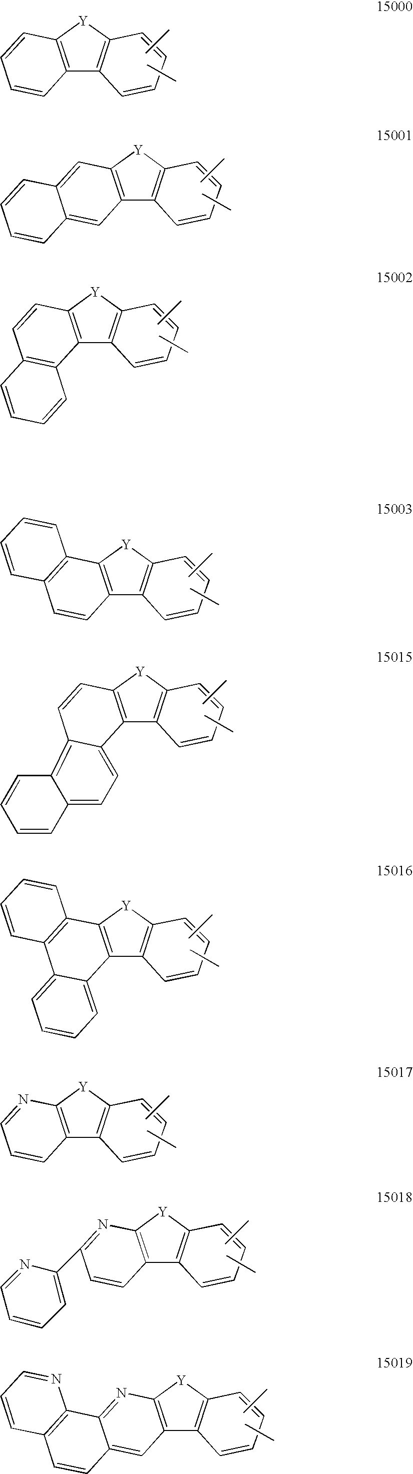

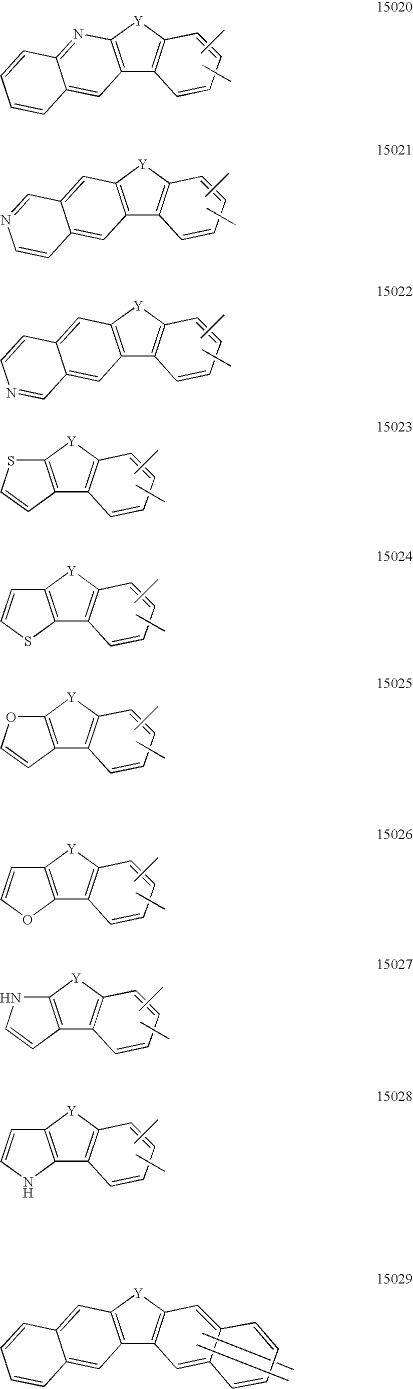

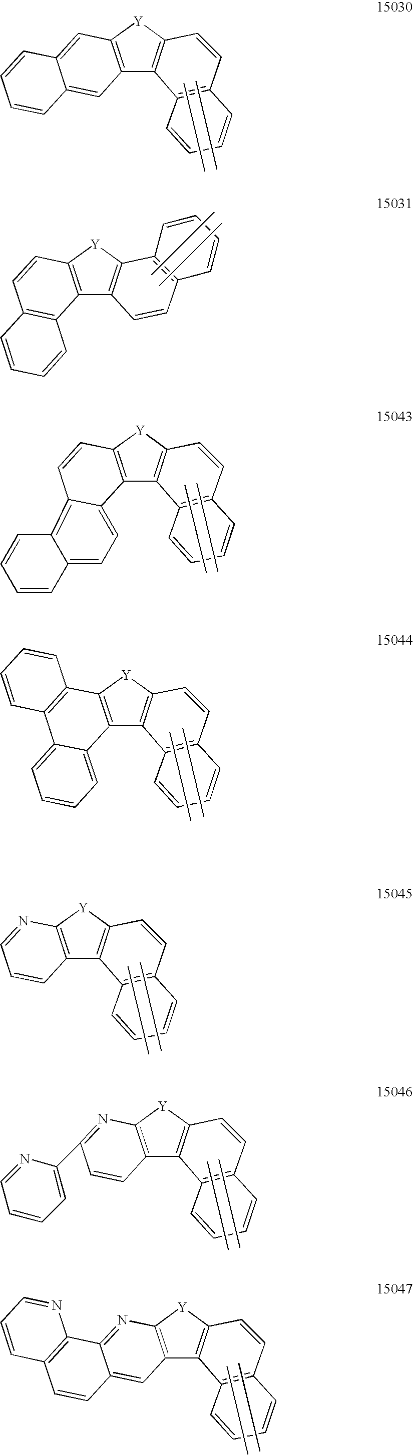

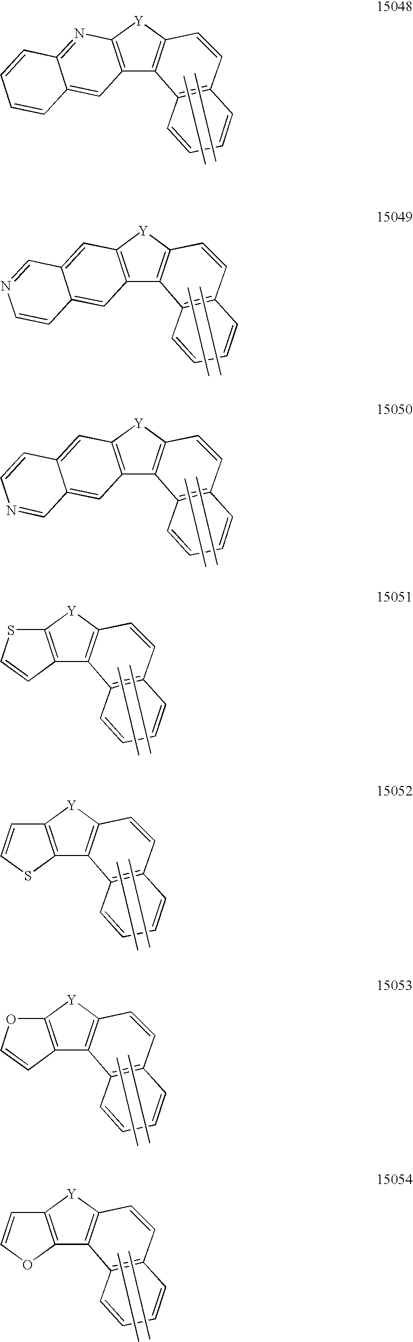

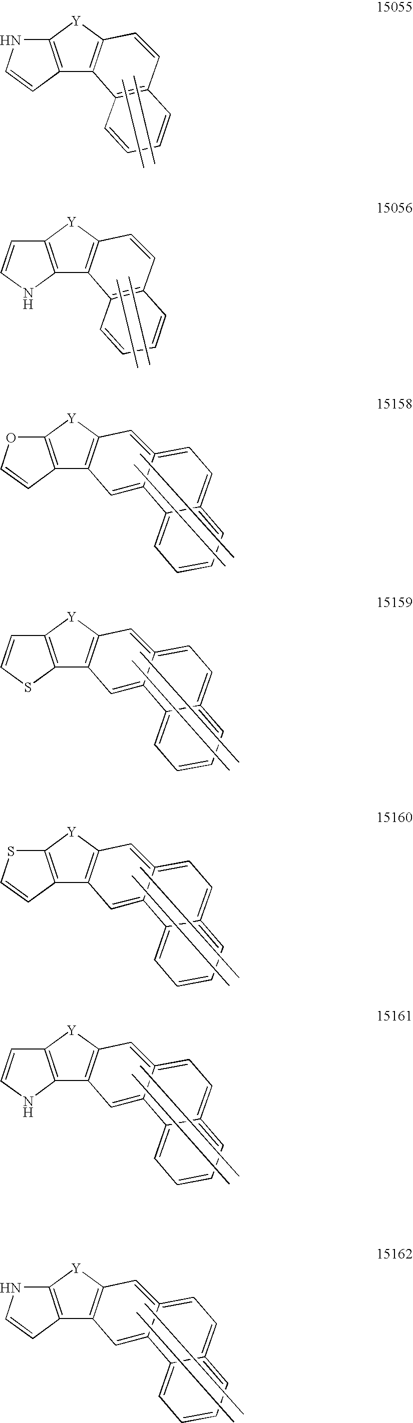

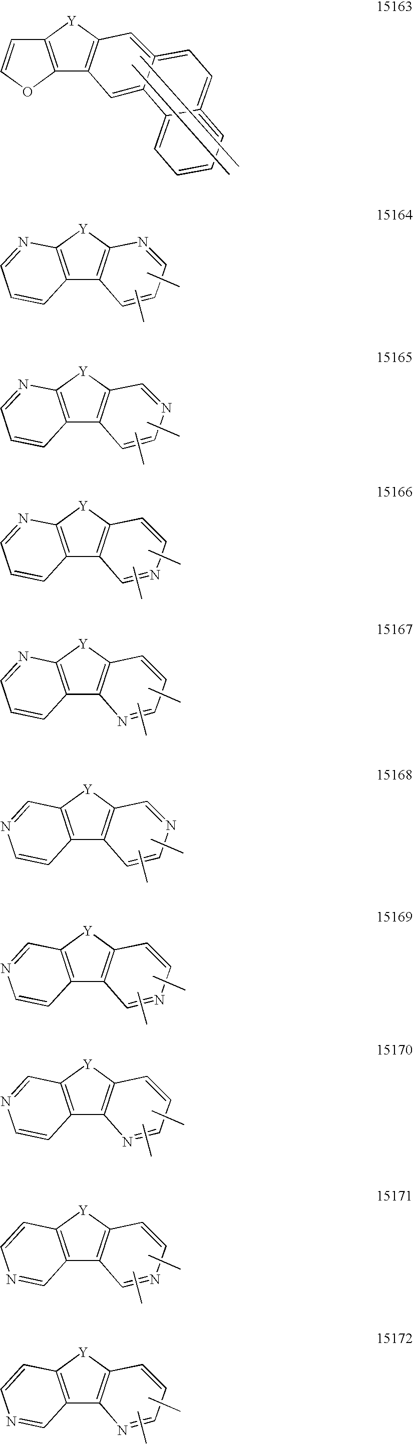

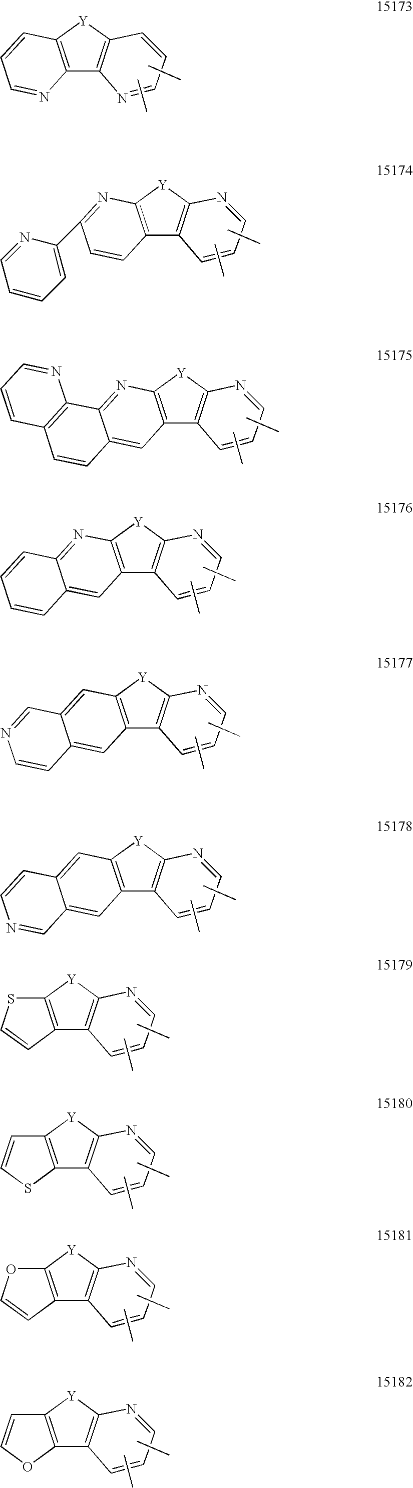

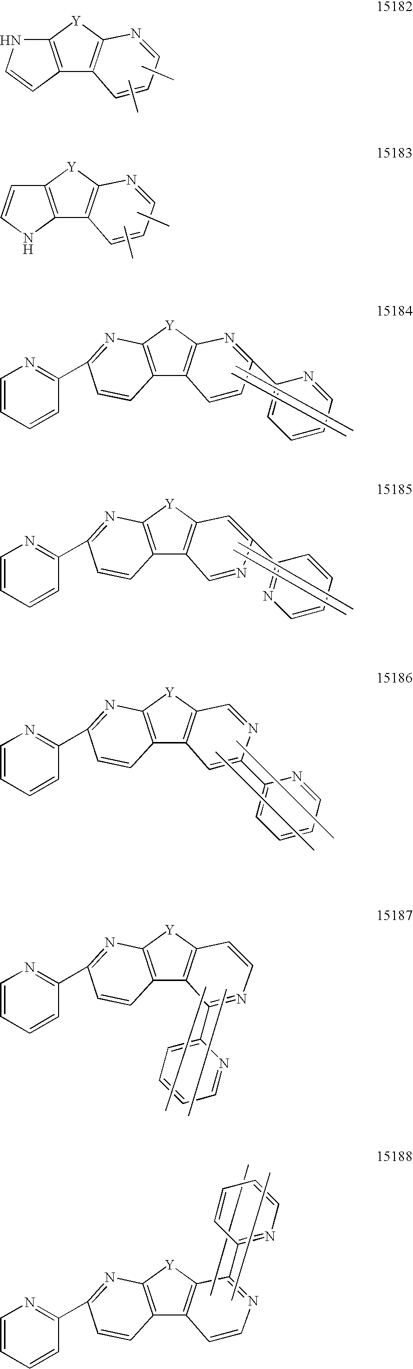

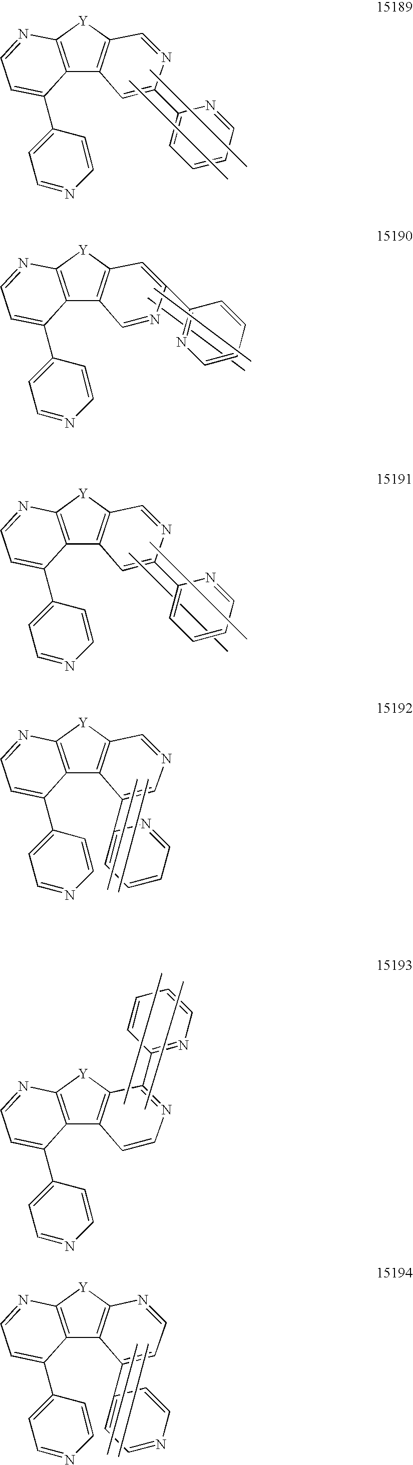

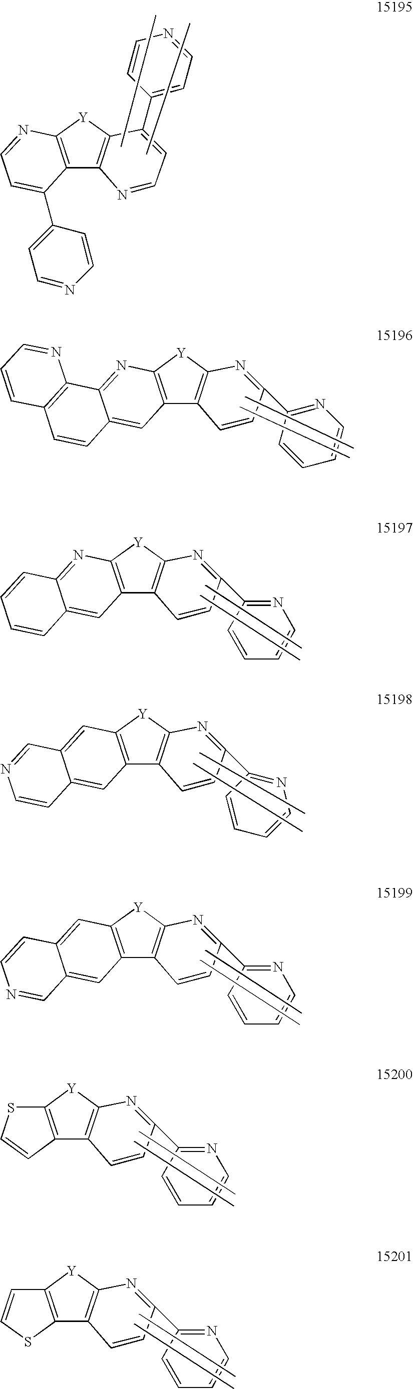

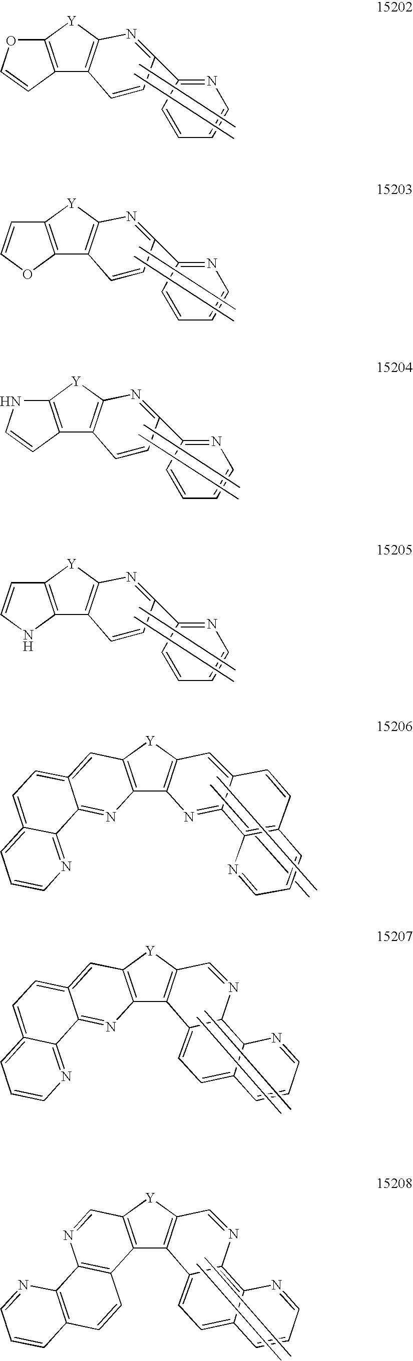

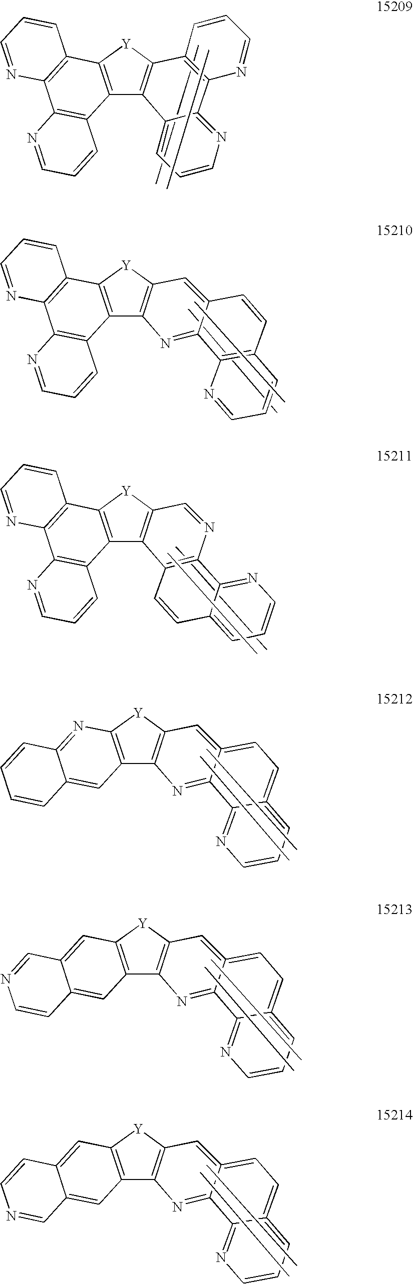

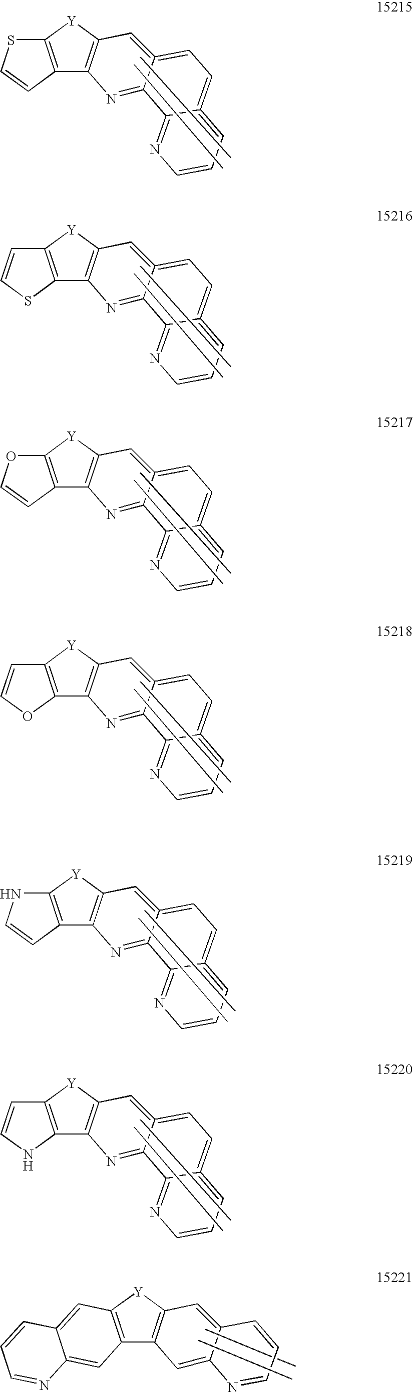

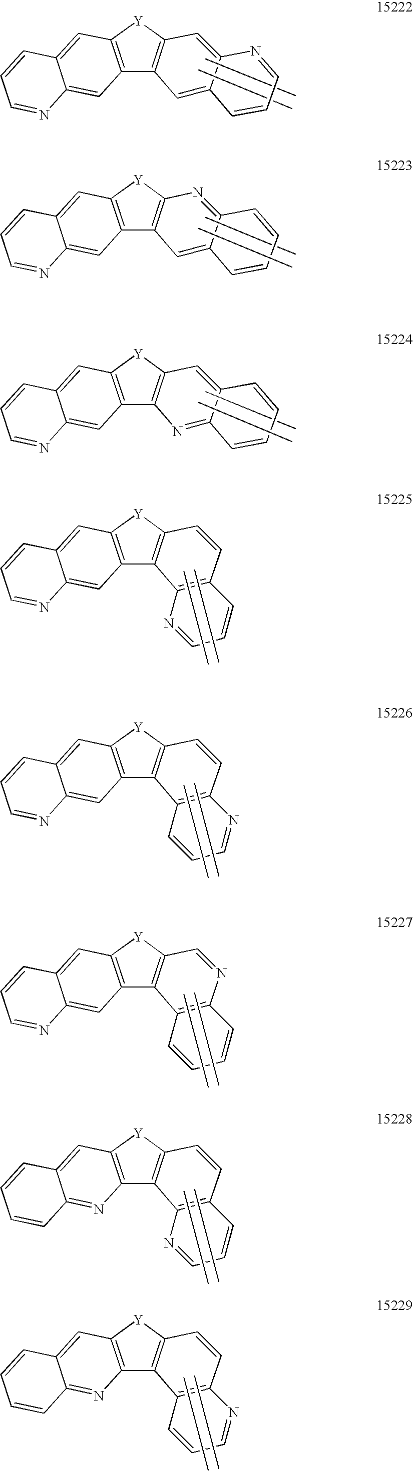

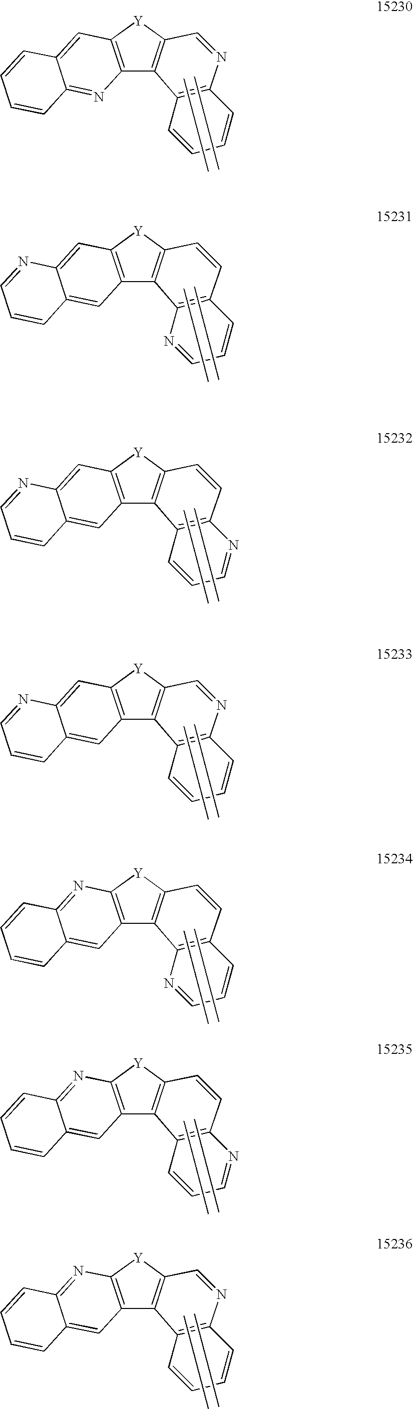

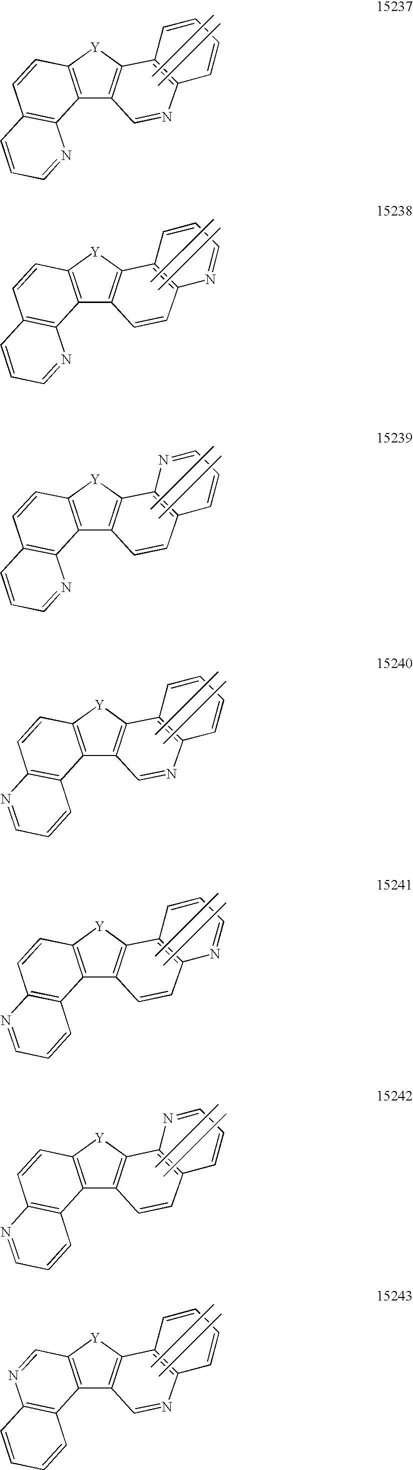

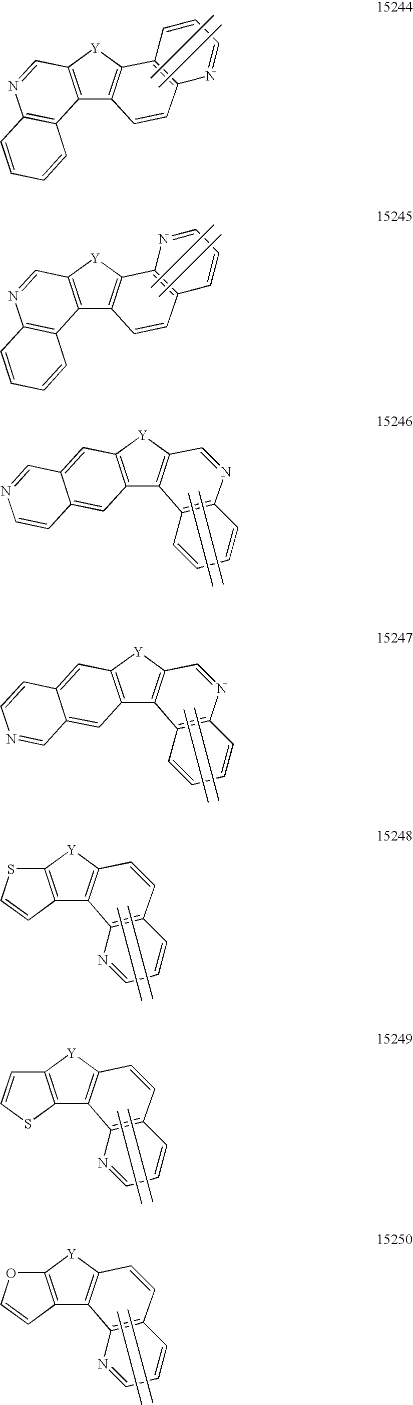

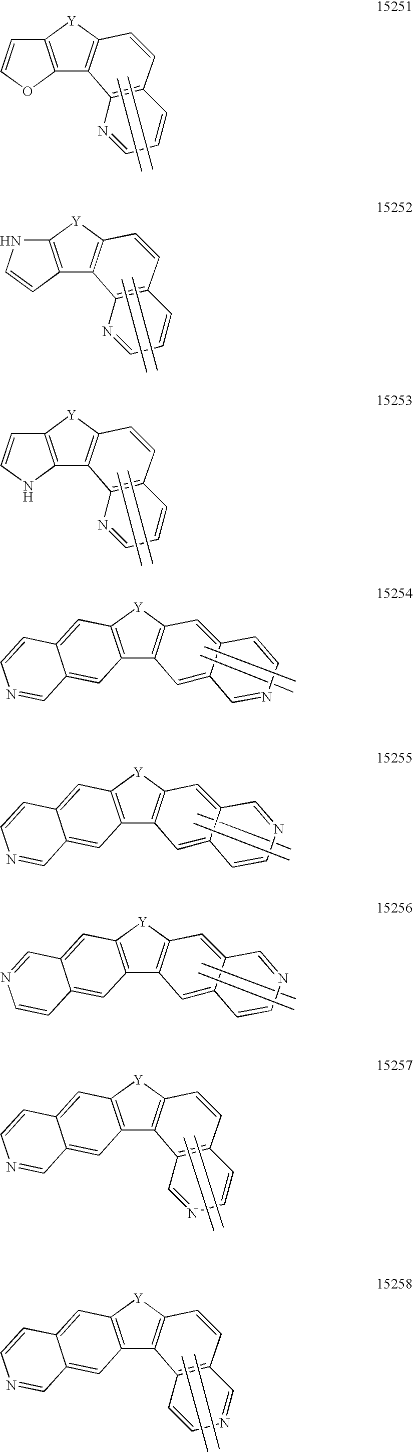

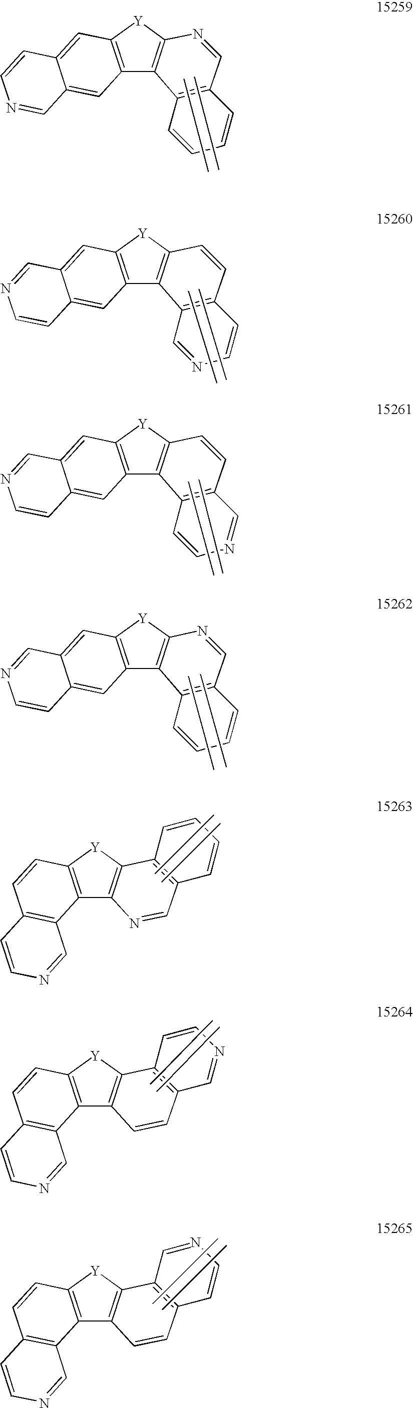

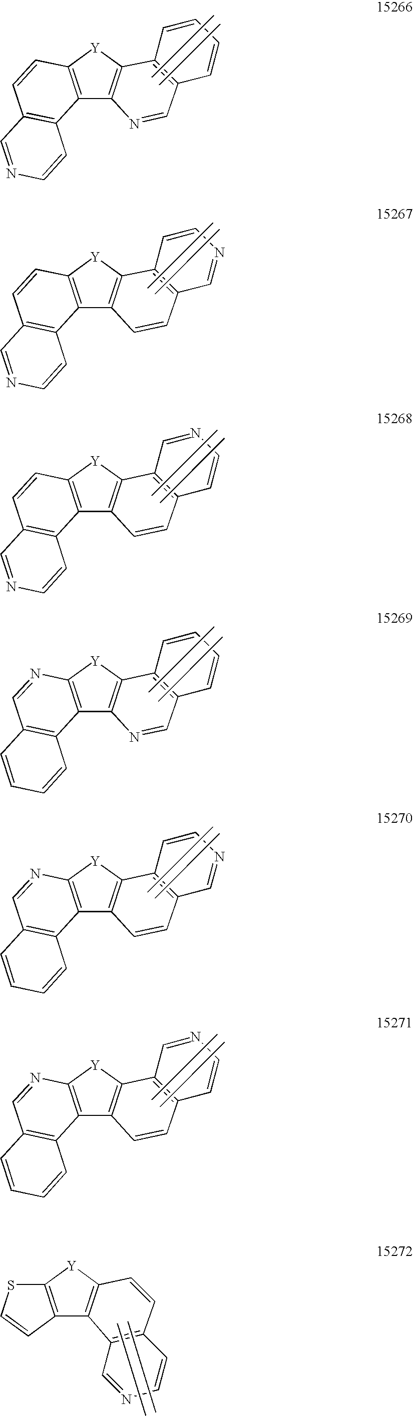

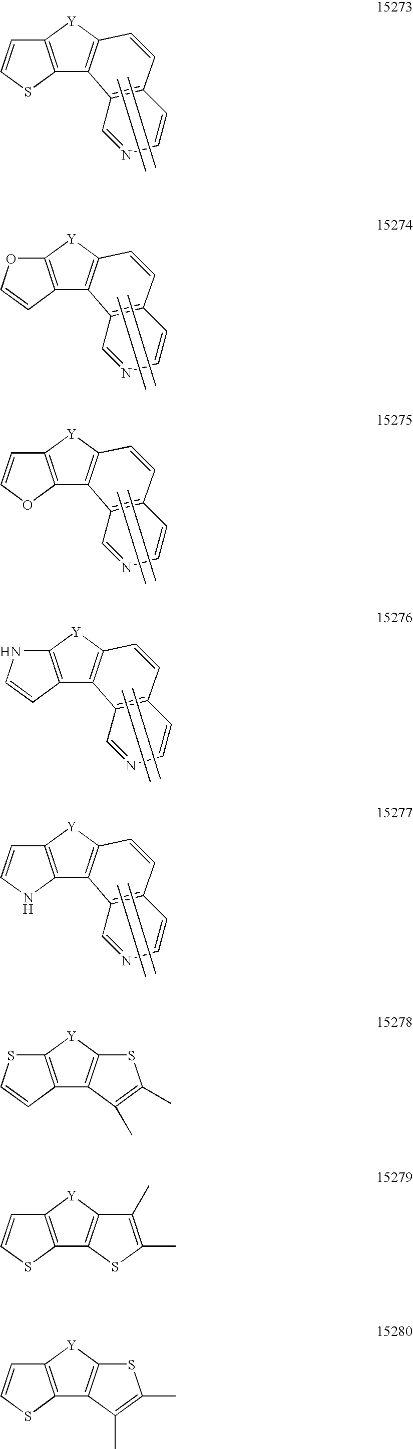

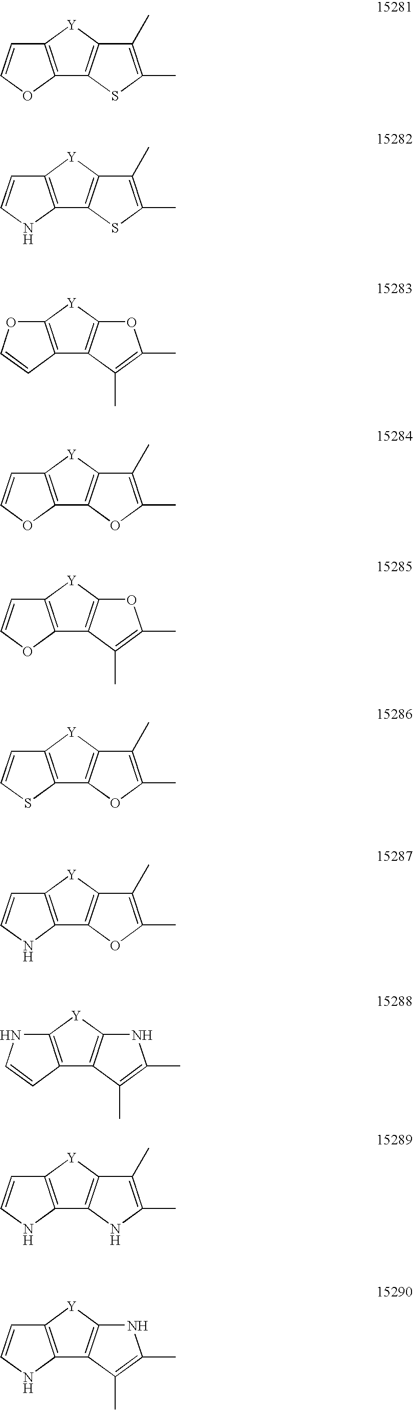

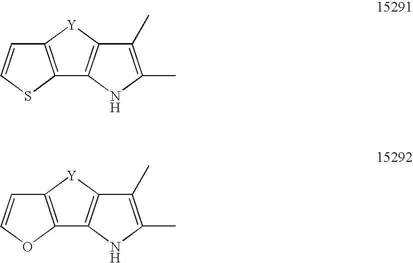

In the above formula (1), formulae (1-4) and (1-5) are preferable, and the structure represented by the below formula (1-6) is more preferable.

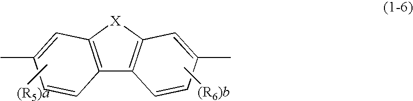

(wherein, R₅ and R₆ each independently representXX each independently represent an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, acyloxy group, imine residue, amide group, acid imide group, monovalent heterocyclic group, carboxyl group, or substituted carboxyl group. a and b each independently represent an integer of 0 to 3. When R₅ and R₆ respectively exist in plural, they may be the same or different. Y represents the same meaning as the above.)

In formula (1-6), Y is preferably O or S.

In view of the solubility in a solvent, a+b is preferably 1 or more.

The polymeric compound used in the light emitting material of the present invention may further contain the repeating units of the below formula (2), (3), (4), or (5).

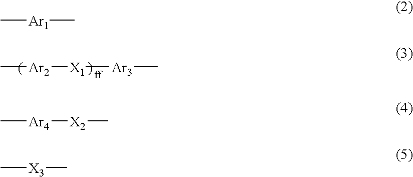

(wherein, Ar₁, Ar₂, Ar₃ and Ar₄ each independently represent an arylene group, divalent heterocyclic group, or divalent group having metal complex structure. X₁, X₂ and X₃ each independently represent —CR₁₅═CR₁₆—, —C≡C—, —N(R₁₇)—, or —(SiR₁₈ R₁₉)ₘ—. R₁₅ and R₁₆ each independently represent a hydrogen atom, alkyl group, aryl group, monovalent heterocyclic group, carboxyl group, substituted carboxyl group, or cyano group. R₁₇, R₁₈ and R₁₉ each independently represent a hydrogen atom, alkyl group, aryl group, monovalent heterocyclic group, arylalkyl group, or substituted amino group. ff represents 1 or 2. m represents an integer of 1 to 12. R₁₅, R₁₆, R₁₇, R₁₈ and R₁₉ repectively exist in plural, they may be the same or different.)

The arylene group is an atomic group in which two hydrogen atoms of an aromatic hydrocarbon are removed, and usually, the number of carbon atoms is about 6 to 60, and preferably 6 to 20. The aromatic hydrocarbon includes those having a condensed ring, an independent benzene ring, or two or more condensed rings bonded through groups, such as a direct bond or a vinylene group.

Examples of the arylene group include phenylene group (for example, following formulas I-3), naphthalenediyl group (following formulas 4-13), anthracenylene group (following formulas 14-19), biphenylene group (following formulas 20-25), terphenyl-diyl group (following formulas 26-28), condensed ring compound group (following formulas 29-35), fluorene-diyl group (following formulas 36-38), stilbene-diyl (following formulas A-D), distilbene-diyl (following formulas E,F), etc. Among them, phenylene group, biphenylene group, and stilbene-diyl group are preferable.

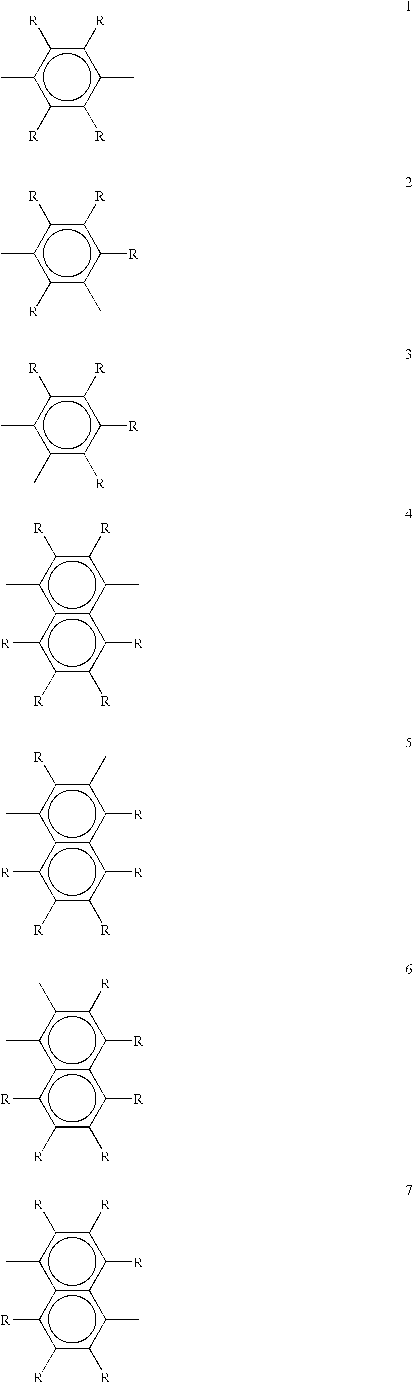

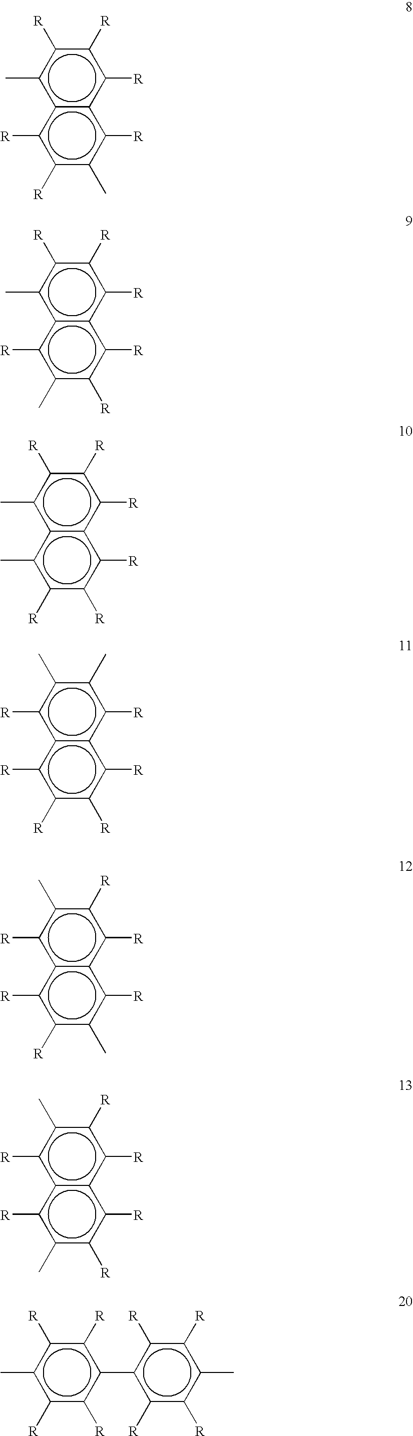

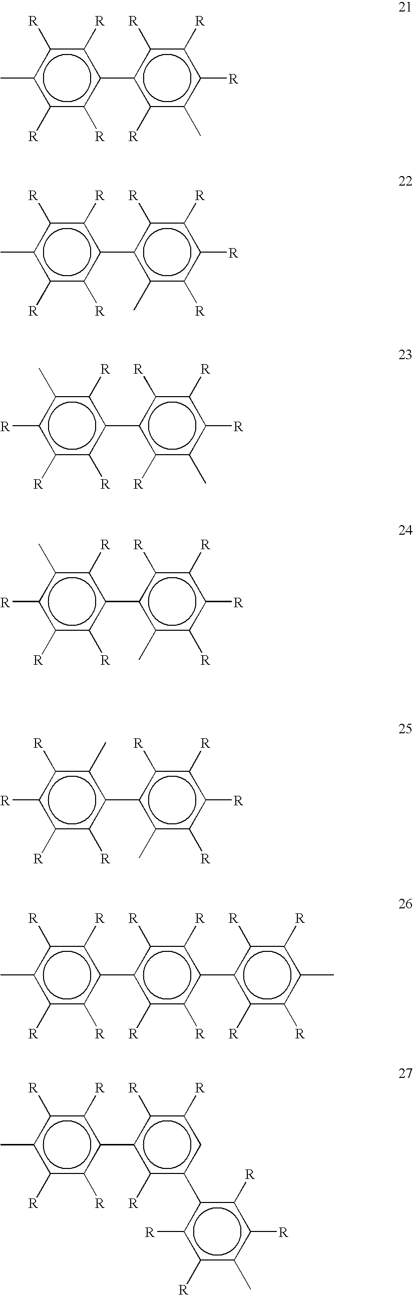

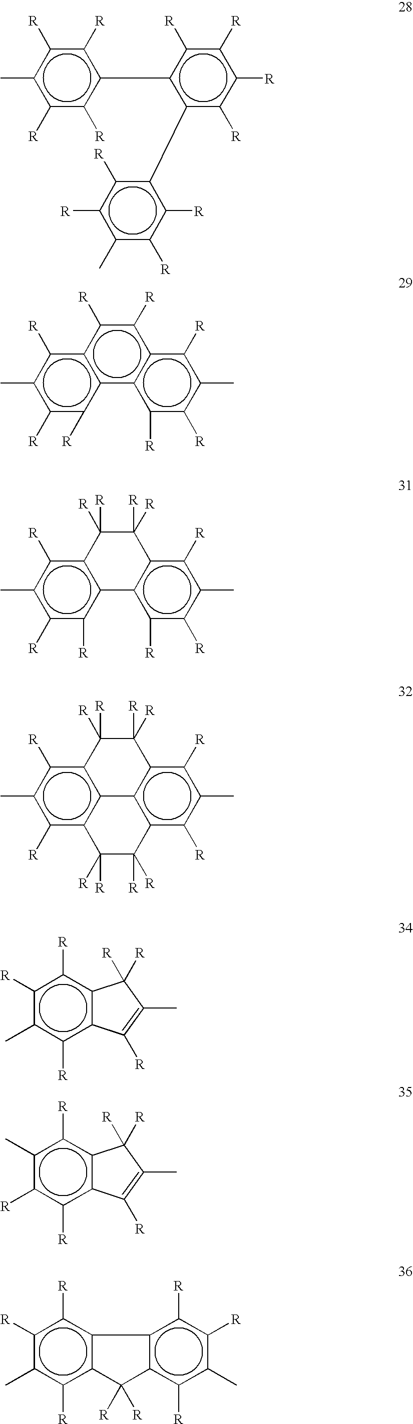

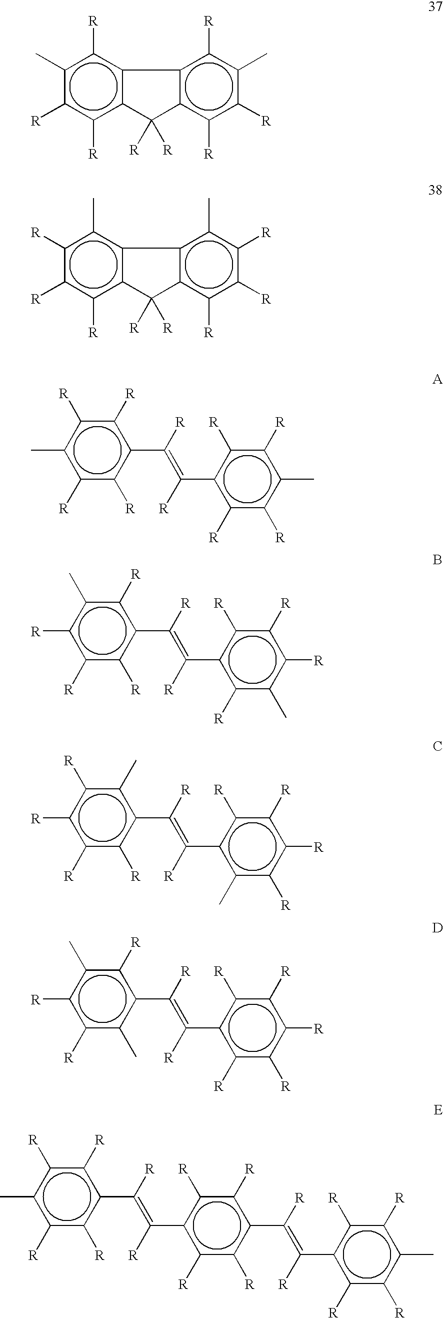

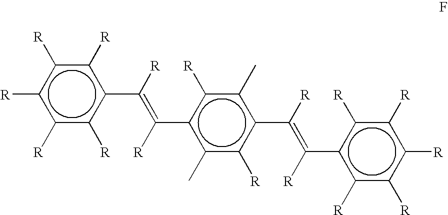

The divalent heterocyclic group means an atomic group in which two hydrogen atoms are removed from a heterocyclic compound, and the number of carbon atoms is usually about 3 to 60.

The heterocyclic compound means an organic compound having a cyclic structure in which at least one heteroatom such as oxygen, sulfur, nitrogen, phosphorus, boron, etc. is contained in the cyclic structure as the element other than carbon atoms.

Examples of the divalent heterocyclic groups include the followings.

Divalent heterocyclic groups containing nitrogen as a hetero atom; pyridine-diyl group (following formulas 39-44), diaza phenylene group (following formulas 45-48), quinolinediyl group (following formulas 49-63), quinoxalinediyl group (following formulas 64-68), acridinediyl group (following formulas 69-72), bipyridyldiyl group (following formulas 73-75), phenanthrolinediyl group (following formulas 76-78), etc.

Groups having a fluorene structure containing silicon, nitrogen, selenium, etc. as a hetero atom (following formulas 79-93).

5 membered heterocyclic groups containing silicon, nitrogen, sulfur, selenium, etc. as a hetero atom: (following formulas 94-98).

Condensed 5 membered heterocyclic groups containing silicon, nitrogen, selenium, etc. as a hetero atom: (following formulas 99-110),

5 membered heterocyclic groups containing silicon, nitrogen, sulfur, selenium, etc. as a hetero atom, which are connected at the a position of the hetero atom to form a dimer or an oligomer (following formulas 111-112);

5 membered ring heterocyclic groups containing silicon, nitrogen, sulfur, selenium, as a hetero atom is connected with a phenyl group at the a position of the hetero atom (following formulas 113-119); and

Groups of 5 membered ring heterocyclic groups containing nitrogen, oxygen, sulfur, as a hetero atom ono which a phenyl group, furyl group, or thienyl group is substituted (following formulas 120-125).

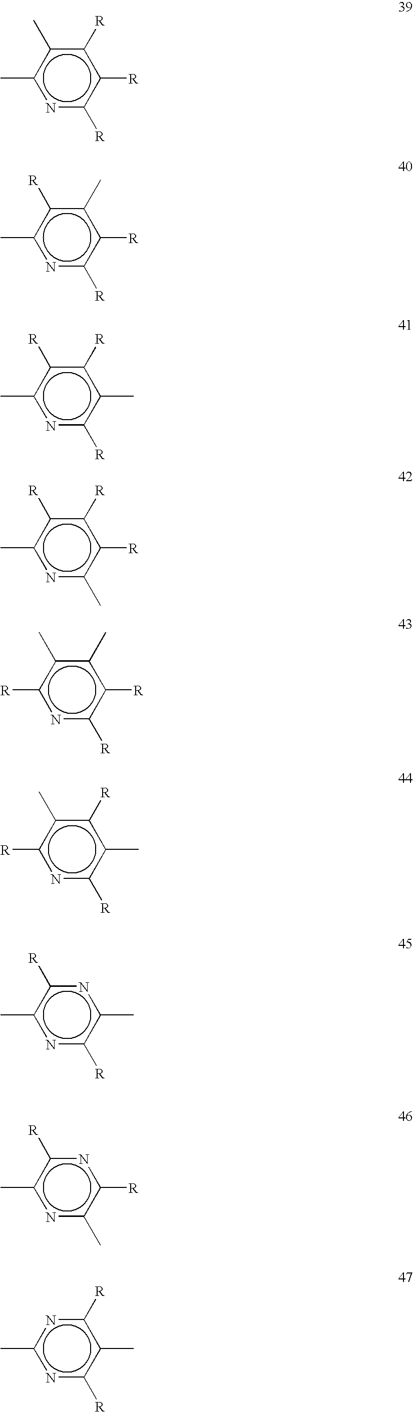

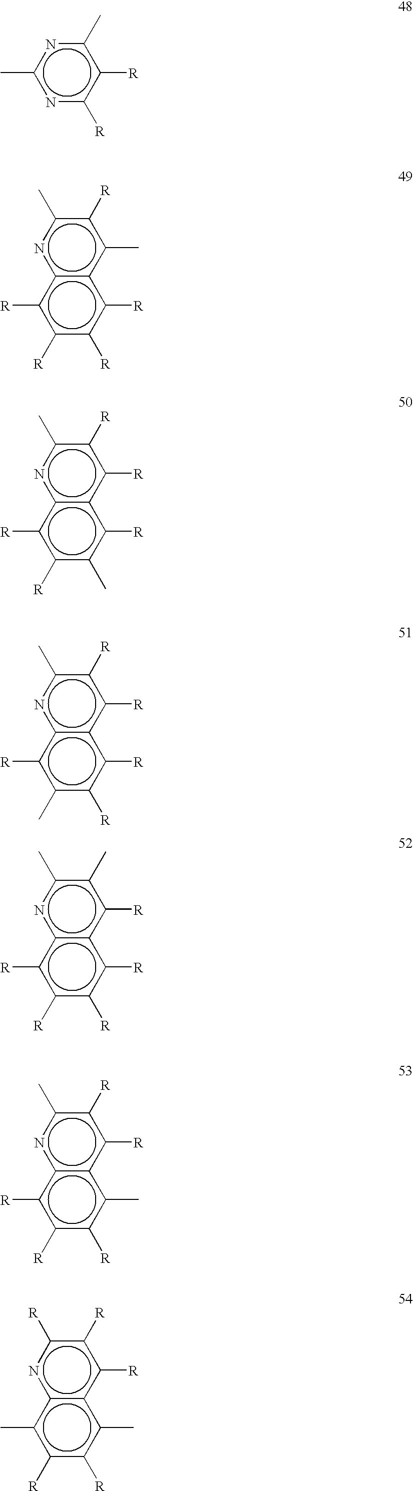

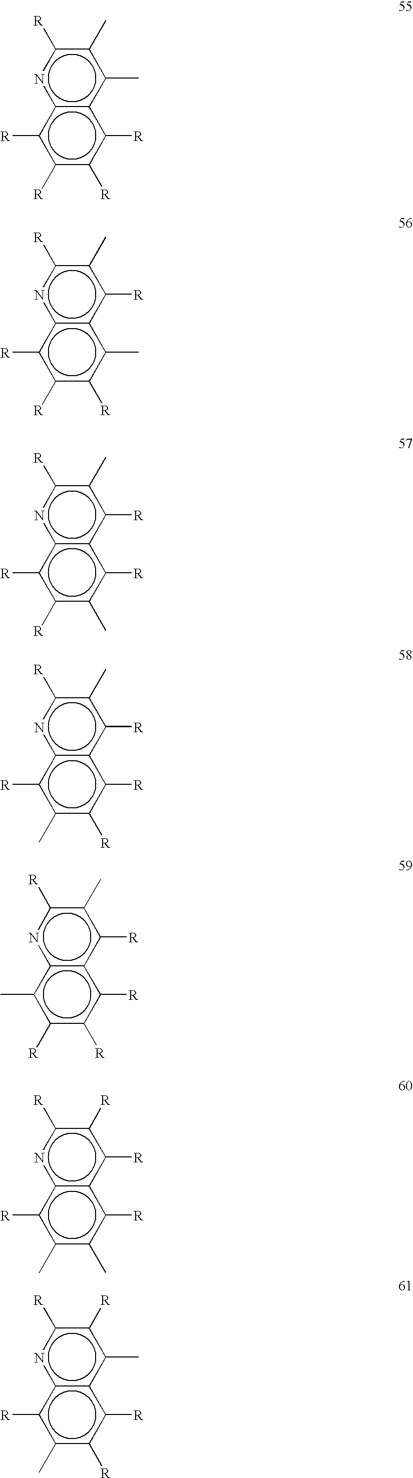

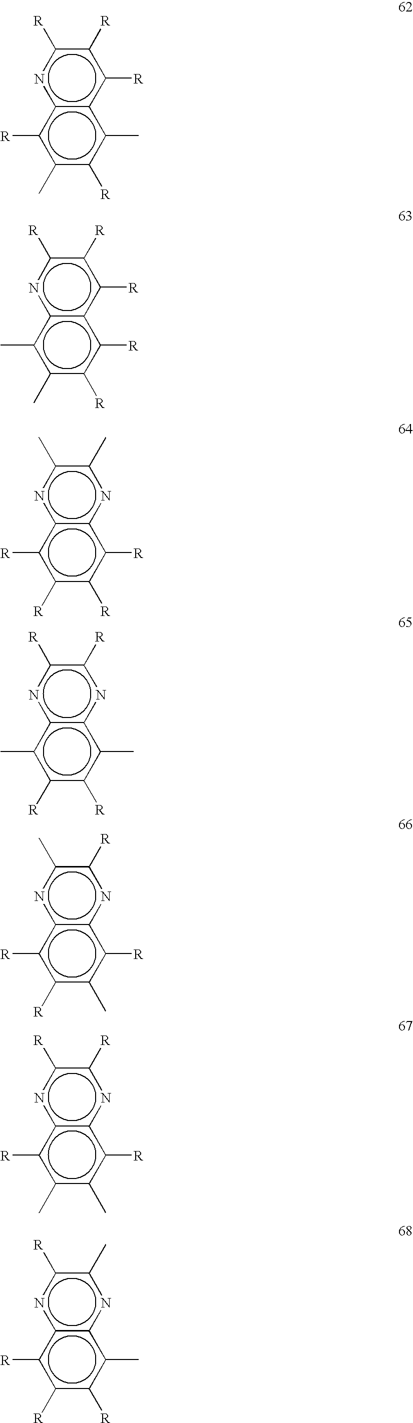

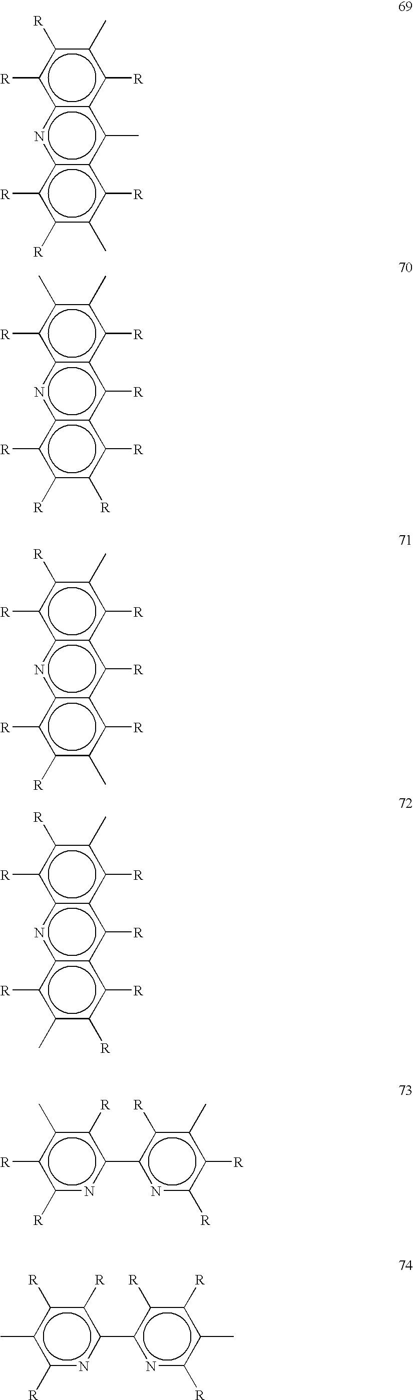

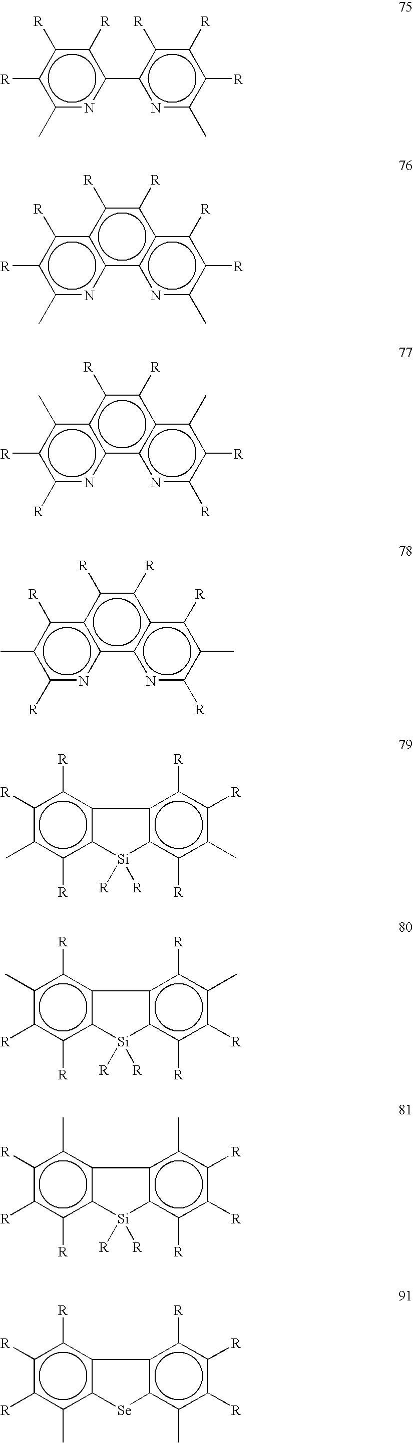

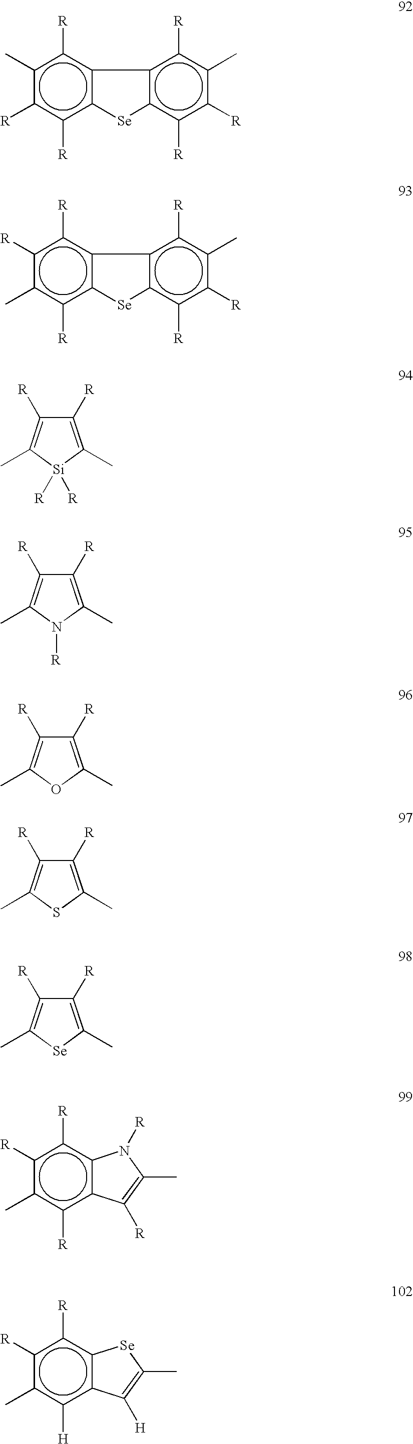

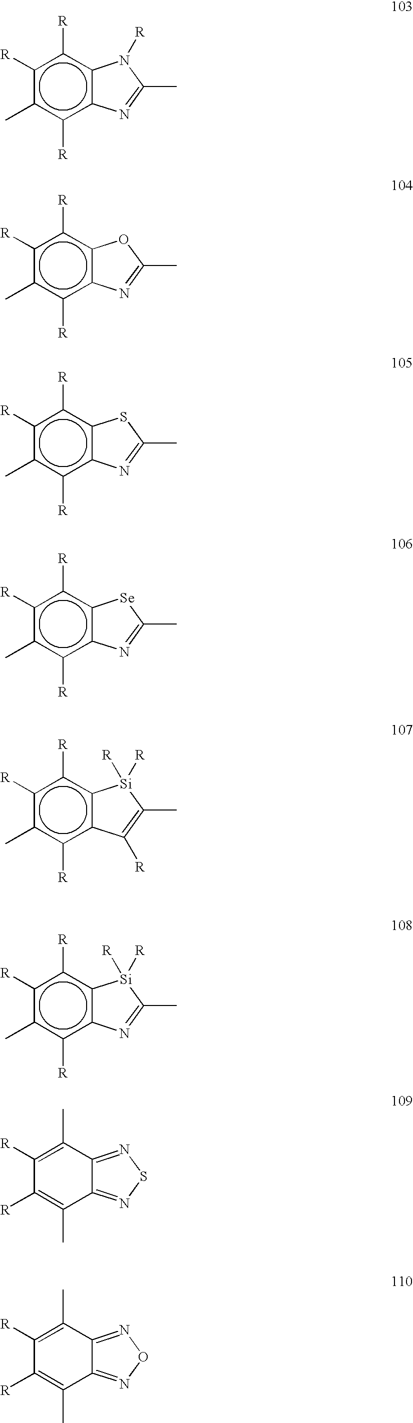

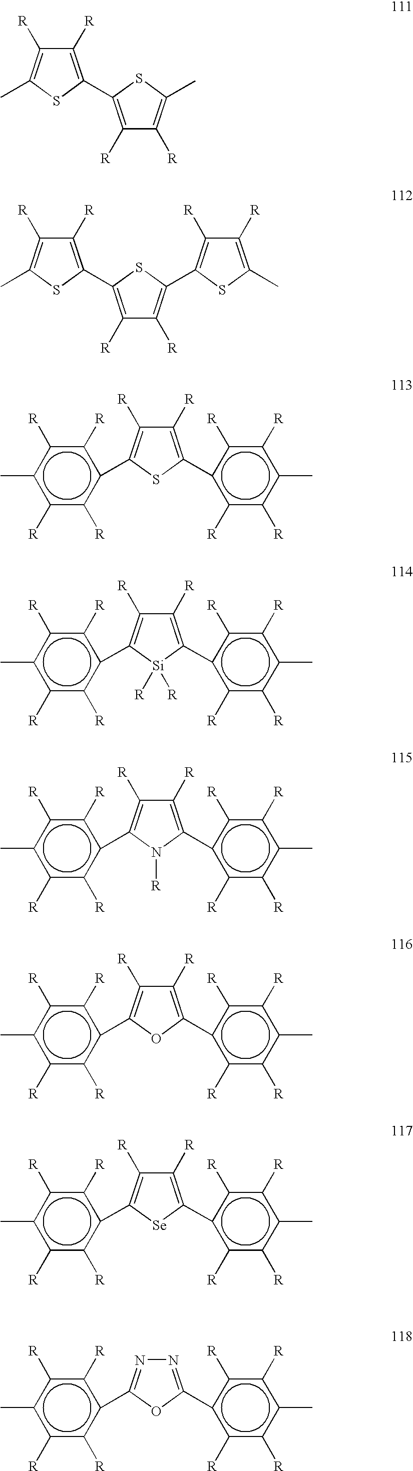

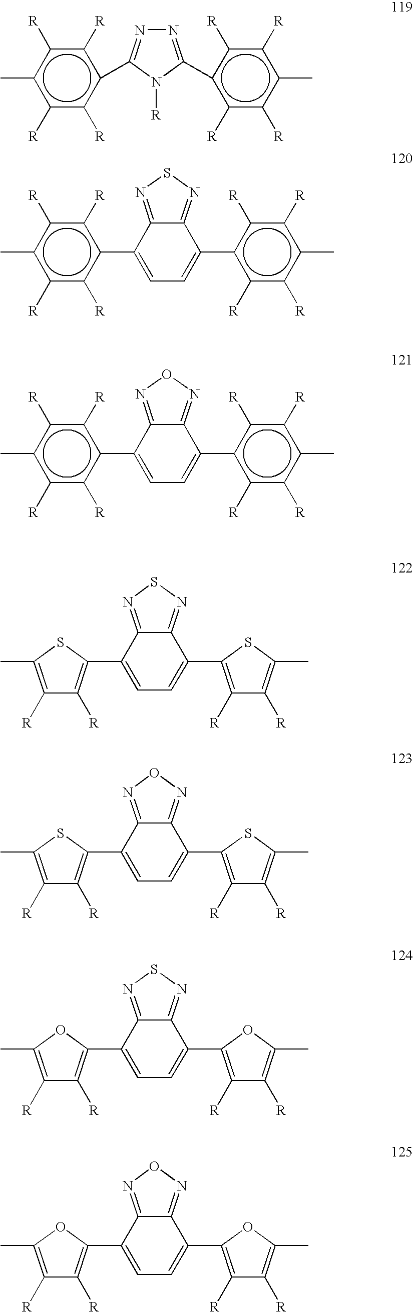

In the examples of the above formulae 1-125, Rs each independently represent a hydrogen atom, alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom (for example, chlorine, bromine, iodine), acyl group, acyloxy group, imine residue, amide group, acid imide group, monovalent heterocyclic group, carboxyl group, substituted carboxyl group, or cyano group. Carbon atom contained in the groups of formulas 1-125 may be substituted by a nitrogen atom, oxygen atom, or sulfur atom, and a hydrogen atom may be substituted by a fluorine atom.

The alkyl group, alkoxy group, alkylthio group, aryl group, aryloxy group, arylthio group, arylalkyl group, arylalkoxy group, arylalkylthio group, arylalkenyl group, arylalkynyl group, substituted amino group, substituted silyl group, halogen atom, acyl group, acyloxy group, imine residue, amide group, acidimide group, monovalent heterocyclic group, carboxyl group, and substituted carboxyl group in the above formulae (1) to (12), (1-1) to (1-10), and in the above examples, represent the same meaning as above.

The alkyl group may be any of linear, branched or cyclic. The number of carbon atoms is usually about 1 to 20, preferably 3 to 20, and specific examples thereof include methyl group, ethyl group, propyl group, i-propyl group, butyl group, i-butyl group, t-butyl group, pentyl group, hexyl group, cyclohexyl group, heptyl group, octyl group, 2-ethylhexyl group, nonyl group, decyl group, 3,7-dimethyloctyl group, lauryl group, trifluoromethyl group, pentafluoroethyl group, perfluorobutyl group, perfluorohexyl group, perfluorooctyl group, etc.; and pentyl group, hexyl group, octyl group, 2-ethyl hexyl group, decyl group, and 3,7-dimethyloctyl group are preferable.

The alkoxy group may be any of linear, branched or cyclic. The number of carbon atoms is usually about 1 to 20, preferably 3 to 20, and specific examples thereof include methoxy group, ethoxy group, propyloxy group, i-propyloxy group, butoxy group, i-butoxy group, t-butoxy group, pentyloxy group, hexyloxy group, cyclohexyloxy group, heptyloxy group, octyloxy group, 2-ethyl hexyloxy group, nonyloxy group, decyloxy group, 3,7-dimethyl octyloxy group, lauryloxy group, trifluoromethoxy group, pentafluoroethoxy group, perfluorobutoxy group, perfluorohexyloxy group, perfluorooctyloxy group, methoxymethyloxy group, 2-methoxyethyloxy group, etc.; and pentyloxy group, hexyloxy group, octyloxy group, 2-ethylhexyloxy group, decyloxy group, and 3,7-dimethyl octyloxy group are preferable.

The alkylthio group may be any of linear, branched or cyclic. The number of carbon atoms is usually about 1 to 20, preferably 3 to 20, and specific examples thereof include methylthio group, ethylthio group, propylthio group, i-propylthio group, butylthio group, i-butylthio group, t-butylthio group, pentylthio group, hexylthio group, cyclo hexylthio group, heptylthio group, octylthio group, 2-ethyl hexylthio group, nonylthio group, decylthio group, 3,7-dimethyloctylthio group, laurylthio group, trifluoromethylthio group, etc.; and pentylthio group, hexylthio group, octylthio group, 2-ethyl hexylthio group, decylthio group, and 3,7-dimethyloctylthio group are preferable.

The aryl group has usually about 6 to 60 carbon atoms, preferably 7 to 48, and specific examples thereof include phenyl group, C₁-C₁₂ alkoxyphenyl group (C₁-C₁₂ represents the number of carbon atoms 1-12. Hereafter the same), C₁-C₁₂ alkylphenyl group, 1-naphtyl group, 2-naphtyl group, 1-anthracenyl group, 2-anthracenyl group, 9-anthracenyl group, pentafluorophenyl group, etc., and C₁-C₁₂ alkoxyphenyl group and C₁-C₁₂ alkylphenyl group are preferable. The aryl group is an atomic group in which one hydrogen atom is removed from an aromatic hydrocarbon. The aromatic hydrocarbon includes those having a condensed ring, an independent benzene ring, or two or more condensed rings bonded through groups, such as a direct bond or a vinylene group.

Concrete examples of C₁-C₁₂ alkoxyphenyl include methoxyphenyl group, ethoxyphenyl group, propyloxyphenyl group, i-propyloxyphenyl group, butoxyphenyl group, i-butoxyphenyl group, t-butoxyphenyl group, pentyloxyphenyl group, hexyloxyphenyl group, cyclohexyloxyphenyl group, heptyloxyphenyl group, octyloxyphenyl group, 2-ethylhexyloxyphenyl group, nonyloxyphenyl group, decyloxyphenyl group, 3,7-dimethyloctyloxyphenyl group, lauryloxyphenyl group, etc.

Concrete examples of C₁-C₁₂ alkylphenyl group include methylphenyl group, ethylphenyl group, dimethylphenyl group, propylphenyl group, mesityl group, methylethylphenyl group, i-propylphenyl group, butylphenyl group, i-butylphenyl group, t-butylphenyl group, pentylphenyl group, isoamylphenyl group, hexylphenyl group, heptylphenyl group, octylphenyl group, nonylphenyl group, decylphenyl group, dodecylphenyl group, etc.

The aryloxy group has the number of carbon atoms of usually about 6 to 60, preferably 7 to 48, and concrete examples thereof include phenoxy group, C₁-C₁₂ alkoxyphenoxy group, C₁-C₁₂ alkyl phenoxy group, 1-naphtyloxy group, 2-naphtyloxy group, pentafluorophenyloxy group, etc.; and C₁-C₁₂ alkoxyphenoxy group and C₁-C₁₂ alkylphenoxy group are preferable.

Concrete examples of C₁-C₁₂ alkoxyphenoxy group include methoxphenoxy group, ethoxphenoxy group, propyloxphenoxy group, i-propyloxphenoxy group, butoxphenoxy group, i-butoxy, t-butox, pentyloxy, hexyloxy, cyclohexyloxyphenoxy group, heptyloxphenoxy group, octyloxphenoxy group, 2-ethylhexyloxyphenoxy group, nonyloxphenoxy group, decyloxphenoxy group, 3,7-dimethyloctyloxphenoxy group, lauryloxyphenoxy group, etc.

Concrete examples of C₁-C₁₂ alkylphenoxy group include methylphenoxy group, ethylphenoxy group, dimethylphenoxy group, propylphenoxy group, 1,3,5-trimethylphenoxy group, methylethylphenoxy group, i-propylphenoxy group, butyl phenoxy group, i-butylphenoxy group, t-butylphenoxy group, pentylphenoxy group, isoamylphenoxy group, hexylphenoxy group, heptylphenoxy group, octylphenoxy group, nonylphenoxy group, decylphenoxy group, dodecylphenoxy group, etc.

The arylthio group has the number of carbon atoms of usually about 6 to 60, preferably 7 to 48, and concrete examples thereof include phenylthio group, C₁-C₁₂ alkoxyphenylthio group, C₁-C₁₂ alkylphenylthio group, 1-naphthylthio group, 2-naphthylthio group, pentafluorophenylthio group, etc.; C₁-C₁₂ alkoxy phenylthio group and C₁-C₁₂ alkyl phenylthio group are preferable.

The arylalkyl group has the number of carbon atoms of usually about 7 to 60, preferably 7 to 48, and concrete examples thereof include phenyl-C₁-C₁₂alkyl group, C₁-C₁₂alkoxy phenyl-C₁-C₁₂ alkyl group, C₁-C₁₂ alkylphenyl-C₁-C₁₂ alkyl group, 1-naphtyl-C₁-C₁₂ alkyl group, 2-naphtyl-C₁-C₁₂ alkyl group etc.; and C₁-C₁₂ alkoxyphenyl-C₁-C₁₂ alkyl group and C₁-C₁₂ alkyl phenyl-C₁-C₁₂ alkyl group are preferable.

The arylalkoxy group has the number of carbon atoms of usually about 7 to 60, preferably 7 to 48, and concrete examples thereof include: phenyl-C₁-C₁₂alkoxy groups, such as phenylmethoxy group, phenylethoxy group, phenylbutoxy group, phenylpentyloxy group, phenylhexyloxy group, phenylheptyloxy group, and phenyloctyloxy group; C₁-C₁₂alkoxyphenyl-C₁-C₁₂ alkoxy group, C₁-C₁₂alkylphenyl-C₁-C₁₂alkoxy group, 1-naphtyl-C₁-C₁₂ alkoxy group, 2-naphtyl-C₁-C₁₂ alkoxy group etc.; and C₁-C₁₂ alkoxyphenyl-C₁-C₁₂ alkoxy group and C₁-C₁₂ alkylphenyl-C₁-C₁₂ alkoxy group are preferable.

The arylalkylthio group has the number of carbon atoms of usually about 7 to 60, preferably 7 to 48, and concrete examples thereof include: phenyl-C₁-C₁₂ alkylthio group, C₁-C₁₂ alkoxy phenyl-C₁-C₁₂ alkylthio group, C₁-C₁₂ alkylphenyl-C₁-C₁₂ alkylthio group, 1-naphtyl-C₁-C₁₂ alkylthio group, 2-naphtyl-C₁-C₁₂ alkylthio group, etc.; and C₁-C₁₂ alkoxy phenyl-C₁-C₁₂ alkylthio group and C₁-C₁₂ alkylphenyl-C₁-C₁₂ alkylthio group are preferable.

The arylalkenyl group has the number of carbon atoms of usually about 7 to 60, preferably 7 to 48, and concrete examples thereof include: phenyl-C₂-C₁₂ alkenyl group, C₁-C₁₂ alkoxy phenyl-C₂-C₁₂ alkenyl group, C₁-C₁₂ alkyl phenyl-C₂-C₁₂ alkenyl group, 1-naphtyl-C₂-C₁₂ alkenyl group, 2-naphtyl-C₂-C₁₂alkenyl group, etc.; and C₁-C₁₂ alkoxy phenyl-C₂-C₁₂alkenyl group, and C₂-C₁₂alkyl phenyl-C₁-C₁₂ alkenyl group are preferable.

The arylalkynyl group has the number of carbon atoms of usually about 7 to 60, preferably 7 to 48, and concrete examples thereof include: phenyl-C₂-C₁₂ alkynyl group, C₁-C₁₂ alkoxy phenyl-C₂-C₁₂ alkynyl group, C₁-C₁₂ alkylphenyl-C₂-C₁₂ alkynyl group, 1-naphtyl-C₂-C₁₂alkynyl group, 2-naphtyl-C₂-C₁₂alkynyl group, etc.; and C₁-C₁₂ alkoxyphenyl-C₂-C₁₂ alkynyl group, and C₁-C₁₂ alkylphenyl-C₂-C₁₂ alkynyl group are preferable.

The substituted amino group means a amino group substituted by 1 or 2 groups selected from an alkyl group, aryl group, arylalkyl group, or monovalent heterocyclic group, and said alkyl group, aryl group, arylalkyl group, or monovalent heterocyclic group may have substituent. The substituted amino groups has usually about 1 to 60, preferably 2 to 48 carbon atoms, without including the number of carbon atoms of said substituent.

Concrete examples thereof include methylamino group, dimethylamino group, ethylamino group, diethylamino group, propylamino group, dipropylamino group, i-propylamino group, diisopropylamino group, butylamino group, i-butyl amino group, t-butylamino group, pentylamino group, hexyl amino group, cyclohexylamino group, heptylamino group, octyl amino group, 2-ethylhexylamino group, nonylamino group, decyl amino group, 3,7-dimethyloctylamino group, laurylamino group, cyclopentylamino group, dicyclopentyl amino group, cyclohexyl amino group, dicyclohexylamino group, pyrrolidyl group, piperidyl group, ditrifluoromethylamino group, phenylamino group, diphenylamino group, C₁-C₁₂ alkoxyphenylamino group, di(C₁-C₁₂ alkoxyphenyl)amino group, di(C₁-C₁₂ alkylphenyl) amino group, 1-naphtylamino group, 2-naphtylamino group, pentafluorophenylamino group, pyridylamino group, pyridazinylamino group, pyrimidylamino group, pyrazylamino group, triazylamino group phenyl-C₁-C₁₂ alkylamino group, C₁-C₁₂ alkoxyphenyl-C₁-C₁₂alkylamino group, C₁-C₁₂ alkyl phenyl-C₁-C₁₂ alkylamino group, di(C₁-C₁₂ alkoxyphenyl-C₁-C₁₂ alkyl)amino group, di(C₁-C₁₂ alkylphenyl-C₁-C₁₂ alkyl)amino group, 1-naphtyl-C₁-C₁₂ alkylamino group, 2-naphtyl-C₁-C₁₂ alkylamino group, etc.

The substituted silyl group means a silyl group substituted by 1, 2 or 3 groups selected from an alkyl group, aryl group, arylalkyl group, or monovalent heterocyclic group. The substituted silyl group has usually about 1 to 60, preferably 3 to 48 carbon atoms. Said alkyl group, aryl group, arylalkyl group, or monovalent heterocyclic group may have substituent.

Concrete examples of the substituted silyl group include trimethylsilyl group, triethylsilyl group, tripropylsilyl group, tri-i-propylsilyl group, dimethyl-i-propylsilyl group, diethyl-i-propylsilyl group, t-butylsilyldimethylsilyl group, pentyldimethylsilyl group, hexyldimethylsilyl group, heptyl dimethylsilyl group, octyldimethylsilyl group, 2-ethyl hexyl-dimethylsilyl group, nonyldimethylsilyl group, decyl dimethylsilyl group, 3,7-dimethyloctyl-dimethylsilyl group, lauryldimethylsilyl group, phenyl-C₁-C₁₂ alkylsilyl group, C₁-C₁₂ alkoxyphenyl-C₁-C₁₂ alkylsilyl group, C₁-C₁₂ alkyl phenyl-C₁-C₁₂ alkylsilyl group, 1-naphtyl-C₁-C₁₂ alkylsilyl group, 2-naphtyl-C₁-C₁₂ alkylsilyl group, phenyl-C₁-C₁₂ alkyl dimethylsilyl group, triphenylsilyl group, tri-p-xylylsilyl group, tribenzylsilyl group, diphenylmethylsilyl group, t-butyldiphenylsilyl group, dimethylphenylsilyl group, etc.

As the halogen atom, a fluorine atom, a chlorine atom, a bromine atom, and an iodine atom are exemplified.

The acyl group has usually about 2 to 20 carbon atoms, preferably 2 to 18 carbon atoms, and concrete examples thereof include acetyl group, propionyl group, butyryl group, isobutyryl group, pivaloyl group, benzoyl group, trifluoro acetyl group, pentafluorobenzoyl group, etc.

The acyloxy group has usually about 2 to 20 carbon atoms, preferably 2 to 18 carbon atoms, and concrete examples thereof include acetoxy group, propionyloxy group, butyryloxy group, isobutyryloxy group, pivaloyloxy group, benzoyloxy group, trifluoroacetyloxy group, pentafluorobenzoyl oxy group, etc.

Imine residue is a residue in which a hydrogen atom is removed from an imine compound (an organic compound having —N═C— is in the molecule. Examples thereof include aldimine, ketimine, and compounds whose hydrogen atom on N is substituted with an alkyl group etc.), and usually has about 2 to 20 carbon atoms, preferably 2 to 18 carbon atoms. As the concrete examples, groups represented by below structural formulas are exemplified.

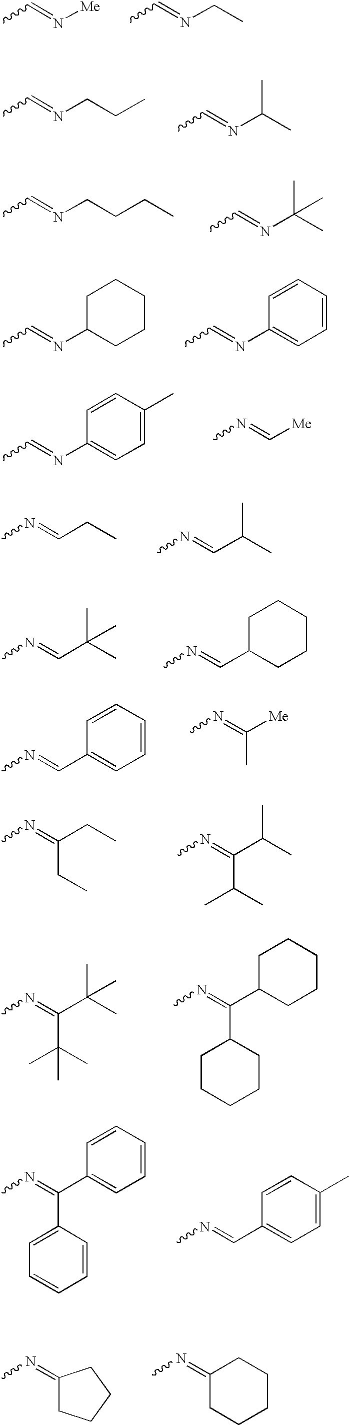

The amide group has usually about 2 to 20 carbon atoms, preferably 2 to 18 carbon atoms, and specific examples thereof include formamide group, acetamide group, propioamide group, butyroamide group, benzamide group, trifluoroacetamide group, pentafluoro benzamide group, diformamide group, diacetoamide group, dipropioamide group, dibutyroamide group, dibenzamide group, ditrifluoro acetamide group, dipentafluorobenzamide group, etc.

Examples of the acid imide group include residual groups in which a hydrogen atom connected with nitrogen atom is removed, and have usually about 2 to 60 carbon atoms, preferably 2 to 48 carbon atoms. As the concrete examples of acid imide group, the following groups are exemplified.

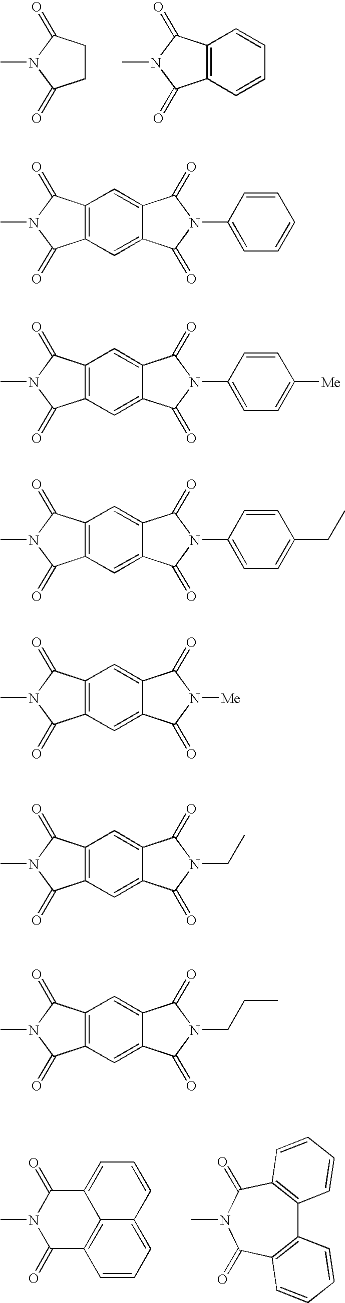

The monovalent heterocyclic group means an atomic group in which a hydrogen atom is removed from a heterocyclic compound, and the number of carbon atoms is usually about 4 to 60, preferably 4 to 20. The number of carbon atoms of the substituent is not contained in the number of carbon atoms of a heterocyclic group. The heterocyclic compound means an organic compound having a cyclic structure in which at least one heteroatom such as oxygen, sulfur, nitrogen, phosphorus, boron, etc. is contained in the cyclic structure as the element other than carbon atoms. Concrete examples thereof include thienyl group, C₁-C₁₂ alkylthienyl group, pyroryl group, furyl group, pyridyl group, C₁-C₁₂ alkylpyridyl group, piperidyl group, quinolyl group, isoquinolyl group, etc.; and thienyl group, C₁-C₁₂ alkylthienyl group, pyridyl group, and C₁-C₁₂ alkylpyridyl group are preferable.

The substituted carboxyl group means a carboxyl group substituted by alkyl group, aryl group, arylalkyl group, or monovalent heterocyclic group, and has usually about 2 to 60, preferably 2 to 48 carbon atoms. Concrete examples thereof include methoxy carbonyl group, ethoxycarbonyl group, propoxycarbonyl group, i-propoxycarbonyl group, butoxycarbonyl group, i-butoxy carbonyl group, t-butoxycarbonyl group, pentyloxycarbonyl group, hexyloxycarbonyl group, cyclohexyloxycarbonyl group, heptyloxycarbonyl group, octyloxycarbonyl group, 2-ethylhexyloxycarbonyl group, nonyloxycarbonyl group, decyloxycarbonyl group, 3,7-dimethyloctyloxycarbonyl group, dodecyloxycarbonyl group, trifluoromethoxycarbonyl group, pentafluoroethoxycarbonyl group, perfluorobutoxycarbonyl group, perfluorohexyloxycarbonyl group, perfluorooctyloxy carbonyl group, phenoxycarbonyl group, naphtoxycarbonyl group, pyridyloxycarbonyl group, etc. Said alkyl group, aryl group, arylalkyl group, or monovalent heterocyclic group may have substituent. The number of carbon atoms of said substituent is not contained in the number of carbon atoms of the substituted carboxyl group.

Among the above, in the groups containing an alkyl, they may be any of linear, branched or cyclic, or may be the combination thereof. In case of not linear, isoamyl group, 2-ethylhexyl group, 3,7-dimethyloctyl group, cyclohexyl group, 4-C₁-C₁₂ alkylcyclohexyl group, etc., are exemplified. Moreover, the tips of two alkyl chains may be connected to form a ring. Furthermore, a part of methyl groups and methylene groups of alkyl, may be replaced by a group containing hetero atom, or a methyl or methylene group substituted by one or more fluorine. As the hetero atoms, an oxygen atom, a sulfur atom, a nitrogen atom, etc., are exemplified.

Furthermore, in the examples of the substituents, when an aryl group or a heterocyclic group is included in the part thereof, they may have one or more substituents.

In order to improve the solubility in a solvent, it is preferable that Ar₁, Ar₂, Ar₃ and Ar₄ have substituent, and one or more of them include an alkyl group or alkoxy group having cyclic or long chain. Examples thereof include cyclopentyl group, cyclohexyl group, pentyl group, isoamyl group, hexyl group, octyl group, 2-ethylhexyl group, decyl group, 3,7-dimethyloctyl group, pentyloxy group, isoamyloxy group, hexyloxy group, octyloxy group, 2-ethylhexyloxy group, decyloxy group, and 3,7-dimethyloctyloxy group.

Two substituents may be connected to form a ring. Furthermore, a part of carbon atom of the alkyl may be replaced by a group containing a hetero atom, and examples of the hetero atom include an oxygen atom, a sulfur atom, a nitrogen atom, etc.

Examples of the repeating unit represented by the above formula (2) include a repeating unit of the following formula (6), (7), (8), (9), (10) and (11).

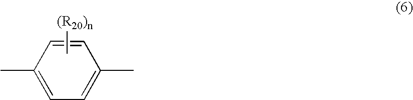

(wherein, R₂₀ represents an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group or cyano group. n represents an integer of 0 to 4. When a plurality of R₂₀s are present, they may be the same or different.)

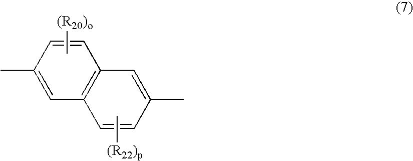

(wherein, R₂₁, and R₂₂ each independently represent an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group or cyano group. o and p each independently represent an integer of 0 to 3. When R₂₁ and R₂₂ are present each in plural number, they may be the same or different.)

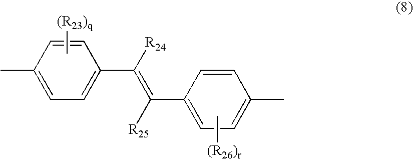

(wherein, R₂₃ and R₂₆ each independently represent an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group or cyano group. q and r each independently represent an integer of 0 to 4. R₂₄ and R₂₅ each independently represent a hydrogen atom, alkyl group, aryl group, monovalent heterocyclic group, carboxyl group, substituted carboxyl group or cyano group. When R₂₃ and R₂₆ are present in plural number, they may be the same or different.)

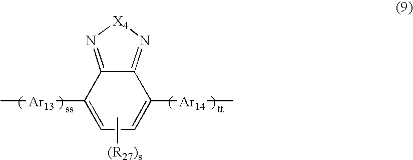

(wherein, R₂₇ represents an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group or cyano group. s represents an integer of 0 to 2. Ar₁₃ and Ar₁₄ each independently represent an arylene group, divalent heterocyclic group or divalent group having a metal complex structure. ss and tt each independently represent 0 or 1. X₄ represents O, S, SO, SO₂, Se or Te. When a plurality of R₂₇s are present, they may be the same or different.)

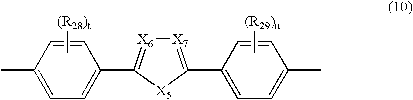

(wherein, R₂₈ and R₂₉ each independently represent an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group or cyano group. t and u each independently represent an integer of 0 to 4. X₅ represents O, S, SO₂, Se, Te, N—R₃₀ or SiR₃₁R₃₂. X₆ and X₇ each independently represent N or C—R₃₃. R₃₀, R₃₁, R₃₂ and R₃₃ each independently represent a hydrogen atom, alkyl group, aryl group, arylalkyl group or monovalent heterocyclic group. When R₂₈, R₂₉ and R₃₃ are present in plural number, they may be the same or different.)

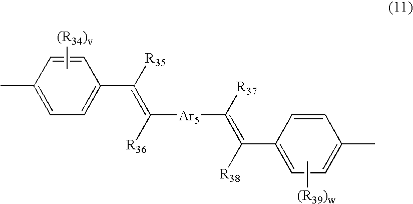

(wherein, R₃₄ and R₃₉ each independently represent an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group or cyano group. v and w each independently represent an integer of 0 to 4. R₃₅, R₃₆, R₃₇ and R₃₈ each independently represent a hydrogen atom, alkyl group, aryl group, monovalent heterocyclic group, carboxyl group, substituted carboxyl group or cyano group. Ar₅ represents an arylene group, divalent heterocyclic group or divalent group having a metal complex structure. When R₃₄ and R₃₉ are present in plural number, they may be the same or different).

Examples of the repeating unit represented by the above formula (3) include a repeating unit of the following formula (13).

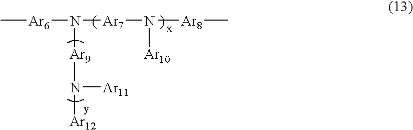

(wherein, Ar₆, Ar₇, Ara and Ar₉ each independently represent an arylene group or divalent heterocyclic group. Ar₁₀, Ar₁₁ and Ar₁₂ each independently represent an aryl group or monovalent heterocyclic group. Ar₆, Ar₇, Ar₈, Ar₉ and Ar₁₀ may have a substituent. x and y each independently represent 0 or 1, and 0=x+y=1).

Among the structures represented by the above formula (2) to (5), structures represented by the below formula (13) are preferable.

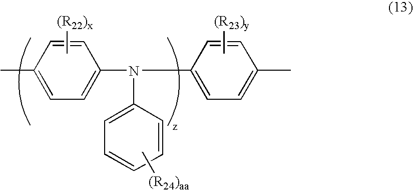

(wherein, R₂₂, R₂₃ and R₂₄ each independently represent an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group, or cyano group. x and y each independently represent an integer of 0-4. z represents an integer of 1-2. aa represents an integer of 0-5.)

As R₂₄ in the above formula (13), an alkyl group, alkoxy group, aryl group, aryloxy group, arylalkyl group, arylalkoxy group, substituted amino group are preferable. As the substituted amino group, diaryl amino group is preferable, and diphenyl amino group is more preferable.

In the above, combinations of the above formula (I-6) with the above formula (5), (7), (8) or (11) are preferable, and combinations of formula (I-6) with formula (8) or (11) are more preferable.

In the structure represented by the above formula (I-6), it is preferable that Y is S atom or O atom.

Furthermore, the end group of polymer compound used for the present invention may also be protected with a stable group since if a polymerization active group remains intact, there is a possibility of reduction in light emitting property and life-time when made into an device. Those having a conjugated bond continuing to a conjugated structure of the main chain are preferable, and there are exemplified structures connected to an aryl group or heterocyclic compound group via a carbon-carbon bond. Specifically, substituents described as Chemical Formula 1 in JP-A-9-45478 are exemplified.

The polymer compound used for the present invention may also be a random, block or graft copolymer, or a polymer having an intermediate structure thereof, for example, a random copolymer having block property. From the viewpoint for obtaining a polymer compound having high fluorescent quantum yield, random copolymers having block property and block or graft copolymers are preferable than complete random copolymers. Further, a polymer having a branched main chain and more than three terminals, and a dendrimer may also be included.

The polymer compound used for the present invention, it is preferable that the polystyrene reduced number average molecular weights is 10³-10⁸, and more preferably 10⁴-10⁷.

As the manufacture method of the polymer compound used for the light emitting material, a monomer having a plurality of polymerization active groups is dissolved in an organic solvent according to necessity, and can be reacted using alkali or appropriate catalyst, at a temperature between the boiling point and the melting point of the organic solvent.

For example, known methods which can be used are described in: Organic Reactions, volume 14, page 270-490, John Wiley & Sons, Inc., 1965; Organic Syntheses, Collective Volume VI, page 407-411, John Wiley & Sons, Inc., 1988; Chemical Review (Chem. Rev.), Volume 95, page 2457 (1995); Journal of Organometallic Chemistry (J. Organomet. Chem.), Volume 576, page 147 (1999); and Macromolecular Chemistry, Macromolecular Symposium (Makromol. Chem., Macromol. Symp.), Volume 12th, page 229 (1987).

In the manufacture method of the polymer compound used for the composition of the present invention, known condensation reactions can be used as the method of carrying out condensation polymerization. As the method of condensation polymerization, in case of producing double bond, for example, a method described in JP-A-5-202355 is exemplified.

That is, exemplified are: a polymerization by Wittig reaction of a compound having formyl group and a compound having phosphonium-methyl group, or a compound having formyl group and phosphonium-methyl group; polymerization by Heck reaction of a compound having vinyl group and a compound having halogen atom; polycondensation by dehydrohalogenation method of a compound having two or more monohalogenated-methyl groups; polycondensation by sulfonium-salt decomposition method of a compound having two or more sulfonium-methyl groups; polymerization by Knoevenagel reaction of a compound having formyl group and a compound having cyano group; and polymerization by McMurry reaction of a compound having two or more formyl groups.

When a polymer compound of the present invention has a triple bond in the main chain by condensation polymerization, for example, Heck reaction can be used.

In case of producing neither a double bond nor a triple bond, exemplified are: a method of polymerization by Suzuki coupling reaction from corresponding monomer; a method of polymerization by Grignard reaction; a method of polymerization by Ni(0) complex; a method of polymerization by oxidizers, such as FeCl₃; a method of electrochemical oxidization polymerization; and a method by decomposition of an intermediate polymer having a suitable leaving group.

Among these, a polymerization by Wittig reaction, a polymerization by Heck reaction, a polymerization by Knoevenagel reaction, a method of polymerization by Suzuki coupling reaction, a method of polymerization by Grignard reaction, and a method of polymerization by nickel zero-valent complex are preferable, since it is easy to control the structure.

When the reactive substituent in the raw monomer for the polymer compound used for the present invention is a halogen atom, alkylsulfonate group, arylsulfonate group, or arylalkylsulfonate group, a manufacture method by condensation polymerization in the existence of nickel-zero-valent-complex is preferable.

As the raw compound, a dihalogenated compound, bis (alkylsulfonate) compound, bis(arylsulfonate) compound, bis (arylalkylsulfonate) compound, or halogen-alkylsulfonate compound, halogen-arylsulfonate compound, halogen-arylalkylsulfonate compound, alkylsulfonate-arylsulfonate compound, alkylsulfonate-arylalkylsulfonate compound are exemplified.

Moreover, When the reactive substituent in the raw monomer for the polymer compound used for the present invention is a a halogen atom, alkylsulfonate group, arylsulfonate group, arylalkylsulfonate group, boric-acid group, or boric acid ester group, it is preferable that the ratio of the total mol of a halogen atom, alkylsulfonate group, arylsulfonate group, and arylalkylsulfonate group, with the total of boric-acid group and boric acid ester group is substantially 1 (usually in the range of 0.7 to 1.2), and the manufacture method is a condensation polymerization using a nickel catalyst or a palladium catalyst.

Concrete examples of the combination of raw compounds include combinations of a dihalogenated compound, bis (alkylsulfonate) compound, bis(arylsulfonate) compound or bis(arylalkylsulfonate) compound, with a diboric acid compound, or diboric acid ester compound.

Moreover, halogen-boric-acid compound, halogen-boric acid ester compound, alkylsulfonate-boric-acid compound, alkylsulfonate-boric acid ester compound, arylsulfonate-boric-acid compound, arylsulfonate-boric acid ester compound, arylalkylsulfonate-boric-acid compound, and arylalkylsulfonate-boric acid ester compound are exemplified.

It is preferable that the organic solvent used is subjected to a deoxygenation treatment sufficiently and the reaction is progressed under an inert atmosphere, generally for suppressing a side reaction, though the treatment differs depending on compounds and reactions used. Further, it is preferable to conduct a dehydration treatment likewise. However, this is not applicable in the case of a reaction in a two-phase system with water, such as a Suzuki coupling reaction.

For the reaction, alkali or a suitable catalyst is added. It can be selected according to the reaction to be used. It is preferable that the alkali or the catalyst can be dissolved in a solvent used for a reaction. Example of the method for mixing the alkali or the catalyst, include a method of adding a solution of alkali or a catalyst slowly, to the reaction solution with stirring under an inert atmosphere of argon, nitrogen, etc. or conversely, a method of adding the reaction solution to the solution of alkali or a catalyst slowly.

When the polymer compounds of the present invention are used for a polymer LED, the purity thereof exerts an influence on light emitting property, therefore, it is preferable that a monomer is purified by a method such as distillation, sublimation purification, re-crystallization and the like before being polymerized. Further, it is preferable to conduct a purification treatment such as re-precipitation purification, chromatographic separation and the like after the polymerization.

Next, the compound (triplet light-emission compound) showing light-emission from triplet excited state used for the composition of the present invention will be explained. The compound showing light-emission from triplet excited state includes a complex in which phosphorescence light-emission is observed, and also a complex in which fluorescence light-emission is observed in addition to the phosphorescence light-emission.

In the triplet light-emission compound, as a complex compound (triplet light-emitting complex compound), a metal complex compound which has been used as a low molecular weight EL light-emission material from the former is exemplified.

These are disclosed by, for example, Nature, (1998) 395, 151; Appl. Phys. Lett. (1999), 75(1), 4; Proc. SPIE-Int. Soc. Opt. Eng. (2001), 4105 (Organic Light-Emitting Materials and Devices IV, 119; J. Am. Chem. Soc., (2001), 123, 4304; Appl. Phys. Lett., (1997), 71(18), 2596; Syn. Met., (1998), 94(1), 103; Syn. Met., (1999), 99(2), 1361; Adv. Mater., (1999), 11 (10) 852, etc.

The center metal of a complex emitting triplet luminescence is usually an atom having an atomic number of 50 or more, and is a metal manifesting a spin-orbital mutual action on this complex and showing a possibility of the intersystem crossing between the singlet state and the triplet state.

As the center metal of a complex emitting triplet luminescence, for example, rhenium, iridium, osmium, scandium, yttrium, platinum, gold, and europium such as lanthanoids, terbium, thulium, dysprosium, samarium, praseodymium, and the like, are exemplified, and iridium, platinum, gold and europium are preferable, iridium, platinum and gold are particularly preferable, and iridium is the most preferable.

As the ligand of a triplet light-emitting complex compound, for example, 8-quinolinol and derivatives thereof, benzoquinolinol and derivatives thereof, 2-phenyl-pyridine and derivatives thereof, 2-phenyl-benzothiazole and derivatives thereof, 2-phenyl-benzoxazole and derivatives thereof, porphyrin and derivatives thereof, and the like are exemplified.

Examples of the triplet light-emitting complex compound include followings.

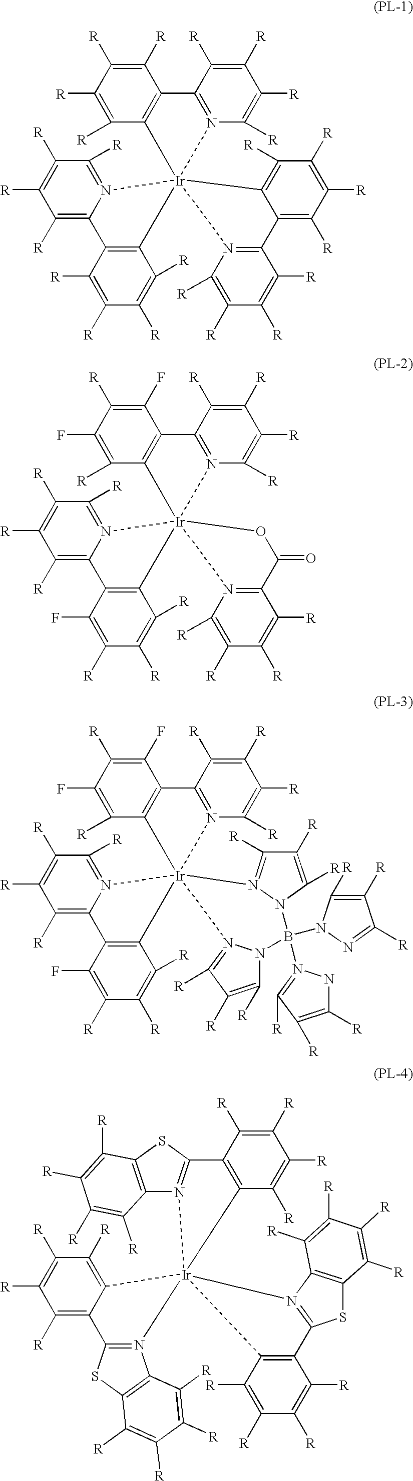

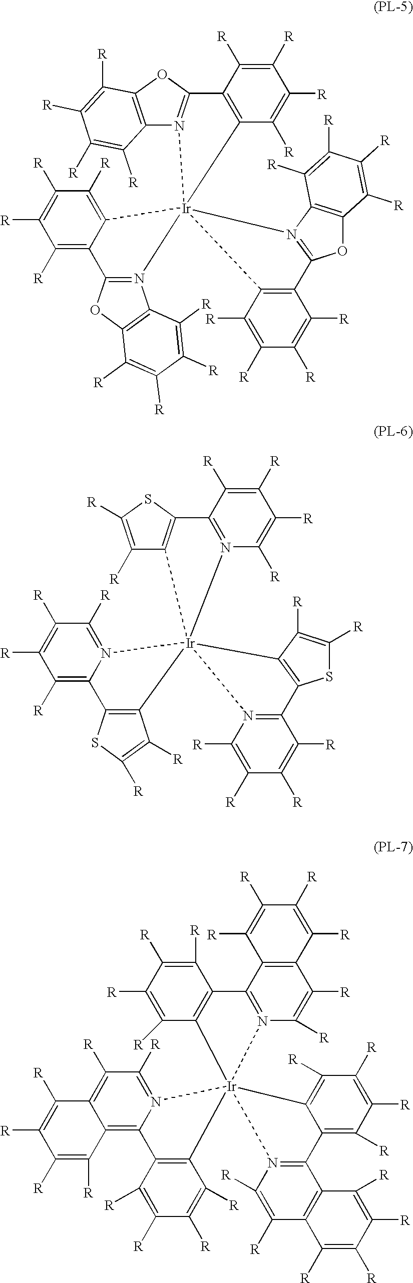

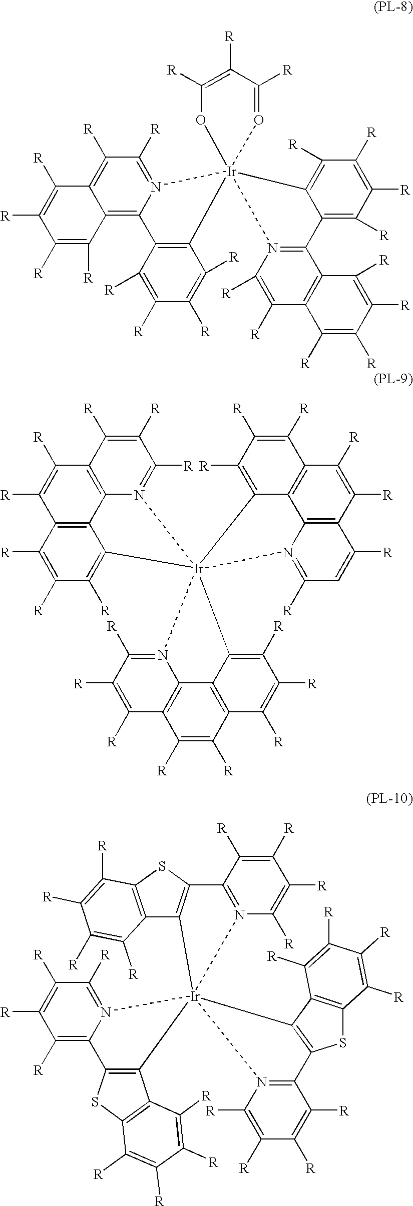

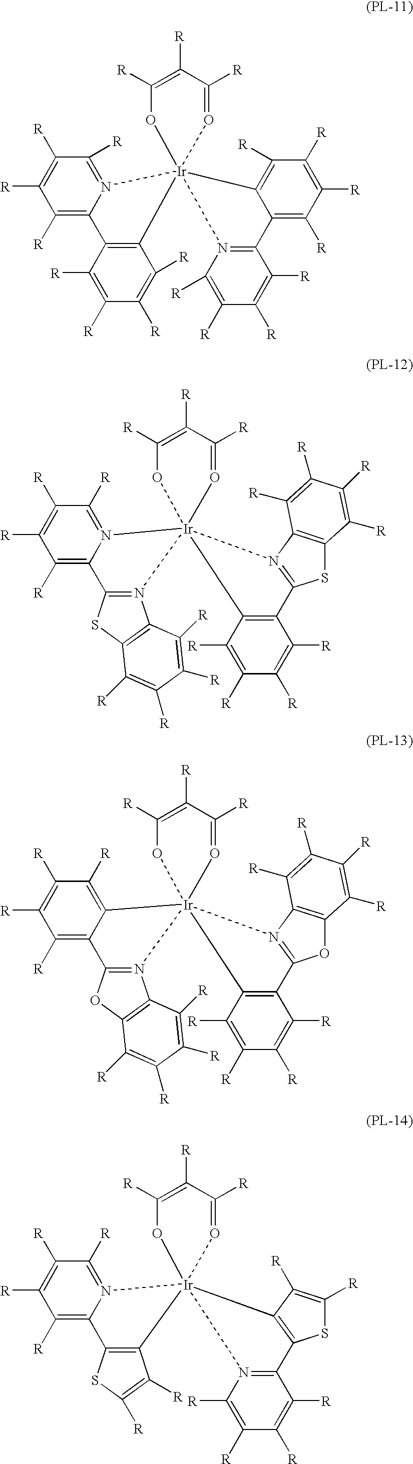

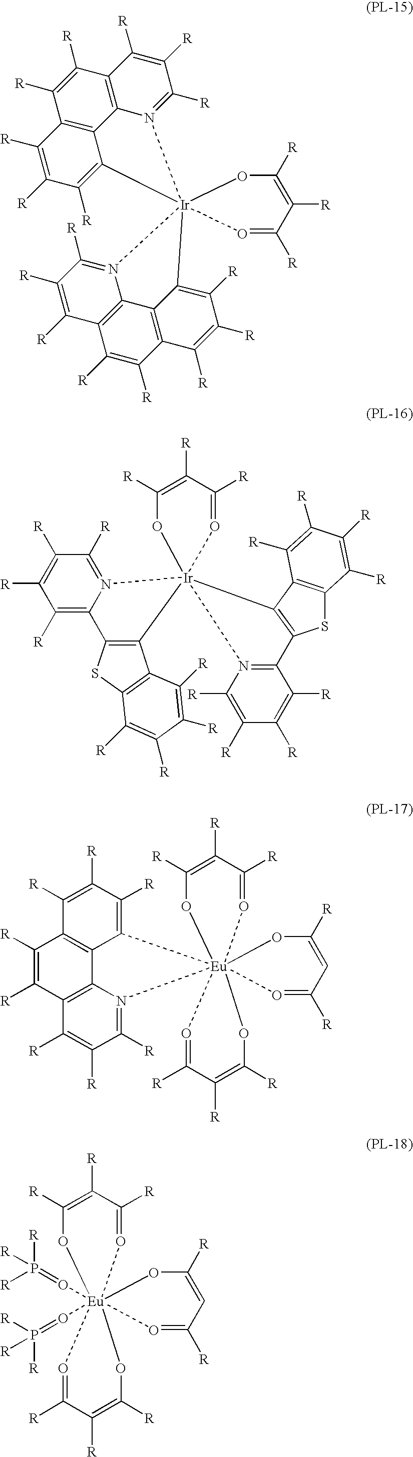

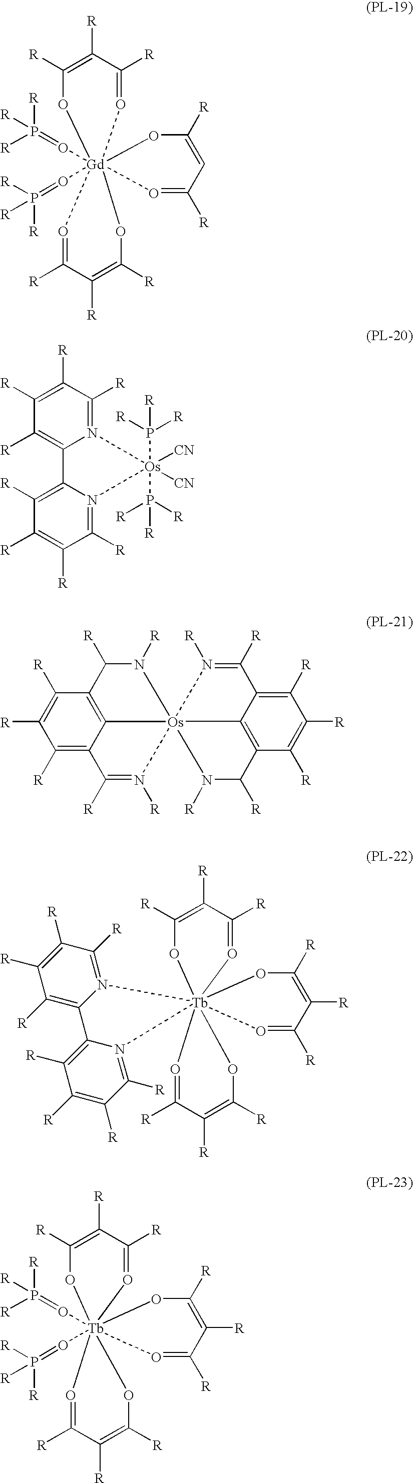

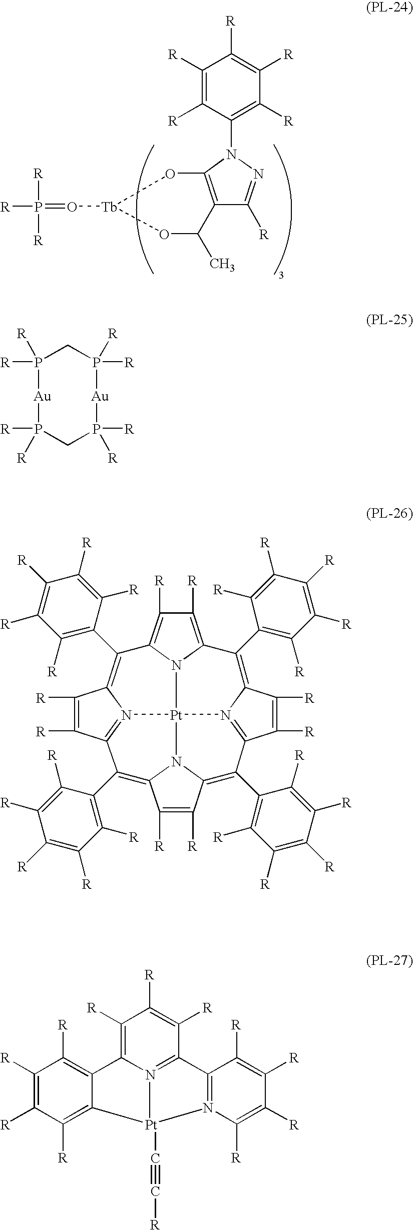

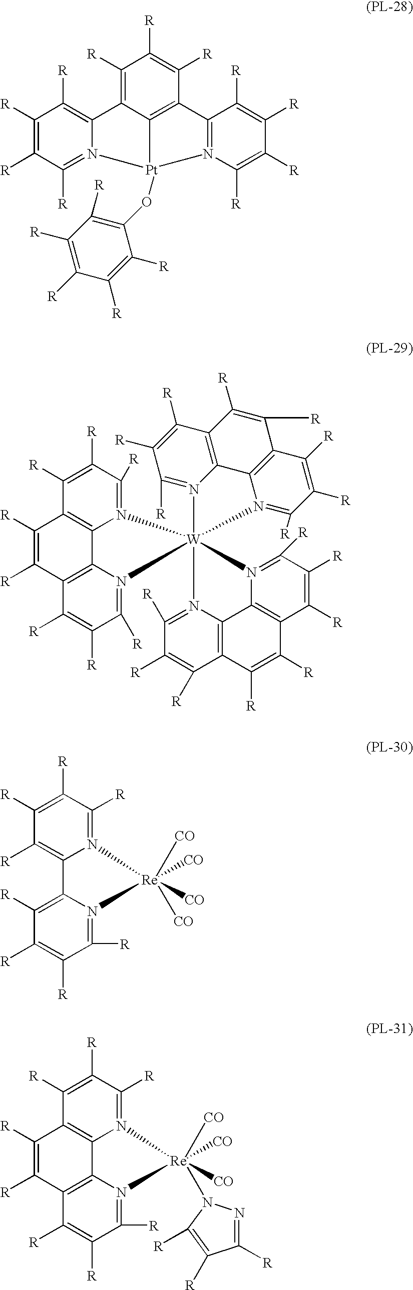

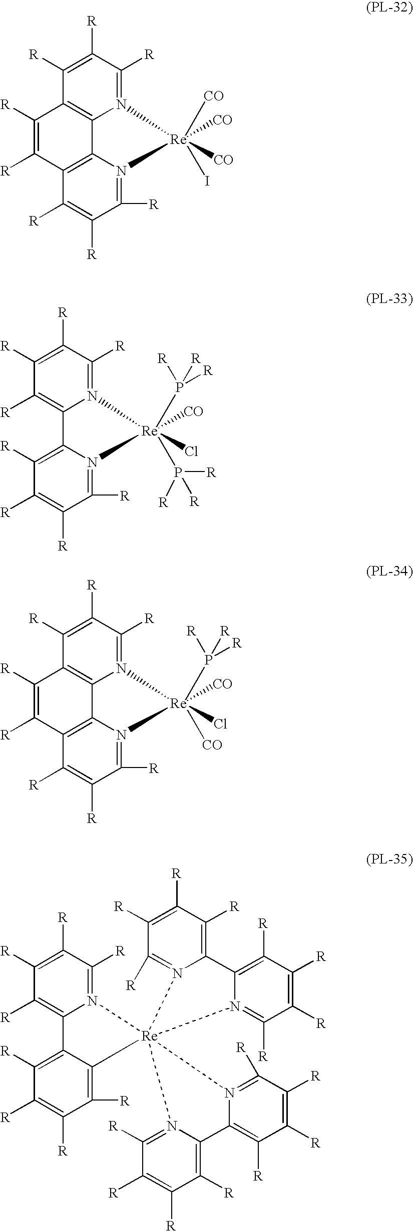

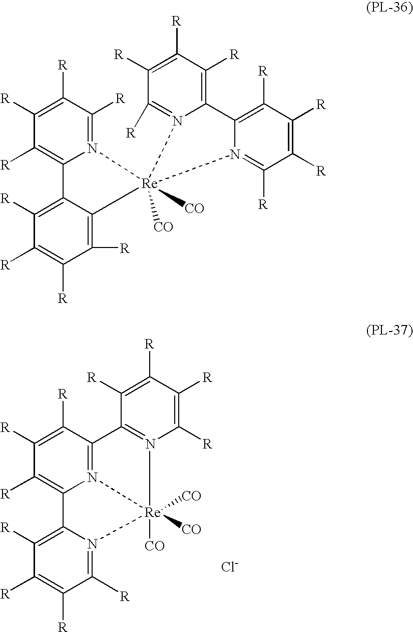

wherein, R each independently represents a group selected from a hydrogen atom, alkyl group, alkoxy group, alkylthio group, alkylsilyl group, alkylamino group, aryl group, aryloxy group, arylalkyl group, arylalkoxy group, arylalkenyl group, arylalkynyl group, arylamino group, monovalent heterocyclic group, and cyano group. In order to improve the solubility in a solvent, alkyl group and alkoxy group are preferable, and it is preferable that the repeating unit including substituent has a form of little symmetry.

As the triplet light-emitting complex compound, still in detail, the structures of the below formula (15) are exemplified.

(H)ₒ-M-(K)ₘ (15)

Wherein, K represents: a ligand containing an atom which bonds with one or more M selected from a nitrogen atom, oxygen atom, carbon atom, sulfur atom, and phosphorus atom; a halogen atom; or a hydrogen atom. Furthermore, o represents an integer of 0-5, and m represents an integer of 1-5.

As the ligand containing an atom which bonds with one or more M selected from a nitrogen atom, oxygen atom, carbon atom, sulfur atom, and phosphorus atom, an alkyl group, alkoxy group, acyloxy group, alkylthio group, alkylamino group, aryl group, aryloxy group, arylthio group, arylamino group, arylalkyl group, arylalkoxy group, arylalkylthio group, arylalkylamino group, sulfonate group, cyano group, heterocyclic ligand, a carbonyl compound, ether, amine, imine, phosphine, phosphite, and sulfide are exemplified. The bond of this ligand with M may be a coordinate bond or a covalent bond. Moreover, it may be a multi-dentate ligand combined thereof.

The alkyl group may be any of linear, branched or cyclic, and may have substituent. The number of carbon atoms is usually about 1 to 20. Concrete examples thereof include methyl group, ethyl group, propyl group, i-propyl group, butyl group, i-butyl group, t-butyl group, pentyl group, hexyl group, cyclohexyl group, heptyl group, Octyl group, 2-ethylhexyl group, nonyl group, decyl group, 3,7-dimethyloctyl group, lauryl group, trifluoromethyl group, pentafluoroethyl group, perfluorobutyl group, perfluorohexyl group, perfluorooctyl group, etc.; and pentyl group, hexyl group, octyl group, 2-ethylhexyl group, decyl group, and 3,7-dimethyl octyl group are preferable.

The alkoxy group may be any of linear, branched or cyclic, and may have substituent. The number of carbon atoms is usually about 1 to 20. Concrete examples thereof include methoxy group, ethoxy group, propyloxy group, i-propyloxy group, butoxy group, i-butoxy group, t-butoxy group, pentyloxy group, hexyloxy group, cyclohexyloxy group, heptyloxy group, octyloxy group, 2-ethylhexyloxy group, nonyloxy group, decyloxy group, 3,7-dimethyloctyloxy group, lauryloxy group, trifluoro methoxy group, pentafluoroethoxy group, perfluorobutoxy group, perfluorohexyl group, perfluorooctyl group, methoxymethyloxy group, 2-methoxyethyloxy group, etc.; and pentyloxy group, hexyloxy group, octyloxy group, 2-ethylhexyloxy group, decyloxy group, and 3,7-dimethyloctyloxy group are preferable.

The acyloxy group has usually about 2 to 20 carbon atoms, and concrete examples thereof include acetyloxy group, trifluoroacetyloxy group, propionyloxy group, and benzoyl oxy group. As the sulfoneoxy group, benzene sulfoneoxy group, p-toluene sulfoneoxy group, methane sulfoneoxy group, ethane sulfoneoxy group, and trifluoromethane sulfoneoxy group are exemplified.

The alkylthio group may be any of linear, branched or cyclic, and may have substituent. The number of carbon atoms is usually about 1 to 20. Concrete examples thereof include methylthio group, ethylthio group, propylthio group, and i-propylthio group, butylthio group, i-butylthio group, t-butylthio group, pentylthio group, hexylthio group, cyclohexylthio group, heptylthio group, octylthio group, 2-ethylhexylthio group, nonylthio group, decylthio group, 3,7-dimethyloctylthio group, laurylthio group, trifluoromethylthio group, etc.; and pentylthio group, hexylthio group, octylthio group, 2-ethyl hexylthio group, decylthio group, and 3,7-dimethyl octylthio group are preferable.

The alkylamino group may be any of linear, branched or cyclic, and may be monoalkylamino group or dialkylamino group. The number of carbon atoms is usually about 1 to 40. Concrete examples thereof include methylamino group, dimethyl amino group, ethylamino group, diethylamino group, propylamino group, dipropylamino group, i-propylamino group, diisopropyl amino group, butylamino group, i-butylamino group, t-butyl amino group, pentylamino group, hexylamino group, cyclohexyl amino group, heptylamino group, octylamino group, 2-ethyl hexylamino group, nonylamino group, decylamino group, 3,7-dimethyloctylamino group, laurylamino group, cyclopentyl amino group, dicyclopentylamino group, cyclohexylamino group, dicyclohexylamino group, pyrrolidyl group, piperidyl group, ditrifluoromethylamino group, etc.; and pentylamino group, hexylamino group, octylamino group, 2-ethylhexylamino group, decylamino group, and 3,7-dimethyloctylamino group are preferable.

The aryl group may have substituent, and the number of carbon atoms is usually about 3 to 60, and concrete examples thereof include phenyl group, C₁-C₁₂ alkoxyphenyl group (C₁-C₁₂ means the number of carbon atoms 1-12. Hereinafter the same), C₁-C₁₂ alkylphenyl group, 1-naphtyl group, 2-naphtyl group, pentafluorophenyl group, pyridyl group, pyridazinyl group, pyrimidyl group, pyrazyl group, triazyl group, etc.; and C₁-C₁₂ alkoxyphenyl group and C₁-C₁₂ alkylphenyl group are preferable.

The aryloxy group may have substituent on the aromatic ring, and the number of carbon atoms is usually about 3 to 60. Concrete examples thereof include phenoxy group, C₁-C₁₂ alkoxyphenoxy group, C₁-C₁₂ alkylphenoxy group, 1-naphtyloxy group, 2-naphtyloxy group, pentafluorophenyloxy group, pyridyloxy group, pyridazinyloxy group, pyrimidyloxy group, pyrazyloxy group, triazyloxy group, etc.; and C₁-C₁₂ alkoxyphenoxy group and C₁-C₁₂ alkylphenoxy group are preferable.

The arylthio group may have substituent on the aromatic ring, and the number of carbon atoms is usually about 3 to 60. Concrete examples thereof include phenylthio group, C₁-C₁₂ alkoxyphenylthio group, C₁-C₁₂ alkylphenylthio group, 1-naphthylthio group, 2-naphthylthio group, pentafluoro phenylthio group, pyridylthio group, pyridazinylthio group, pyrimidylthio group, pyrazylthio group, triazylthio group, etc.; and C₁-C₁₂ alkoxyphenylthio group and C₁-C₁₂ alkyl phenylthio group are preferable.

The arylamino group may have substituent on the aromatic ring, and the number of carbon atoms is usually about 3 to 60. Concrete examples thereof include phenyl amino group, diphenylamino group, C₁-C₁₂ alkoxyphenylamino group, di(C₁-C₁₂ alkoxyphenyl)amino group, di(C₁-C₁₂ alkylphenyl)amino group, 1-naphtylamino group, 2-naphtylamino group, pentafluoro phenylamino group, pyridylamino group, pyridazinylamino group, pyrimidylamino group, pyrazylamino group, triazylamino group, etc.; and C₁-C₁₂ alkylphenylamino group and di(C₁-C₁₂ alkyl phenyl)amino group are preferable.

The arylalkyl group may have substituent on the aromatic ring, and the number of carbon atoms is usually about 7 to 60. Concrete examples thereof include phenyl-C₁-C₁₂ alkyl group, C₁-C₁₂ alkoxyphenyl-C₁-C₁₂ alkyl group, C₁-C₁₂ alkyl phenyl-C₁-C₁₂ alkyl group, 1-naphtyl-C₁-C₁₂ alkyl group, 2-naphtyl-C₁-C₁₂ alkyl group etc.; and C₁-C₁₂ alkoxy phenyl-C₁-C₁₂ alkyl group and C₁-C₁₂ alkylphenyl-C₁-C₁₂ alkyl group are preferable.

The arylalkoxy group may have substituent on the aromatic ring, and the number of carbon atoms is usually about 7 to 60. Concrete examples thereof include phenyl-C₁-C₁₂ alkoxy group, C₁-C₁₂ alkoxyphenyl-C₁-C₁₂ alkoxy group, C₁-C₁₂ alkyl phenyl-C₁-C₁₂ alkoxy group, 1-naphtyl-C₁-C₁₂ alkoxy group, 2-naphtyl-C₁-C₁₂ alkoxy group etc.; and C₁-C₁₂ alkoxy phenyl-C₁-C₁₂ alkoxy group and C₁-C₁₂ alkyl phenyl-C₁-C₁₂ alkoxy group are preferable.

The arylalkylthio group may have substituent on the aromatic ring, and the number of carbon atoms is usually about 7 to 60. Concrete examples thereof include phenyl-C₁-C₁₂ alkoxy group, C₁-C₁₂ alkoxyphenyl-C₁-C₁₂ alkoxy group, C₁-C₁₂ alkyl phenyl-C₁-C₁₂ alkoxy group, 1-naphtyl-C₁-C₁₂ alkoxy group, 2-naphtyl-C₁-C₁₂ alkoxy group etc.; and C₁-C₁₂ alkoxy phenyl-C₁-C₁₂ alkoxy group and C₁-C₁₂ alkyl phenyl-C₁-C₁₂ alkoxy group are preferable.

The arylalkylamino group has usually about 7 to 60 carbon atoms, and concrete examples thereof include phenyl-C₁-C₁₂ alkylamino group, C₁-C₁₂ alkoxyphenyl-C₁-C₁₂ alkylamino group, C₁-C₁₂ alkylphenyl-C₁-C₁₂ alkylamino group, di(C₁-C₁₂ alkoxy phenyl-C₁-C₁₂ alkyl)amino group, di(C₁-C₁₂ alkylphenyl-C₁-C₁₂ alkyl)amino group, 1-naphtyl-C₁-C₁₂ alkylamino group, 2-naphtyl-C₁-C₁₂ alkylamino group, etc.; and C₁-C₁₂ alkyl phenyl-C₁-C₁₂ alkylamino group and di(C₁-C₁₂ alkyl phenyl-C₁-C₁₂ alkyl)amino group are preferable.

Examples of the sulfonate group include benzenesulfonate group, p-toluenesulfonate group, methanesulfonate group, ethanesulfonate group, and trifluoromethanesulfonate group.

The heterocyclic ligand is a ligand which is constituted by bonding heterocycles, such as a pyridine ring, pyrrole ring, thiophene ring, oxazole, furan ring, and a benzene ring. Concrete examples thereof include phenylpyridine, 2-(para phenylphenyl)pyridine, 7-bromobenzo[h]quinoline, 2-(4-thiophene-2-yl)pyridine, 2-(4-phenylthiophene-2-yl)pyridine, 2-phenylbenzoxazole, 2-(paraphenylphenyl)benzoxazole, 2-phenylbenzothiazole, 2-(paraphenylphenyl)benzothiazole, 2-(benzothiophene-2-yl)pyridine, 1,10-phenanthroline, 2,3,7,8,12,13,17,18-octa ethyl-21H,23H-porphyrin, etc. It may be either a coordinate bond or a covalent bond.

As the carbonyl compound, exemplified are those having a coordinate bond to M by the oxygen atom, and examples thereof include ketones, such as carbon monoxide, and acetone, benzophenone; and diketones, such as, acetyl acetone, and acenaphtho quinone.

As the ether, exemplified are those having a coordinate bond to M by the oxygen atom, and examples thereof include dimethyl ether, diethyl ether, tetrahydrofuran, 1,2-dimethoxy ethane, etc.

As the amine, exemplified are those having a coordinate bond to M by the nitrogen atom, and examples thereof include: mono amines, such as trimethylamine, triethyl amine, tributyl amine, tribenzyl amine, triphenyl amine, dimethylphenyl amine, and methyldiphenyl amine; and diamines, such as 1,1,2,2-tetramethylethylene diamine, 1,1,2,2-tetraphenyl ethylene diamine, and 1,1,2,2-tetramethyl-o-phenylene diamine.

As the imine, exemplified are those having a coordinate bond to M by the nitrogen atom, and examples thereof include: mono imines, such as benzylidene aniline, benzylidene benzyl amine, and benzylidene methylamine; and diimines, such as dibenzylidene ethylene diamine, dibenzylidene-o-phenylene diamine, and 2,3-bis(anilino)butane.

As the phosphine, exemplified are those having a coordinate bond to M by the phosphorus atom, and examples thereof include: triphenyl phosphine, diphenyl phosphino ethane, and diphenyl phosphino propane. As the phosphite, exemplified are those having a coordinate bond to M by the phosphorus atom, and examples thereof include trimethylphosphite, triethyl phosphite, and triphenylphosphite.

As the sulfide, exemplified are those having a coordinate bond to M by the sulfur atom, and examples thereof include dimethyl sulfide, diethyl sulfide, diphenyl sulfide, and thioanisole.

M represents a metal atom having an atomic number of 50 or more and showing a possibility of the intersystem crossing between the singlet state and the triplet state in this complex by a spin-orbital mutual action.

As the multidentate ligand which is the combination of an alkyl group, alkoxy group, acyloxy group, alkylthio group, alkylamino group, aryl group, aryloxy group, arylthio group, arylamino group, arylalkyl group, arylalkoxy group, arylalkylthio group, arylalkylamino group, sulfonate group, cyano group, a heterocyclic ligand, a carbonyl compound, ether, amine, imine, phosphine, phosphite, and sulfide, exemplified are acetonates, such as acetylacetonate, dibenzomethylate, and thenoyl trifluoroacetonate.

Examples of the atoms represented by M include: a rhenium atom, osmium atom, iridium atom, platinum atom, gold atom, lanthanum atom, cerium atom, praseodymium atom, neodymium atom, promethium atom, samarium atom, europium atom, gadolinium atom, terbium atom, dysprosium atom, etc.; preferably a rhenium atom, osmium atom, iridium atom, platinum atom, gold atom, samarium atom, europium atom, gadolinium atom, terbium atom, and a dysprosium atom; and more preferably, an iridium atom, platinum atom, gold atom, and europium atom in view of light emitting efficiency.

H, as the atom which bonds with M, represents a ligand containing one or more atoms selected from a nitrogen atom, oxygen atom, carbon atom, sulfur atom, and phosphorus atom.

As the atom which bonds with M, the ligand containing one or more atoms selected from a nitrogen atom, oxygen atom, carbon atom, sulfur atom, and phosphorus atom is the same as those exemplified about K.

As H, the followings are exemplified. Wherein, * represents an atom which bonds with M.

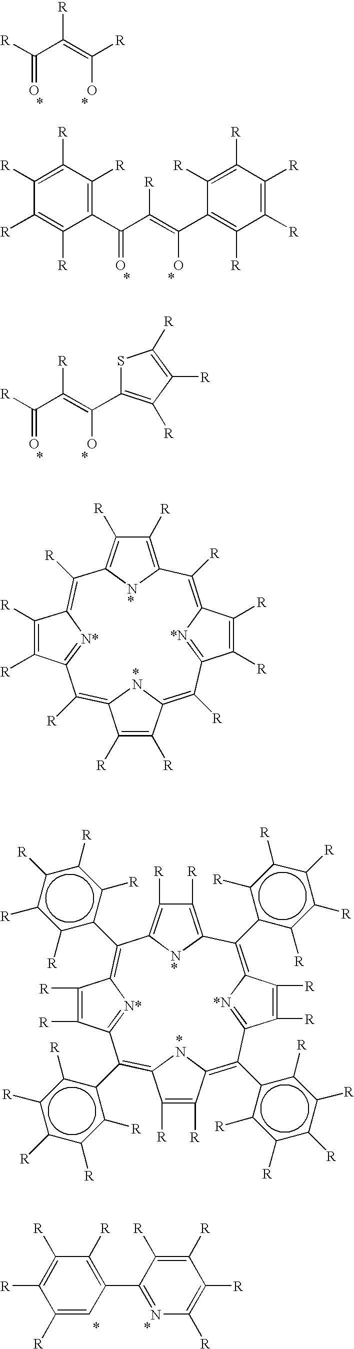

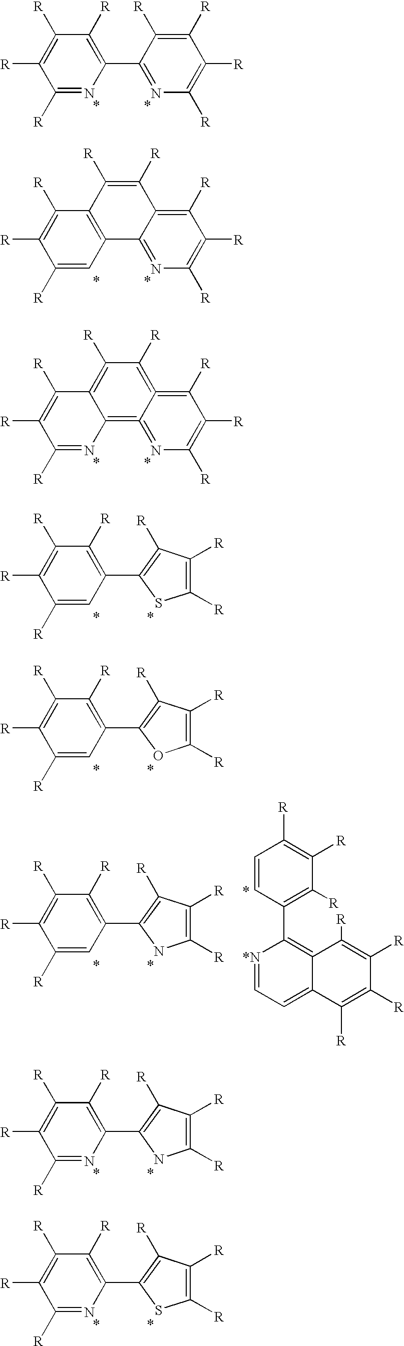

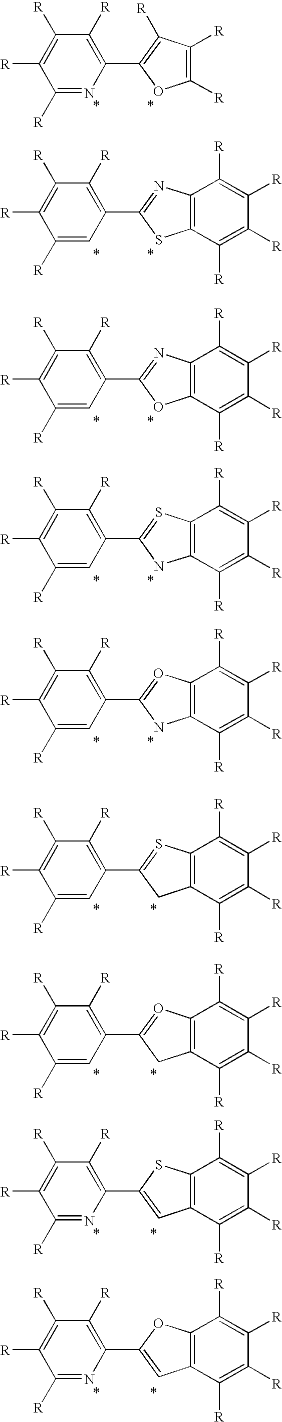

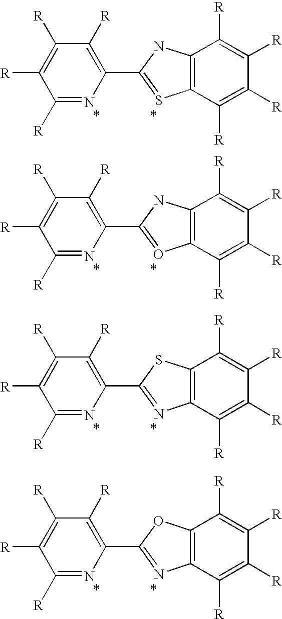

Wherein, R each independently represent a hydrogen atom, halogen atom, alkyl group, alkoxy group, alkylthio group, alkylamino group, alkylsilyl group, aryl group, aryloxy group, arylthio group, arylamino group, arylsilyl group, arylalkyl group, arylalkoxy group, arylalkylthio group, arylalkylamino group, arylalkylsilyl group, acyl group, acyloxy group, imine residue, amide group, arylalkenyl group, arylalkynyl group, cyano group, or monovalent heterocyclic group. R may be connected mutually to form a ring. In order to improve the solubility in a solvent, it is preferable that at least one of R contains a long chain alkyl group.

The concrete examples of alkyl group, alkoxy group, acyloxy group, alkylthio group, alkylamino group, aryl group, aryloxy group, arylthio group, arylamino group, arylalkyl group, arylalkoxy group, arylalkylthio group, and arylalkylamino group are the same as those of the above mentioned Y.

As the halogen atom, fluorine, chlorine, bromine, andiodine are exemplified.

The alkylsilyl group may be any of linear, branched or cyclic, and the number of carbon atoms is usually about 1 to 60. Concrete examples thereof include trimethylsilyl group, triethylsilyl group, tripropylsilyl group, tri-i-propylsilyl group, dimethyl-i-propylsilyl group, diethyl-i-propylsilyl group, t-butylsilyldimethylsilyl group, pentyldimethylsilyl group, hexyldimethylsilyl group, heptyldimethylsilyl group, octyldimethylsilyl group, 2-ethylhexyl-dimethylsilyl group, nonyldimethylsilyl group, decyldimethylsilyl group, 3,7-dimethyloctyl-dimethylsilyl group, lauryldimethylsilyl group etc.; and pentyl dimethylsilyl group, hexyl dimethyl silyl group, octyldimethylsilyl group, 2-ethylhexyl-dimethyl silyl group, decyldimethylsilyl group, and 3,7-dimethyloctyl dimethylsilyl group are preferable.

The aryl silyl group may have substituent on the aromatic ring, and the number of carbon atoms is usually about 3 to 60, and concrete examples thereof include triphenylsilyl group, tri-p-xylylsilyl group, tribenzylsilyl group, diphenylmethyl silyl group, t-butyldiphenylsilyl group, dimethylphenylsilyl group, etc.

The aryl alkylsilyl group usually has about 7 to 60 carbon atoms. Concrete examples thereof include phenyl-C₁-C₁₂ alkylsilyl group, C₁-C₁₂ alkoxyphenyl-C₁-C₁₂ alkylsilyl group, C₁-C₁₂ alkylphenyl-C₁-C₁₂ alkylsilyl group, 1-naphtyl-C₁-C₁₂ alkylsilyl group, 2-naphtyl-C₁-C₁₂ alkylsilyl group, phenyl-C₁-C₁₂ alkyldimethylsilyl group etc.; and C₁-C₁₂ alkoxy phenyl-C₁-C₁₂ alkylsilyl group and C₁-C₁₂ alkylphenyl-C₁-C₁₂ alkylsilyl group are preferable.

The acyl group usually has about 2 to 20 carbon atoms. Concrete examples thereof include acetyl group, propionyl group, butyryl group, isobutyryl group, pivaloyl group, benzoyl group, trifluoroacetyl group, pentafluorobenzoyl group, etc.

The acyloxy group usually has about 2 to 20 carbon atoms. Concrete examples thereof include acetoxy group, propionyloxy group, butyryloxy group, isobutyryloxy group, pivaloyloxy group, benzoyloxy group, trifluoroacetyloxy group, pentafluorobenzoyloxy group, etc.

The definition of the imine residue and the concrete examples are the same as those mentioned above.

The amide group has usually about 2 to 20 carbon atoms, and concrete examples thereof include formamide group, acetamide group, propioamide group, butyroamide group, benzamide group, trifluoroacetamide group, pentafluoro benzamide group, diformamide group, diacetoamide group, dipropioamide group, dibutyroamide group, dibenzamide group, ditrifluoroacetamide group, dipentafluorobenzamide group, succine imide group, phthalic imide group, etc.

The arylalkenyl group has usually about 7 to 60 carbon atoms, and concrete examples thereof include phenyl-C₁-C₁₂ alkenyl group, C₁-C₁₂ alkoxyphenyl-C₁-C₁₂ alkenyl group, C₁-C₁₂ alkyl phenyl-C₁-C₁₂ alkenyl group, 1-naphtyl-C₁-C₁₂ alkenyl group, 2-naphtyl-C₁-C₁₂ alkenyl group etc.; and C₁-C₁₂ alkoxy phenyl-C₁-C₁₂ alkenyl group and C₁-C₁₂ alkylphenyl-C₁-C₁₂ alkenyl group are preferable.

The arylalkynyl group has usually about 7 to 60 carbon atoms, and concrete examples thereof include phenyl-C₁-C₁₂ alkynyl group, C₁-C₁₂ alkoxyphenyl-C₁-C₁₂ alkynyl group, C₁-C₁₂ alkyl phenyl-C₁-C₁₂ alkynyl group, 1-naphtyl-C₁-C₁₂ alkynyl group, 2-naphtyl-C₁-C₁₂ alkynyl group etc.; and C₁-C₁₂ alkoxy phenyl-C₁-C₁₂ alkynyl group and C₁-C₁₂ alkylphenyl-C₁-C₁₂ alkynyl group are preferable.

The monovalent heterocyclic group means an atomic group in which a hydrogen atom is removed from a heterocyclic compound, and usually has about 4 to 60 carbon atoms. Concrete examples thereof include thienyl group, C₁-C₁₂ alkylthienyl group, pyridyl group, pyroryl group, furyl group, C₁-C₁₂ alkylpyridyl group, etc.; and thienyl group, C₁-C₁₂ alkylthienyl group, pyridyl group, and C₁-C₁₂ alkylpyridyl group are preferable.

It is preferable that H bonds with M by at least one nitrogen atom or carbon atom in respect of the stability of a compound, and it is more preferable that H bonds with M at multidentate sites.

H is more preferably represented by the below formula (H-1), (H-2), (H-3) or (H-4).

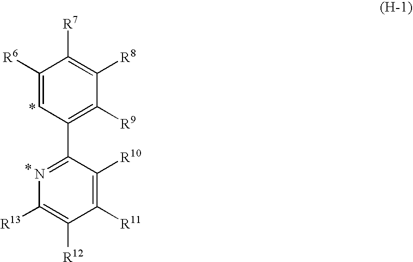

(wherein, R⁶-R¹³ each independently represent a hydrogen atom, halogen atom, alkyl group, alkoxy group, alkylthio group, alkylamino group, alkylsilyl group, aryl group, aryloxy group, arylthio group, arylamino group, arylsilyl group, arylalkyl group, arylalkoxy group, arylalkylthio group, arylalkylamino group, arylalkylsilyl group, acyl group, acyloxy group, imine residue, amide group, arylalkenyl group, arylalkynyl group, cyano group, and monovalent heterocyclic group, and * represents a bonding position with M.).

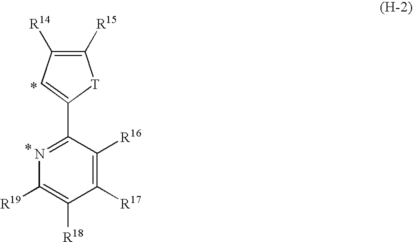

(Wherein, T represents an oxygen atom or a sulfur atom. R¹⁴-R¹⁹ each independently represent a hydrogen atom, halogen atom, alkyl group, alkoxy group, alkylthio group, alkylamino group, alkylsilyl group, aryl group, aryloxy group, arylthio group, arylamino group, arylsilyl group, arylalkyl group, arylalkoxy group, arylalkylthio group, arylalkylamino group, arylalkylsilyl group, acyl group, acyloxy group, imine residue, amide group, arylalkenyl group, arylalkynyl group, and cyano group, and * represents a bonding position with M.).

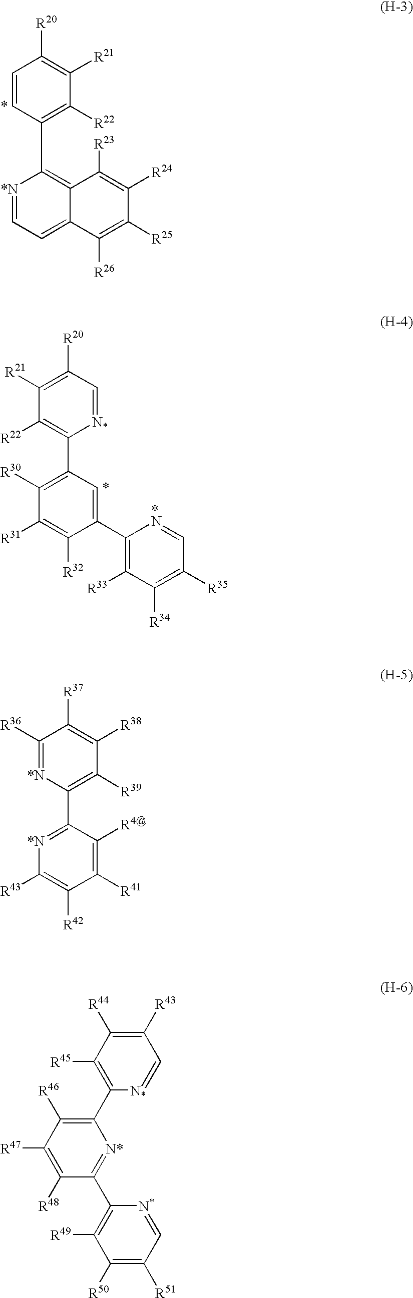

(wherein, R²⁰-R⁵¹ each independently represent a hydrogen atom, halogen atom, alkyl group, alkoxy group, alkylthio group, alkylamino group, alkylsilyl group, aryl group, aryloxy group, arylthio group, arylamino group, aryl silyl group, arylalkyl group, arylalkoxy group, arylalkylthio group, arylalkylamino group, aryl alkylsilyl group, acyl group, acyloxy group, imine residue, amide group, arylalkenyl group, arylalkynyl group, cyano group, and * represents a bonding position with M.)

The amount of the triplet light-emission compound (B) in the light emitting material in the present invention is usually 0.01-80 parts by weight preferably 0.1-60 parts by weight, based on 100 parts by weight of the polymer compound, although it is not limited, since it depends on the kind of polymer compound to be combined, and characteristics to be optimized.

The light emitting material of the present invention may be a conjugated polymer compound comprising aromatic ring in the main chain, and said polymer compound has a structure derived from a compound (B) showing light emission from triplet excited state in the molecule.

Next, the polymer light-emitting device (polymer LED) of the present invention will be explained. It is characterized by having a layer which contains the light emitting material of the present invention between the electrodes consisting of an anode and a cathode.

It is preferable that the layer containing the light emitting material of the present invention is a light emitting layer.

Moreover, the polymer LED of the present invention include: a polymer LED having an electron transporting layer between a cathode and a light emitting layer; a polymer LED having an hole transporting layer between an anode and a light emitting layer; and a polymer LED having an electron transporting layer between an cathode and a light emitting layer, and a hole transporting layer between an anode and a light emitting layer.

Furthermore, exemplified are: a polymer-LED in which a layer containing a conductive polymer is disposed between at least one of the above electrodes and a light emitting layer adjacently to the electrode; and a polymer LED in which a buffer layer having a mean film thickness of 2 nm or less is disposed between at least one of the above electrodes and a light emitting layer adjacently to the electrode.

Specifically, the following structures a)-d) are exemplified.

a) anode/light emitting layer/cathode
b) anode/hole transporting layer/light emitting layer/cathode
c) anode/light emitting layer/electron transporting layer/cathode
d) anode/hole transporting layer/light emitting layer/electron transporting layer/cathode
(wherein, “/” indicates adjacent lamination of layers. Hereinafter, the same).

Herein, the light emitting layer is a layer having function to emit a light, the hole transporting layer is a layer having function to transport a hole, and the electron transporting layer is a layer having function to transport an electron. Herein, the electron transporting layer and the hole transporting layer are generically called a charge transporting layer.

The light emitting layer, hole transporting layer and electron transporting layer also may be used each independently in two or more layers.

Charge transporting layers disposed adjacent to an electrode, that having function to improve charge injecting efficiency from the electrode and having effect to decrease driving voltage of an device are particularly called sometimes a charge injecting layer (hole injecting layer, electron injecting layer) in general.

For enhancing adherence with an electrode and improving charge injection from an electrode, the above-described charge injecting layer or insulation layer having a thickness of 2 nm or less may also be provided adjacent to an electrode, and further, for enhancing adherence of the interface, preventing mixing and the like, a thin buffer layer may also be inserted into the interface of a charge transporting layer and light emitting layer.

The order and number of layers laminated and the thickness of each layer can be appropriately applied while considering light emitting efficiency and life of the device.

In the present invention, as the polymer LED having a charge injecting layer (electron injecting layer, hole injecting layer) provided, there are listed a polymer LED having a charge injecting layer provided adjacent to a cathode and a polymer LED having a charge injecting layer provided adjacent to an anode.

For example, the following structures e) to p) are specifically exemplified.

e) anode/charge injecting layer/light emitting layer/cathode
f) anode/light emitting layer/charge injecting layer/cathode
g) anode/charge injecting layer/light emitting layer/charge injecting layer/cathode
h) anode/charge injecting layer/hole transporting layer/light emitting layer/cathode
i) anode/hole transporting layer/light emitting layer/charge injecting layer/cathode
j) anode/charge injecting layer/hole transporting layer/light emitting layer/charge injecting layer/cathode
k) anode/charge injecting layer/light emitting layer/electron transporting layer/cathode
l) anode/light emitting layer/electron transporting layer/charge injecting layer/cathode
m) anode/charge injecting layer/light emitting layer/electron transporting layer/charge injecting layer/cathode
n) anode/charge injecting layer/hole transporting layer/light emitting layer/electron transporting layer/cathode
o) anode/hole transporting layer/light emitting layer/electron transporting layer/charge injecting layer/cathode
p) anode/charge injecting layer/hole transporting layer/light emitting layer/electron transporting layer/charge injecting layer/cathode

As the specific examples of the charge injecting layer, there are exemplified layers containing an conducting polymer, layers which are disposed between an anode and a hole transporting layer and contain a material having an ionization potential between the ionization potential of an anode material and the ionization potential of a hole transporting material contained in the hole transporting layer, layers which are disposed between a cathode and an electron transporting layer and contain a material having an electron affinity between the electron affinity of a cathode material and the electron affinity of an electron transporting material contained in the electron transporting layer, and the like.

When the above-described charge injecting layer is a layer containing an conducting polymer, the electric conductivity of the conducting polymer is preferably 10⁻⁵ S/cm or more and 103 S/cm or less, and for decreasing the leak current between light emitting pixels, more preferably 10⁻⁵ S/cm or more and 10² S/cm or less, further preferably 10⁻⁵ S/cm or more and 10¹ S/cm or less.

Usually, to provide an electric conductivity of the conducting polymer of 10⁻⁵ S/cm or more and 10³ S/cm or less, a suitable amount of ions are doped into the conducting polymer.

Regarding the kind of an ion doped, an anion is used in a hole injecting layer and a cation is used in an electron injecting layer. As examples of the anion, a polystyrene sulfonate ion, alkylbenzene sulfonate ion, camphor sulfonate ion and the like are exemplified, and as examples of the cation, a lithium ion, sodium ion, potassium ion, tetrabutyl ammonium ion and the like are exemplified.

The thickness of the charge injecting layer is for example, from 1 nm to 100 nm, preferably from 2 nm to 50 nm.

Materials used in the charge injecting layer may properly be selected in view of relation with the materials of electrode and adjacent layers, and there are exemplified conducting polymers such as polyaniline and derivatives thereof, polythiophene and derivatives thereof, polypyrrole and derivatives thereof, poly(phenylene vinylene) and derivatives thereof, poly(thienylene vinylene) and derivatives thereof, polyquinoline and derivatives thereof, polyquinoxaline and derivatives thereof, polymers containing aromatic amine structures in the main chain or the side chain, and the like, and metal phthalocyanine (copper phthalocyanine and the like), carbon and the like.

The insulation layer having a thickness of 2 nm or less has function to make charge injection easy. As the material of the above-described insulation layer, metal fluoride, metal oxide, organic insulation materials and the like are listed. As the polymer LED having an insulation layer having a thickness of 2 nm or less, there are listed polymer LEDs having an insulation layer having a thickness of 2 nm or less provided adjacent to a cathode, and polymer LEDs having an insulation layer having a thickness of 2 nm or less provided adjacent to an anode.

Specifically, there are listed the following structures q) to ab) for example.

q) anode/insulation layer having a thickness of 2 nm or less/light emitting layer/cathode
r) anode/light emitting layer/insulation layer having a thickness of 2 nm or less/cathode
s) anode/insulation layer having a thickness of 2 nm or less/light emitting layer/insulation layer having a thickness of 2 nm or less/cathode
t) anode/insulation layer having a thickness of 2 nm or less/hole transporting layer/light emitting layer/cathode
u) anode/hole transporting layer/light emitting layer/insulation layer having a thickness of 2 nm or less/cathode
v) anode/insulation layer having a thickness of 2 nm or less/hole transporting layer/light emitting layer/insulation layer having a thickness of 2 nm or less/cathode
w) anode/insulation layer having a thickness of 2 nm or less/light emitting layer/electron transporting layer/cathode
x) anode/light emitting layer/electron transporting layer/insulation layer having a thickness of 2 nm or less/cathode
y) anode/insulation layer having a thickness of 2 nm or less/light emitting layer/electron transporting layer/insulation layer having a thickness of 2 nm or less/cathode
z) anode/insulation layer having a thickness of 2 nm or less/hole transporting layer/light emitting layer/electron transporting layer/cathode
aa) anode/hole transporting layer/light emitting layer/electron transporting layer/insulation layer having a thickness of 2 nm or less/cathode
ab) anode/insulation layer having a thickness of 2 nm or less/hole transporting layer/light emitting layer/electron transporting layer/insulation layer having a thickness of 2 nm or less/cathode

A hole preventing layer is a layer having a function of transporting electrons and confining the holes transported from anode, and the layer is prepared at the interface on the side cathode of the light emitting layer, and consists of a material having larger ionization potential than that of the light emitting layer, for example, a metal complex of bathocuproine, 8-hydroxy quinoline, or derivatives thereof.

The film thickness of the hole preventing layer, for example, is 1 nm to 100 nm, and preferably 2 nm to 50 nm.

Specifically, there are listed the following structures ac) to an) for example.

ac) anode/charge injection layer/light emitting layer/hole preventing layer/cathode
ad) anode/light emitting layer/hole preventing layer/charge injection layer/cathode
ae) anode/charge injection layer/light emitting layer/hole preventing layer/charge injection layer/cathode
af) anode/charge injection layer/hole transporting layer/light emitting layer/hole preventing layer/cathode
ag) anode/hole transporting layer/light emitting layer/hole preventing layer/charge injection layer/cathode
ah) anode/charge injection layer/hole transporting layer/light emitting layer/hole preventing layer/charge injection layer/cathode
ai) anode/charge injection layer/light emitting layer/hole preventing layer/charge transporting layer/cathode
aj) anode/light emitting layer/hole preventing layer/electron transporting layer/charge injection layer/cathode
ak) anode/charge injection layer/light emitting layer/hole preventing layer/electron transporting layer/charge injection layer/cathode
al) anode/charge injection layer/hole transporting layer/light emitting layer/hole preventing layer/charge transporting layer/cathode
am) anode/hole transporting layer/light emitting layer/hole preventing layer/electron transporting layer/charge injection layer/cathode
an) anode/charge injection layer/hole transporting layer/light emitting layer/hole preventing layer/electron transporting layer/charge injection layer/cathode

In producing a polymer LED, when a film is formed from a solution by using such complex composition or polymer complex compound of the present invention, only required is removal of the solvent by drying after coating of this solution, and even in the case of mixing of a charge transporting material and a light emitting material, the same method can be applied, causing an extreme advantage in production. As the film forming method from a solution, there can be used coating methods such as a spin coating method, casting method, micro gravure coating method, gravure coating method, bar coating method, roll coating method, wire bar coating method, dip coating method, spray coating method, screen printing method, flexo printing method, offset printing method, inkjet printing method and the like.

Regarding the thickness of the light emitting layer, the optimum value differs depending on material used, and may properly be selected so that the driving voltage and the light emitting efficiency become optimum values, and for example, it is from 1 nm to 1 μm, preferably from 2 nm to 500 nm, further preferably from 5 nm to 200 nm.

In the polymer LED of the present invention, light emitting materials other than the light emitting material of the present invention or light emitting material polymer complex compound can also be mixed in a light emitting layer. Further, in the polymer LED of the present invention, the light emitting layer containing light emitting materials other than the above light emitting material may also be laminated with a light emitting layer containing the above light emitting material of the present invention.

As the light emitting material, known materials can be used. In a compound having lower molecular weight, there can be used, for example, naphthalene derivatives, anthracene or derivatives thereof, perylene or derivatives thereof; dyes such as polymethine dyes, xanthene dyes, coumarine dyes, cyanine dyes; metal complexes of 8-hydroxyquinoline or derivatives thereof, aromatic amine, tetraphenylcyclopentane or derivatives thereof, or tetraphenylbutadiene or derivatives thereof, and the like.

Specifically, there can be used known compounds such as those described in JP-A Nos. 57-51781, 59-194393 and the like, for example.

When the polymer LED of the present invention has a hole transporting layer, as the hole transporting materials used, there are exemplified polyvinylcarbazole or derivatives thereof, polysilane or derivatives thereof, polysiloxane derivatives having an aromatic amine in the side chain or the main chain, pyrazoline derivatives, arylamine derivatives, stilbene derivatives, triphenyldiamine derivatives, polyaniline or derivatives thereof, polythiophene or derivatives thereof, polypyrrole or derivatives thereof, poly(p-phenylenevinylene) or derivatives thereof, poly(2,5-thienylenevinylene) or derivatives thereof, or the like.

Specific examples of the hole transporting material include those described in JP-A Nos. 63-70257, 63-175860, 2-135359, 2-135361, 2-209988, 3-37992 and 3-152184.

Among them, as the hole transporting materials used in the hole transporting layer, preferable are polymer hole transporting materials such as polyvinylcarbazole or derivatives thereof, polysilane or derivatives thereof, polysiloxane derivatives having an aromatic amine compound group in the side chain or the main chain, polyaniline or derivatives thereof, polythiophene or derivatives thereof, poly(p-phenylenevinylene) or derivatives thereof, poly(2,5-thienylenevinylene) or derivatives thereof, or the like, and further preferable are polyvinylcarbazole or derivatives thereof, polysilane or derivatives thereof and polysiloxane derivatives having an aromatic amine compound group in the side chain or the main chain. In the case of a hole transporting material having lower molecular weight, it is preferably dispersed in a polymer binder for use.

Polyvinylcarbazole or derivatives thereof are obtained, for example, by cation polymerization or radical polymerization from a vinyl monomer.

As the polysilane or derivatives thereof, there are exemplified compounds described in Chem. Rev., 89, 1359 (1989) and GB 2300196 published specification, and the like. For synthesis, methods described in them can be used, and a Kipping method can be suitably used particularly.

As the polysiloxane or derivatives thereof, those having the structure of the above-described hole transporting material having lower molecular weight in the side chain or main chain, since the siloxane skeleton structure has poor hole transporting property. Particularly, there are exemplified those having an aromatic amine having hole transporting property in the side chain or main chain.

The method for forming a hole transporting layer is not restricted, and in the case of a hole transporting layer having lower molecular weight, a method in which the layer is formed from a mixed solution with a polymer binder is exemplified. In the case of a polymer hole transporting material, a method in which the layer is formed from a solution is exemplified.

The solvent used for the film forming from a solution is not particularly restricted providing it can dissolve a hole transporting material. As the solvent, there are exemplified chlorine solvents such as chloroform, methylene chloride, dichloroethane and the like, ether solvents such as tetrahydrofuran and the like, aromatic hydrocarbon solvents such as toluene, xylene and the like, ketone solvents such as acetone, methyl ethyl ketone and the like, and ester solvents such as ethyl acetate, butyl acetate, ethylcellosolve acetate and the like.

As the film forming method from a solution, there can be used coating methods such as a spin coating method, casting method, micro gravure coating method, gravure coating method, bar coating method, roll coating method, wire bar coating method, dip coating method, spray coating method, screen printing method, flexo printing method, offset printing method, inkjet printing method and the like, from a solution.

The polymer binder mixed is preferably that does not disturb charge transport extremely, and that does not have strong absorption of a visible light is suitably used. As such polymer binder, polycarbonate, polyacrylate, poly(methyl acrylate), poly(methyl methacrylate), polystyrene, poly(vinyl chloride), polysiloxane and the like are exemplified.

Regarding the thickness of the hole transporting layer, the optimum value differs depending on material used, and may properly be selected so that the driving voltage and the light emitting efficiency become optimum values, and at least a thickness at which no pin hole is produced is necessary, and too large thickness is not preferable since the driving voltage of the device increases. Therefore, the thickness of the hole transporting layer is, for example, from 1 nm to 1 μm, preferably from 2 nm to 500 nm, further preferably from 5 nm to 200 nm.

When the polymer LED of the present invention has an electron transporting layer, known compounds are used as the electron transporting materials, and there are exemplified oxadiazole derivatives, anthraquinodimethane or derivatives thereof, benzoquinone or derivatives thereof, naphthoquinone or derivatives thereof, anthraquinone or derivatives thereof, tetracyanoanthraquinodimethane or derivatives thereof, fluorenone derivatives, diphenyldicyanoethylene or derivatives thereof, diphenoquinoline derivatives, or metal complexes of 8-hydroxyquinoline or derivatives thereof, polyquinoline and derivatives thereof, polyquinoxaline and derivatives thereof, polyfluorene or derivatives thereof, and the like.

Specifically, there are exemplified those described in JP-A Nos. 63-70257, 63-175860, 2-135359, 2-135361, 2-209988, 3-37992 and 3-152184.

Among them, oxadiazole derivatives, benzoquinone or derivatives thereof, anthraquinone or derivatives thereof, or metal complexes of 8-hydroxyquinoline or derivatives thereof, polyquinoline and derivatives thereof, polyquinoxaline and derivatives thereof, polyfluorene or derivatives thereof are preferable, and 2-(4-biphenyl)-5-(4-t-butylphenyl)-1,3,4-oxadiazole, benzoquinone, anthraquinone, tris(8-quinolinol)aluminum and polyquinoline are further preferable.

The method for forming the electron transporting layer is not particularly restricted, and in the case of an electron transporting material having lower molecular weight, a vapor deposition method from a powder, or a method of film-forming from a solution or melted state is exemplified, and in the case of a polymer electron transporting material, a method of film-forming from a solution or melted state is exemplified, respectively.

The solvent used in the film-forming from a solution is not particularly restricted provided it can dissolve electron transporting materials and/or polymer binders. As the solvent, there are exemplified chlorine solvents such as chloroform, methylene chloride, dichloroethane and the like, ether solvents such as tetrahydrofuran and the like, aromatic hydrocarbon solvents such as toluene, xylene and the like, ketone solvents such as acetone, methyl ethyl ketone and the like, and ester solvents such as ethyl acetate, butyl acetate, ethylcellosolve acetate and the like.

As the film-forming method from a solution or melted state, there can be used coating methods such as a spin coating method, casting method, micro gravure coating method, gravure coating method, bar coating method, roll coating method, wire bar coating method, dip coating method, spray coating method, screen printing method, flexo printing method, offset printing method, inkjet printing method and the like.

The polymer binder to be mixed is preferably that which does not extremely disturb a charge transport property, and that does not have strong absorption of a visible light is suitably used. As such polymer binder, poly(N-vinylcarbazole), polyaniline or derivatives thereof, polythiophene or derivatives thereof, poly(p-phenylene vinylene) or derivatives thereof, poly(2,5-thienylene vinylene) or derivatives thereof, polycarbonate, polyacrylate, poly(methyl acrylate), poly(methyl methacrylate), polystyrene, poly(vinyl chloride), polysiloxane and the like are exemplified.

Regarding the thickness of the electron transporting layer, the optimum value differs depending on material used, and may properly be selected so that the driving voltage and the light emitting efficiency become optimum values, and at least a thickness at which no pin hole is produced is necessary, and too large thickness is not preferable since the driving voltage of the device increases. Therefore, the thickness of the electron transporting layer is, for example, from 1 nm to 11 m, preferably from 2 nm to 500 nm, further preferably from 5 nm to 200 nm.

The substrate forming the polymer LED of the present invention may preferably be that does not change in forming an electrode and layers of organic materials, and there are exemplified glass, plastics, polymer film, silicon substrates and the like. In the case of a opaque substrate, it is preferable that the opposite electrode is transparent or semitransparent.

Usually, at least one of the electrodes consisting of an anode and a cathode, is transparent or semitransparent. It is preferable that the anode is transparent or semitransparent.

As the material of this anode, electron conductive metal oxide films, semitransparent metal thin films and the like are used. Specifically, there are used indium oxide, zinc oxide, tin oxide, and composition thereof, i.e. indium/tin/oxide (ITO), and films (NESA and the like) fabricated by using an electron conductive glass composed of indium/zinc/oxide, and the like, and gold, platinum, silver, copper and the like. Among them, ITO, indium/zinc/oxide, tin oxide are preferable. As the fabricating method, a vacuum vapor deposition method, sputtering method, ion plating method, plating method and the like are used. As the anode, there may also be used organic transparent conducting films such as polyaniline or derivatives thereof, polythiophene or derivatives thereof and the like.

The thickness of the anode can be appropriately selected while considering transmission of a light and electric conductivity, and for example, from 10 nm to 10 μm, preferably from 20 nm to 1 μm, further preferably from 50 nm to 500 nm.

Further, for easy charge injection, there may be provided on the anode a layer comprising a phthalocyanine derivative conducting polymers, carbon and the like, or a layer having an average film thickness of 2 nm or less comprising a metal oxide, metal fluoride, organic insulating material and the like.

As the material of a cathode used in the polymer LED of the present invention, that having lower work function is preferable. For example, there are used metals such as lithium, sodium, potassium, rubidium, cesium, beryllium, magnesium, calcium, strontium, barium, aluminum, scandium, vanadium, zinc, yttrium, indium, cerium, samarium, europium, terbium, ytterbium and the like, or alloys comprising two of more of them, or alloys comprising one or more of them with one or more of gold, silver, platinum, copper, manganese, titanium, cobalt, nickel, tungsten and tin, graphite or graphite intercalation compounds and the like. Examples of alloys include a magnesium-silver alloy, magnesium-indium alloy, magnesium-aluminum alloy, indium-silver alloy, lithium-aluminum alloy, lithium-magnesium alloy, lithium-indium alloy, calcium-aluminum alloy and the like. The cathode may be formed into a laminated structure of two or more layers.

The thickness of the cathode can be appropriately selected while considering transmission of a light and electric conductivity, and for example, from 10 nm to 10 μm, preferably from 20 nm to 1 μm, further preferably from 50 nm to 500 nm.

As the method for fabricating a cathode, there are used a vacuum vapor deposition method, sputtering method, lamination method in which a metal thin film is adhered under heat and pressure, and the like. Further, there may also be provided, between a cathode and an organic layer, a layer comprising an conducting polymer, or a layer having an average film thickness of 2 nm or less comprising a metal oxide, metal fluoride, organic insulation material and the like, and after fabrication of the cathode, a protective layer may also be provided which protects the polymer LED. For stable use of the polymer LED for a long period of time, it is preferable to provide a protective layer and/or protective cover for protection of the device in order to prevent it from outside damage.

As the protective layer, there can be used a polymeric compound, metal oxide, metal fluoride, metal borate and the like. As the protective cover, there can be used a glass plate, a plastic plate the surface of which has been subjected to lower-water-permeation treatment, and the like, and there is suitably used a method in which the cover is pasted with an device substrate by a thermosetting resin or light-curing resin for sealing. If space is maintained using a spacer, it is easy to prevent an device from being injured. If an inner gas such as nitrogen and argon is sealed in this space, it is possible to prevent oxidation of a cathode, and further, by placing a desiccant such as barium oxide and the like in the above-described space, it is easy to suppress the damage of an device by moisture adhered in the production process. Among them, any one means or more are preferably adopted.

The polymer LED of the present invention can be used for a flat light source, a segment display, a dot matrix display, and a liquid crystal display as a back light, etc.

For obtaining light emission in plane form using the polymer LED of the present invention, an anode and a cathode in the plane form may properly be placed so that they are laminated each other. Further, for obtaining light emission in pattern form, there is a method in which a mask with a window in pattern form is placed on the above-described plane light emitting device, a method in which an organic layer in non-light emission part is formed to obtain extremely large thickness providing substantial non-light emission, and a method in which any one of an anode or a cathode, or both of them are formed in the pattern. By forming a pattern by any of these methods and by placing some electrodes so that independent on/off is possible, there is obtained a display device of segment type which can display digits, letters, simple marks and the like. Further, for forming a dot matrix device, it may be advantageous that anodes and cathodes are made in the form of stripes and placed so that they cross at right angles. By a method in which a plurality of kinds of polymeric compounds emitting different colors of lights are placed separately or a method in which a color filter or luminescence converting filter is used, area color displays and multi color displays are obtained. A dot matrix display can be driven by passive driving, or by active driving combined with TFT and the like. These display devices can be used as a display of a computer, television, portable terminal, portable telephone, car navigation, view finder of a video camera, and the like.

Further, the above-described light emitting device in plane form is a thin self-light-emitting one, and can be suitably used as a flat light source for back-light of a liquid crystal display, or as a flat light source for illumination. Further, if a flexible plate is used, it can also be used as a curved light source or a display.

Hereafter, in order to explain the present invention in detail with showing examples, but the present invention is not limited to these.

The polystyrene reduced number average molecular weight was obtained by gel permeation chromatography (GPC: HLC-8220GPC produced by TOSOH, or SCL-10A produced by Shimadzu) using tetrahydrofuran or chloroform as a solvent.

### Column: two TOSOH TSKgel SuperHM-H+TSKgel SuperH2000 (4.6 mm I.d.×15 cm)

Detector: RI (SHIMADZU RID-10A) was used.

### SYNTHESIS EXAMPLES 1 TO 5

### Synthesis of Polymer Compound 1-1

### Synthesis Example 1

### Synthesis of Compound A

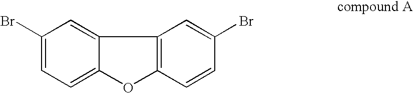

Into a 1-L three-necked flask under an inert atmosphere was charged benzofuran (23.2 g, 137.9 mmol) and acetic acid (232 g), and the mixture was stirred and dissolved at room temperature, then, heated up to 75° C. After temperature rising, a solution prepared by diluting bromine (92.6 g, 579.3 mmol) with acetic acid (54 g) was dropped. After completion of dropping, the mixture was stirred for 3 hours while keeping the temperature, and allowed to cool. Disappearance of a raw material was confirmed by TLC, then, a sodium thiosulfate solution was added to terminate the reaction, and the mixture was stirred for 1 hour at room temperature. After stirring, filtration was performed to separate a cake which was further washed by a sodium thiosulfate solution and water, then, dried. The resultant coarse product was re-crystallized from hexane, to obtain an intended substance (yielded amount: 21.8 g, yield: 49%).

¹H-NMR (300 MHz/CDCl₃):

d7.44 (d, 2H), 7.57 (d, 2H), 8.03 (s, 2H)

### SYNTHESIS EXAMPLE 2

### Synthesis of Compound B

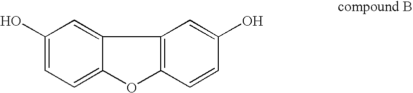

Under an inert atmosphere, a compound A (16.6 g, 50.9 mmol) and tetrahydrofuran (293 g) were charged into a 500 ml four-necked flask and cooled down to −78° C. n-butyllithium (80 ml <1.6 mol hexane solution>, 127.3 mmol) was dropped, then, the mixture was stirred for 1 hour while keeping the temperature. This reaction solution was dropped into a solution prepared by charging trimethoxyboronic acid (31.7 g, 305.5 mmol) and tetrahydrofuran (250 ml) in a 1000 ml four-necked flask and cooling down to −78° C. After completion of dropping, the temperature was returned to room temperature, and the mixture was stirred for 2 hours at room temperature, then, disappearance of a raw material was confirmed by TLC. The reaction completed mass was poured into concentrated sulfuric acid (30 g) and water (600 ml) charged in a 2000 ml beaker, and the reaction was completed. Toluene (300 ml) was added, an organic layer was extracted, further, water was added to effect washing. A solvent was distilled off, then, 8 g of the solvent and ethyl acetate (160 ml) were placed in a 300 ml four-necked flask, subsequently, 30% hydrogen peroxide water (7.09 g) was added, and the mixture was stirred at 40° C. for 2 hours. This reaction solution was poured into an aqueous solution of ammonium sulfate iron (II)(71 g) and water (500 ml) in a 1000 ml beaker. The mixture was stirred, then, an organic layer was extracted and washed with water. A solvent was removed to obtain 6.72 g a coarse compound B.

MS spectrum: M⁺ 200.0

### SYNTHESIS EXAMPLE 3

### Synthesis of Compound C

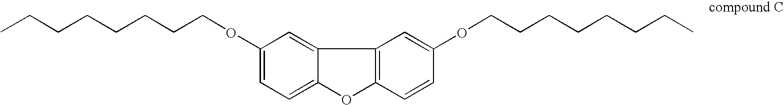

Under an inert atmosphere, a compound B (2.28 g, 11.4 mmol) synthesized by the same method as in Synthesis Example 2 and N,N-dimethylformamide (23 g) were charged into a 200 ml four-necked flask and the mixture was stirred at room temperature for dissolution thereof, then, potassium carbonate (9.45 g, 68.3 mmol) was charged and the mixture was heated up to 60° C. After temperature rising, a solution prepared by diluting n-octyl bromide (6.60 g, 34.2 mmol) with N,N-dimethylformamide (11 g) was dropped. After completion of dropping, the mixture was heated up to 60° C., and the mixture was stirred for 2 hours while keeping the temperature, and disappearance of a raw material was confirmed by TLC. Water (20 ml) was added to complete the reaction, subsequently, toluene (20 ml) was added, and organic layer was extracted and washed twice with water. After drying over anhydrous sodium sulfate, a solvent was distilled off. The resultant coarse product was purified by a silica gel column, to obtain an intended substance (yielded amount: 1.84 g, yield: 38%)

MS spectrum: M⁺ 425.3

### SYNTHESIS EXAMPLE 4

### Synthesis of Compound D

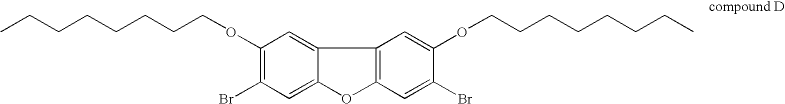

Under an inert atmosphere, a compound C (7.50 g, 17.7 mmol) synthesized by the same method as in Synthesis Example 3 and N,N-dimethylformamide were charged into a 500 ml four-necked flask and the mixture was stirred at room temperature for dissolution thereof, then, cooled in an ice bath. After cooling, a solution prepared by diluting N-bromosuccinimide (6.38 g, 35.9 mmol) with N,N-dimethylformamide (225 ml) was dropped. After completion of dropping, the mixture was cooled in an ice water for 1 hour, kept at room temperature for 18.5 hours, and heated up to 40° C. and stirred for 6.5 hours while keeping the temperature, and disappearance of a raw material was confirmed by liquid chromatography. A solvent was removed, toluene (75 ml) was added for dissolution, then, an organic layer was washed three times with water. After drying over anhydrous sodium sulfate, a solvent was distilled off. About half of the resultant coarse product was purified by silica gel column and preparative liquid chromatography, to obtain an intended substance (yielded amount: 0.326 g).

¹H-NMR (300 MHz/CDCl₃,):

d0.90 (t, 6H), 1.26-1.95 (m, 24H), 4.11 (t, 4H), 7.34 (s, 2H), 7.74 (s, 2H)

MS spectrum: M⁺ 582.1

### SYNTHESIS EXAMPLE 5

### Synthesis of Polymer Compound 1-1

6.26 g of the compound D and 4.7 g of 2,2′-bipydiryl were charged into a reaction vessel, then, an atmosphere in the reaction system was purged with a nitrogen gas. To this was added 350 g of tetrahydrofuran (THF) deaerated previously by bubbling with an argon gas (dehydrated solvent). Next, to this mixed solution was added 8.3 g of bis(1,5-cyclooctadiene)nickel(0) {Ni(COD)₂}, the mixture was stirred at room temperature for 10 minutes, then, reacted at 60° C. for 3 hours. The reaction was conducted in a nitrogen gas atmosphere.

After the reaction, this solution was cooled, then, a mixed solution of 25% ammonia solution 40 ml/methanol 200 ml/ion exchanged water 200 ml was poured into this, and the mixture was stirred for about 1 hour. Next, the generated precipitate was recovered by filtration. This precipitate was dried under reduced pressure, then, dissolved in 600 g of toluene. This solution was filtrated to remove insoluble materials, then, this solution was purified by passing through a column filled with alumina. Next, this solution was washed with 1 N hydrochloric acid. After liquid separation, a toluene phase was washed with an ammonia solution of about 3%. After liquid separation, the toluene phase was washed with ion exchanged water. After liquid separation, the toluene solution was recovered. Next, methanol was poured into this toluene solution while stirring, to cause re-precipitation and purification. The produced precipitate was recovered, then, this precipitate was washed with methanol. This precipitate was dried under reduced pressure, to obtain 2.6 g of a polymer. This polymer had a polystyrene-reduced number-average molecular weight Mn of 1.1×10⁵ and a polystyrene-reduced weight-average molecular weight Mw of 2.7×10⁵.

Polymer compound 1-1: homopolymer substantially composed of the following repeating unit

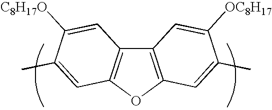

### EXAMPLE 6

### Synthesis of Iridium Complex A

A 300 ml four-necked flask was purged with argon, then, into the flask was charged 760 mg (1.0 mmol) of the following compound (a-2), 400 mg (4.0 mmol) of acetylacetone and 505 mg (4.0 mmol) of triethylamine, and 50 ml of dehydrated methanol was added to this. The mixture was refluxed at a bath temperature of 80° C. for 9 hours, then, allowed to cool, and concentrated and dried, then, purified by silica gel column chromatography using toluene as a solvent, and a solvent was distilled off to obtain 603 g of iridium complex A.

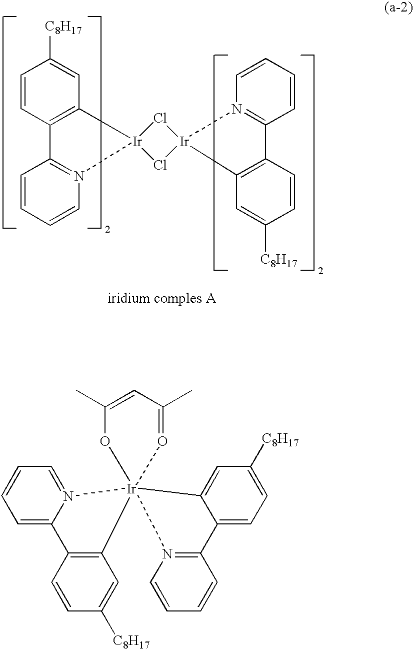

¹H-NMR (CDCl₃, 300 MHz) d8.47 (2H, d), 7.78 (2H, d), 7.68 (2H, dd), 7.42 (2H, d), 7.08 (2H, dd), 6.61 (2H, d), 6.02 (2H, s), 5.19 (1H, s), 2.26 (4H, t), 1.78 (6H, s), 1.1.12-1.36 (24H, m), 0.87 (6H, t).

MS (ESI-positive, KCl addition m/z: 824.39 ([M+K]⁺)

### EXAMPLE 1

A 1.5 wt % toluene solution of a mixture prepared by adding the above-mentioned iridium complex A in an amount of 5 wt % to the above-mentioned polymer compound 1-1 was prepared.

On a glass substrate carrying thereon an ITO film having a thickness of 150 nm formed by a sputtering method, a film having a thickness of 50 nm was formed by spin coating using a solution of poly(ethylenedioxythiophene)/polystyrenesulfonic acid (Baytron P manufactured by Bayer), and the film was dried at 200° C. on a hot plate for 10 minutes. Next, a film was formed by spin coating at a rotational speed of 1000 rpm using the chloroform solution prepared above. The film thickness was about 100 nm. Further, this was dried under reduced pressure at 80° C. for 1 hour, then, LiF was vapor-deposited at a thickness of about 4 nm as a cathode buffer layer, and calcium was vapor-deposited at a thickness of about 5 nm and then aluminum was vapor-deposited at a thickness of about 80 nm each as a cathode, to produce an EL device. After the degree of vacuum reached 1×10⁻⁴ Pa or less, vapor deposition of a metal was initiated. By applying voltage on the resultant device, EL light emission showing a peak at 520 nm was obtained. The device showed light emission of 100 cd/m² at about 13 V. The maximum light emission efficiency was 3.5 cd/A.

The lowest excited triplet energy of the polymer compound 1-1 and the iridium complex A calculated by a computational chemical means were 2.82 eV and 2.70 eV, respectively. A difference between the vacuum level and the energy level of LUMO in the ground state of the polymer compound 1-1 was 1.76 eV.

The chemical structure as the calculation subject was:

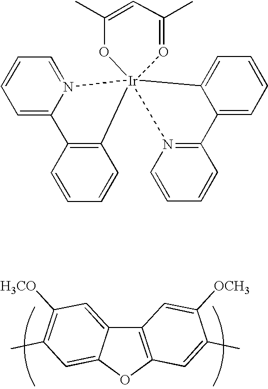

and the calculation was performed by the method described in

### DETAILED DESCRIPTION OF THE INVENTION

Specifically, regarding the iridium complex A and the polymer compound 1-1, the structure was optimized by a Hatree-Fock (HF) method. In this procedure, lanl2dz was used for iridium contained in the iridium complex A and 6-31g* was used for other atoms in the iridium complex A and the polymer compound 1-1, as a base function. Further, for the optimized structure, the lowest excited single energy, lowest excited triplet energy, HOMO value and LUMO value were calculated by a time-dependent density functional (TDDFT) method at b3p86 level using the same base as for the structure optimization. Validity for simplification as described above of the chemical structure on which calculation had been performed was formed previously as described below.

The HOMO value in the ground state, LUMO value in the ground state, lowest excited single energy and lowest excited triplet energy obtained by calculation by the HF method using the base function 6-31g* described above, hypothesizing OCH₃, OC₃H₇, OC₅H₁₁ and OC₈H₁₇ as a side chain instead of a side chain OC₈H₁₇ in the polymer compound 1-1 are as described below.

TABLE 1

| | OC1H3 | OC3H7 | OC5H11 | OC8H17 |
|---|---|---|---|---|
| HOMO(eV) | −6.15 | −6.10 | −6.10 | −6.07 |
| LUMO(eV) | −1.44 | −1.39 | −1.38 | −1.37 |
| Lowest | 4.17 | 4.16 | 4.16 | 4.16 |
| excited | | | | |
| single | | | | |
| energy (eV) | | | | |
| Lowest | 3.20 | 3.19 | 3.19 | 3.19 |
| excited | | | | |
| triplet | | | | |
| energy (eV) | | | | |

By this, dependency of the HOMO value, LUMO value, lowest excited single energy and lowest excited triplet energy on the side chain length is believed to be small by calculation by the above-mentioned calculation method. Therefore, for the polymer compound 1-1, the side chain of a chemical structure as a calculation subject was simplified as OCH₃ and calculation was effected.

### SYNTHESIS EXAMPLE 7-12

### Synthesis of Polymer Compound 1-2

Here, the polystyrene reduced number-average molecular weight was measured by gel permeation chromatography (GPC: HLC-8220GPC, manufactured by Tosoh Corp. or SCL-10A, manufactured by Shimadzu Corp.) using tetrahydrofuran as a solvent.

Column: TOSOH TSKgel Super HM-H (two)+TSKgel Super H2000 (4.6 mm I.d.×15 cm), detector: RI (SHIMADZU RID-10A). The mobile phase used chloroform or tetrahydrofuran (THF).

### SYNTHESIS EXAMPLE 7

### Synthesis of Compound E

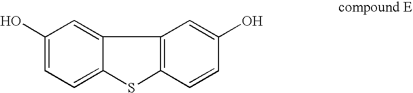

Under an inert atmosphere, 7 g of 2,8-dibromodibenzothiophene and 280 ml of THF were charged into a four-necked flask, stirred at room temperature for dissolution thereof, then, the solution was cooled down to −78° C. 29 ml of n-butyllithium (1.6 mol hexane solution) was dropped. After completion of dropping, the mixture was stirred for 2 hours while keeping the temperature, and 13 g of trimethoxyboronic acid was dropped. After completion of dropping, the temperature was returned to room temperature slowly. After stirring at room temperature for 3 hours, disappearance of a raw material was confirmed by TLC. 100 ml of 5% sulfuric acid was added to terminate the reaction, and the mixture was stirred at room temperature for 12 hours. Water was added to this and the solution was washed, and an organic layer was separated. The solvent was substituted by ethyl acetate, then, 5 ml of 30% hydrogen peroxide water was added and the mixture was stirred at 40° C. for 5 hours. Thereafter, an organic layer was separated, and washed by a 10% ammonium sulfate iron (II) aqueous solution, then, dried and a solvent was distilled off, to obtain 4.43 g of brown solid. As understood from LC-MS measurement, by-products such as a dimmer and the like were produced, and the purity of the compound E was 77% (LC basis).

MS (APCI(−)): (M−H)⁻ 215

### SYNTHESIS EXAMPLE 8

### Synthesis of Compound F

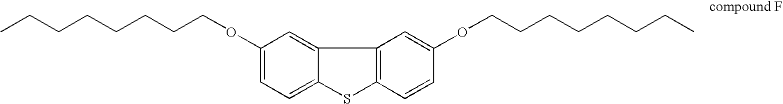

Under an inert atmosphere, 4.43 g of the compound E, 25.1 g of n-octyl bromide and 12.5 g (23.5 mmol) of potassium carbonate were charged in a 200 ml three-necked flask, and 50 ml of methyl isobutyl ketone was added as a solvent and the mixture was heated under reflux at 125° C. for 6 hours. After completion of the reaction, a solvent was distilled off, and chloroform and water were added to this, an organic layer was separated, further, washed twice with water. After drying over anhydrous sodium sulfate, purification by silica gel column (development solvent: toluene/cyclohexane=1/10) was performed, to obtain 8.49 g of a compound F (LC basis: 97%, yield: 94%).

¹H-NMR (300 MHz/CDCl₃,):

d0.91 (t, 6H), 1.31-1.90 (m, 24H), 4.08 (t, 4H), 7.07 (ss, 2H), 7.55 (d, 2H), 7.68 (d, 2H)

### SYNTHESIS EXAMPLE 9

### Synthesis of Compound G

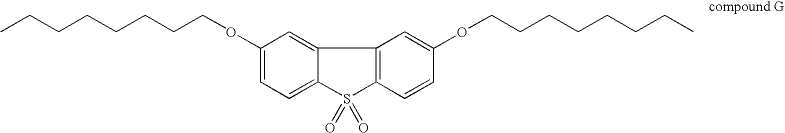

6.67 g of the compound F and 40 ml of acetic acid were charged into a 100 ml three-necked flask, and the mixture was heated up to a bath temperature of 140° C. in an oil bath. Subsequently, 13 ml of 30% hydrogen peroxide water was added through a cooling tube, the mixture was stirred vigorously for 1 hour, then, poured into 180 ml of cold water to complete the reaction. Extraction with chloroform, drying, and subsequent distillation off of a solvent, gave 6.96 g of a compound G (LC basis: 90%, yield: 97%).

¹H-NMR (300 MHz/CDCl₃,):

d0.90 (t, 6H), 1.26-1.87 (m, 24H), 4.06 (t, 4H), 7.19 (dd, 2H), 7.69 (d, 2H), 7.84 (d, 2H)

MS (APCI(+)): (M+H)⁺ 473

### SYNTHESIS EXAMPLE 10

### Synthesis of Compound H

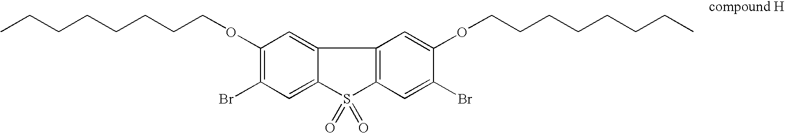

Under an inert atmosphere, 3.96 g of the compound G, and 15 ml of a mixed solution of acetic acid/chloroform=1/1 were added into a 200 ml four-necked flask, and the mixture was stirred at 70° C. for dissolution. A sodium thiosulfate aqueous solution was added to remove unreacted bromine, and chloroform and water were added, an organic layer was separated and dried. A solvent was distilled off, and purification by silica gel column (development solvent: chloroform/hexane=1/4) was performed, to obtain 4.46 g of a compound H (LC basis: 98%, yield: 84%).

¹H-NMR (300 MHz/CDCl₃,):

d0.95 (t, 6H), 1.30-1.99 (m, 24H), 4.19 (t, 4H), 7.04 (s, 2H), 7.89 (s, 2H)

MS (FD⁺)M⁺ 630

### SYNTHESIS EXAMPLE 11

### Synthesis of Compound J

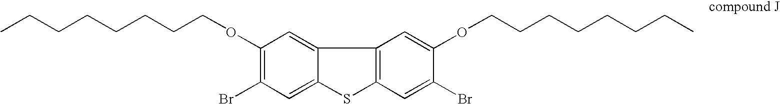

Under an inert atmosphere, 3.9 g of the compound H, and 50 ml of diethyl ether were added into a 200 ml four-necked flask, and the mixture was heated up to 40° C. and stirred. 1.17 g of lithium aluminum hydride was added portion-wise, and reacted for 5 hours. By adding water portion-wise, excess lithium aluminum hydride was decomposed and, washing with 5.8 ml of 36% hydrochloric acid was performed. Chloroform and water were added, and an organic layer was separated and dried. Purification by silica gel column (development solvent: chloroform/hexane=1/5) was performed, to obtain 1.8 g of a compound J (LC basis: 99%, yield: 49%).

¹H-NMR (300 MHz/CDCl₃,):

d0.90 (t, 6H), 1.26-1.97 (m, 24H), 4.15 (t, 4H), 7.45 (s, 2H), 7.94 (s, 2H)

MS (FD⁺)M⁺ 598

According to MS (APCI(+)) method, peaks were detected at 615 and 598.

### SYNTHESIS EXAMPLE 12

### Synthesis of Polymer Compound 1-2

400 mg of the compound J and 180 mg of 2,2′-bipyridyl were dissolved in 20 mL of dehydrated tetrahydrofuran, then, under a nitrogen atmosphere, to this solution was added 320 mg of bis(1,5-cyclooctadiene)nickel(0) {Ni(COD₂)}, the mixture was heated up to 60° C. and reacted for 3 hours. After the reaction, this reaction solution was cooled to room temperature, and dropped into a mixed solution of 25% ammonia solution 10 ml/methanol 120 ml/ion exchanged water 50 ml, and the mixture was stirred for 30 minutes, then, the deposited precipitate was filtrated and dried under reduced pressure for 2 hours, and dissolved in 30 ml of toluene. 30 mL of 1 N hydrochloric acid was added and the mixture was stirred for 3 hours, then, an aqueous layer was removed and to an organic layer was added 30 mL of a 4% ammonia solution and the mixture was stirred for 3 hours, then, an aqueous layer was removed. An organic layer was dropped into 150 ml of methanol and the mixture was stirred for 30 minutes, and the deposited precipitate was filtrated and dried under reduced pressure for 2 hours, and dissolved in 30 mL of toluene. Thereafter, purification was effected through an alumina column (alumina amount: 20 g), the recovered toluene solution was dropped into 100 mL of methanol and the mixture was stirred for 30 minutes, to deposit a precipitate. The deposited precipitate was filtrated and dried under reduced pressure for 2 hours. The yield of the resultant polymer compound I-2 was 120 mg.

The polymer compound I-2 had a polystyrene-reduced number-average molecular weight Mn=1.3×10⁵ and a polystyrene-reduced weight-average molecular weight Mw=2.8×10⁵.

Polymer compound 1-2: homopolymer substantially composed of the following repeating unit

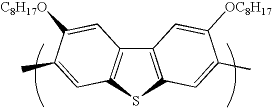

### EXAMPLE 2

A 0.8 wt % chloroform solution of a mixture prepared by adding the iridium complex A in an amount 5 wt % to the above-mentioned polymer compound I-2 was prepared, and a device was produced in the same manner as in Example 1. The spin coater rotation number in film formation was 2400 rpm, and the film thickness was about 84 nm.

By applying voltage on the resultant device, EL light emission showing a peak at 520 nm was obtained. The device showed light emission of 100 cd/m² at about 11 V. The maximum light emission efficiency was 2.7 cd/A.

The photoluminescence intensity ratio of the polymer compound I-2 to the iridium complex A was 0.16. Photoluminescence was measured using PR (manufactured by JOBINYVON-SPEX), and an ultraviolet lamp showing a brilliant line at 350 nm or less was used as an excitation light source.

### SYNTHESIS EXAMPLE 13

The iridium complex B was synthesized as described below.

### 1) Synthesis of Ligand 1

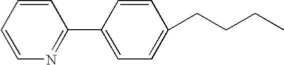

Under an argon atmosphere, 4.74 g (30 mmol) of 2-bromopyridine, 4.81 g (27 mmol) 4-butylphenylboronic acid, 5.18 g (37.5 mmol) of potassium carbonate, 18 ml of ion exchanged water and 20 ml of dehydrated toluene were charged, and argon bubbling was performed. 0.17 g (0.15 mmol) of Pd(PPh₃)₄ was charged, further, argon bubbling was performed. Heating under reflux was conducted for 7 hours, the mixture was cooled to room temperature, then, the reaction mass was added to 50 ml of ion exchanged water, and extraction with toluene, washing with saturated brine, drying of an organic layer over anhydrous mirabilite, and concentration, gave 6.30 g of a coarse product. Purification by silica gel column (development solvent: cyclohexane/toluene=1/4→1/6) was performed, to obtain 4.20 g of an intended substance (yield: 66.2%).

¹H-NMR (300 MHz/CDCl₃,):

d0.94 (t, 3H), 1.36-1.43 (m, 24H), 1.58-1.69 (m, 2H), 2.66 (t, 2H), 7.16-7.21 (m, 1H), 7.25-7.30 (m, 2H), 7.68-7.75 (m, 2H), 7.90-7.92 (m, 2H), 8.67 (d, 1H)

MS (APCI(+)): (M+H)⁺ 212

### 2) Synthesis of Iridium Complex B

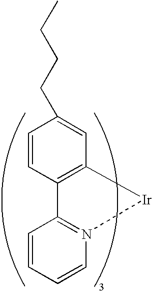

Under an argon atmosphere, 30 ml of glycerol was heated at 130° C., and argon bubbling was performed. 4.23 g (20 mmol) of the ligand 1, 2.45 g (5 mmol) of Ir(acac)₃ and 10 ml of 2-ethoxyethanol (dehydrated by molecular sieve) were charged, and the mixture was heated at 180° C. They were reacted for 47 hours, and cooled to room temperature, then, the reaction mass was charged into 300 ml of 1 N HCl, the deposited yellow powder was filtrated, to obtain 4.75 g of a coarse product. Purification by silica gel column (eluent: toluene) gave 0.72 g of an intended substance (yield: 16.4%).

¹H-NMR (300 MHz/CDCl₃,):

d0.84 (t, 9H), 1.18-1.30 (m, 6H), 1.41-1.50 (m, 6H), 2.28-2.43 (m, 6H), 6.69 (bs, 3H), 6.71 (bs, 6H), 6.77-6.81 (m, 3H), 7.47-7.54 (m, 9H), 7.78 (bd, 3H)

MS (APCI(+)): (M+H)⁺ 824

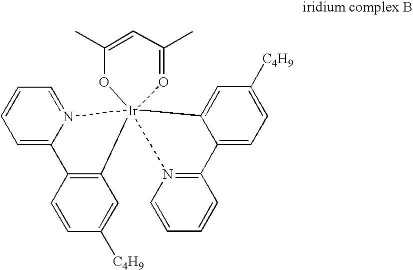

### EXAMPLE 3

A 2.0 wt % toluene solution of a mixture prepared by adding the above-mentioned iridium complex B in an amount 20 wt % to the above-mentioned polymer compound 1-1 was prepared, and a device was produced in the same manner as in Example 1. The spin coater rotation number in film formation was 700 rpm, and the film thickness was about 87 nm.

By applying voltage on the resultant device, EL light emission showing a peak at 516 nm was obtained. The device showed light emission of 100 cd/m² at about 9 V. The maximum light emission efficiency was 6.0 cd/A.

The lowest excited triplet energies calculated of the polymer compound 1-1 and the iridium complex B were 2.82 eV and 2.70 eV, respectively. The compound as calculation subject was the same as in Example 1.

### COMPARATIVE EXAMPLE 1

A 0.6% chloroform solution of a mixture prepared by adding the iridium complex A in an amount 5 wt % to the polymer compound R1 (polystyrene-reduced number-average molecular weight Mn=8.0×10⁴, polystyrene-reduced weight-average molecular weight Mw=3.0×10⁵) was prepared, and a device was produced in the same manner as in Example 1. The spin coater rotation number in film formation was 2600 rpm, and the film thickness was about 90 nm. By applying voltage on the resultant device, EL light emission showing a peak at 508 nm was obtained, however, the maximum light emission efficiency of the device was as low as 0.12 cd/A.

Polymer compound R1: homopolymer substantially composed of the following repeating unit

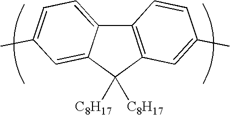

The lowest excited triple energy of the polymer compound R-1 calculated in the same manner as in Example 1 was 2.55 eV which was smaller than 2.76 eV, calculated value of the iridium complex A.

The chemical structure as calculation subject was

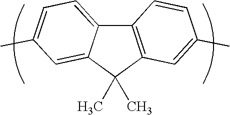

because of the same idea as in Example 1.

The photoluminescence intensity ratio of the polymer compound R1 and the iridium complex A calculated in the same manner as in Example 2 was 26.7.

The polymer compound R1 was synthesized by a method described in U.S. Pat. No. 6,512,083.

### SYNTHESIS EXAMPLE 14

The iridium complex C was synthesized as described below.

### EXAMPLE 4

1.2 wt % toluene solution of a mixture prepared by adding the above-mentioned iridium complex C in an amount of 1 wt % to the above-mentioned polymer compound 1-1 was prepared, and a device was produced in the same manner as in Example 1. The spin coater rotation number in film formation was 1000 rpm and the film thickness was about 80 nm.

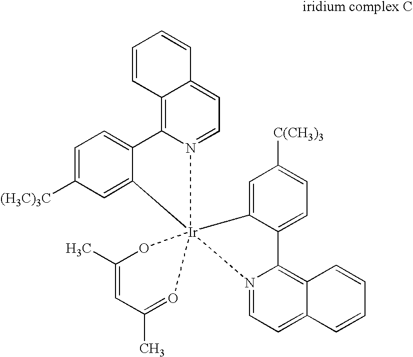

By applying voltage on the resultant device, EL light emission showing a peak at 625 nm was obtained. The device showed light emission of 100 cm/m² at a voltage of about 11 V. The maximum light emission efficiency was 2.3 cd/A.

The lowest excited triplet energies calculated of the polymer compound 1-1 and the iridium complex C were 2.82 eV and 2.26 eV, respectively. The lowest excited triplet energy of the iridium complex C was calculated as the following unsubstituted body in the same manner as for the iridium complex A in Example 1.

The iridium complex C was synthesized by a method described in WO03-040256A2.

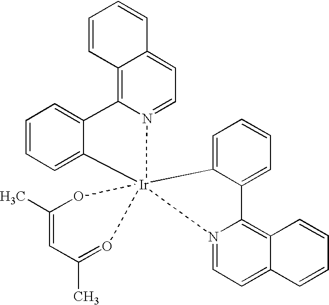

### INDUSTRIAL APPLICABILITY

An light emitting device using the light emitting material of the present invention in a light emitting layer is excellent in light emission efficiency. Therefore, the light emitting material of the present invention can be used suitably for light emitting materials of polymer LED, and the like, and can be used as a material of polymer light emitting devices, organic EL devices using the same, and the like.

1. A light emitting material comprising a conjugated polymer compound (A) containing an aromatic ring in the main chain and a compound (B) showing light emission from the triplet excited state, wherein an energy difference between the vacuum level and the lowest unoccupied orbital (LUMO) level in the ground state, calculated by a computational chemical means, is 1.3 eV or more, or an energy difference between the vacuum level and the lowest unoccupied orbital (LUMO) level in the ground state, experimentally measured, is 2.2 eV or more, in the polymer compound (A), and either the following (Condition 1) or the following (Condition 2) or both of them are satisfied:
(Condition 1): Energy (ES_{A0}) in the ground state of the polymer compound (A), energy (ET_{A}) in the lowest excited triplet state of the polymer compound (A), energy (ES_{B0}) in the ground state of the compound (B) and energy (ET_{B}) in the lowest excited triplet state of the compound (B) satisfy the relation (Eq 1):
ET_{A}−ES_{A0}>ET_{B}−ES_{B0} (Eq1);
(Condition 2): The ratio PL_{A}/PL_{B} of photoluminescence intensity (PL_{A}) of the polymer compound (A) to photoluminescence intensity (PL_{B}) of the compound (B) showing light emission from the triplet excited state is 0.8 or less.

2. The light emitting material according to claim 1, wherein an energy difference ET_{AB} between energy ET_{A} in the lowest excited triplet state calculated by a computational chemical means of the polymer compound (A) and energy ET_{B} in the lowest excited triplet state of the compound (B), and a difference EH_{AB} between highest monopolized orbital (HOMO) energy EH_{A} in the ground state of the polymer compound (A) and HOMO energy EH_{B} in the ground state of the compound (B) satisfy the relation (Eq2):
ET_{AB}≧EH_{AB} (Eq2).

3. The light emitting material according to claim 1, wherein an energy difference ES_{AB1} between energy ES_{A1} in the lowest excited singlet state calculated by a computational chemical means of the polymer compound (A) and energy ES_{B1} in the lowest excited singlet state of the compound (B), and a difference EH_{AB} between HOMO energy EH_{A} in the ground state of the polymer compound (A) and HOMO energy EH_{B} in the ground state of the compound (B) satisfy the relation (Eq3):
ES_{AB1}≧EH_{AB} (Eq3).

4. The light emitting material according to claim 1, wherein energy ET_{A} in the lowest excited triplet state calculated by a computational chemical means of the polymer compound (A) is 2.6 eV or more, or the EL light emission peak wavelength thereof is 550 nm or less.

5. The light emitting material according to claim 1, wherein the conjugated polymer compound (A) containing an aromatic ring in the main chain has a structure originated from the compound (B) showing light emission from the triplet excited state.

6. The light emitting material according to claim 1, wherein the polymer compound (A) contains a repeating unit of the following general formula (1): 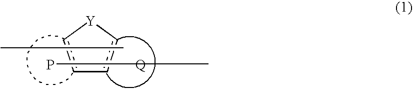
(wherein, Ring P and Ring Q each independently represent an aromatic ring, but Ring P may be either existent or non-existent;
when Ring P is existent, two connecting bonds respectively are on Ring P and/or Ring Q, and when Ring P is non-existent, two connecting bonds respectively are on 5 membered ring containing Y, and/or Ring Q;
the aromatic ring and/or the 5-membered ring containing Y may carry a substituent selected from the group consisting of alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atoms, acyl group, acyloxy group, imine residues, amide group, acid imide group, monovalent heterocyclic group, carboxyl group, substituted carboxyl group and cyano group; and
Y represents —O—, —S—, —Si(R₁)(R₂)—, —P(R₃)— or —PR₄(═O)—, and R₁, R₂, R₃ and R₄ each independently represent an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, silyloxy group, substituted silyloxy group, monovalent heterocyclic group or halogen atom).

7. The light emitting material according to claim 6, wherein the repeating unit of the above-mentioned formula (1) is a repeating unit of the following formula (1-1), (1-2) or (1-3): 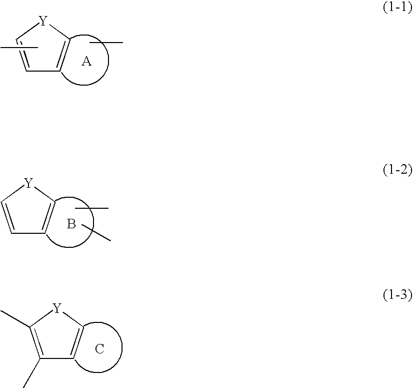
(wherein, ring A, ring B and ring C each independently represent an aromatic ring;
formulae (1-1), (1-2) and (1-3) may each carry a substituent selected from the group consisting of alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atoms, acyl group, acyloxy group, imine residues, amide group, acid imide group, monovalent heterocyclic group, carboxyl group, substituted carboxyl group and cyano group; and
Y represents the same meaning as described above).

8. The light emitting material according to claim 6, wherein the repeating unit of the above-mentioned formula (1) is a repeating unit of the following formula (1-4) or (1-5): 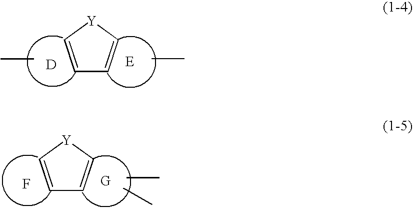
(wherein, ring D, ring E, ring F and ring G each independently represent an aromatic ring optionally carrying a substituent selected from the group consisting of alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atoms, acyl group, acyloxy group, imine residues, amide group, acid imide group, monovalent heterocyclic group, carboxyl group, substituted carboxyl group and cyano group; and
Y represents the same meaning as described above).

9. The light emitting material according to claim 6, wherein Y represents an O atom or a S atom.

10. The light emitting material according to claim 6, wherein the ring P, ring Q, ring A, ring B, ring C, ring D, ring E, ring F and ring G represent an aromatic hydrocarbon ring.

11. The light emitting material according to claim 8, wherein the repeating unit of the above-mentioned formula (1-4) is a repeating unit of the following formula (1-6): 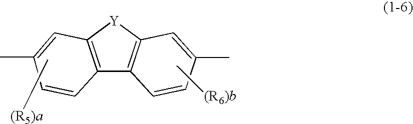
(wherein, R₅ and R₆ each independently represent an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, acyloxy group, imine residue, amide group, acid imide group, monovalent heterocyclic group, carboxyl group or substituted carboxyl group;
a and b each independently represent an integer of 0 to 3;
when R₅ and R₆ are present each in plural number, they may the same or different; and
Y represents the same meaning as described above).

12. The composition according to claim 6, wherein the polymer compound has further a repeating unit of the following formula (2), formula (3), formula (4) or formula (5): 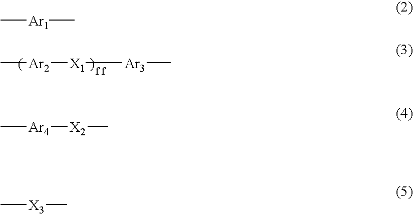
(wherein, Ar₁, Ar₂, Ar₃ and Ar₄ each independently represent an arylene group, divalent heterocyclic group or divalent group having a metal complex structure;
X₁, X₂ and X₃ each independently represent —CR₁₅═CR₁₆—, —C≡C—, —N(R₁₇)— or —(SiR₁₈R₁₉)ₘ;
R₁₅ and R₁₆ each independently represent a hydrogen atom, alkyl group, aryl group, monovalent heterocyclic group, carboxyl group, substituted carboxyl group or cyano group;
R₁₇, R₁₈ and R₁₉ each independently represent a hydrogen atom, alkyl group, aryl group, monovalent heterocyclic group, arylalkyl group or substituted amino group;
ff represents 1 or 2. m represents an integer of 1 to 12; and
when R₁₅, R₁₆, R₁₇, R₁₈ and R₁₉ are present each in plural number, they may be the same or different).

13. The light emitting material according to claim 12, wherein the repeating unit of the above-mentioned formula (2) is a repeating unit of the following formula (6), (7), (8), (9), (10) or (11): 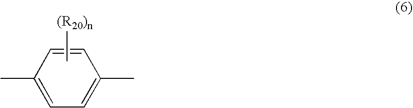
(wherein, R₂₀ represents an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group or cyano group;
n represents an integer of 0 to 4;
when a plurality of R₂₀s are present, they may be the same or different) 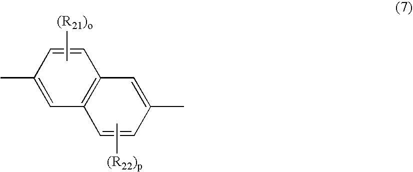
(wherein, R₂₁ and R₂₂ each independently represent an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group or cyano group;
o and p each independently represent an integer of 0 to 3;
when R₂₁ and R₂₂ are present each in plural number, they may be the same or different) 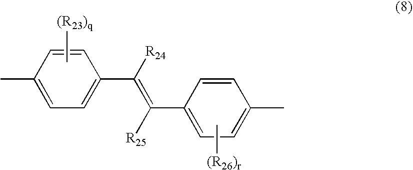
(wherein, R₂₃ and R₂₆ each independently represent an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group or cyano group;
q and r each independently represent an integer of 0 to 4;
R₂₄ and R₂₅ each independently represent a hydrogen atom, alkyl group, aryl group, monovalent heterocyclic group, carboxyl group, substituted carboxyl group or cyano group,
when R₂₃ and R₂₆ are present in plural number, they may be the same or different) 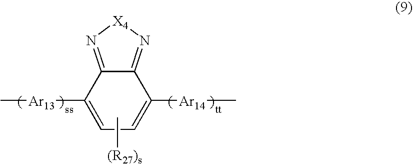
(wherein, R₂₇ represents an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group or cyano group;
s represents an integer of 0 to 2;
Ar₁₃ and Ar₁₄ each independently represent an arylene group, divalent heterocyclic group or divalent group having a metal complex structure. ss and tt each independently represent 0 or 1;
X₄ represents O, S, SO, SO₂, Se or Te;
when a plurality of R₂₇s are present, they may be the same or different) 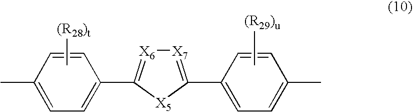
(wherein, R₂₈ and R₂₉ each independently represent an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group or cyano group;
t and u each independently represent an integer of 0 to 4;
X₅ represents O, S, SO₂, Se, Te, N—R₃₀ or SiR₃₁R₃₂. X₆ and X₇ each independently represent N or C—R₃₃. R₃₀, R₃₁, R₃₂ and R₃₃ each independently represent a hydrogen atom, alkyl group, aryl group, arylalkyl group or monovalent heterocyclic group;
when R₂₈, R₂₉ and R₃₃ are present in plural number, they may be the same or different) 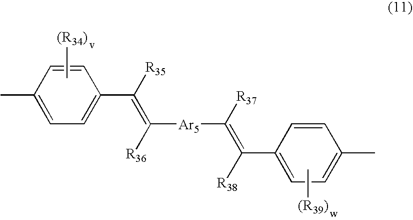
(wherein, R₃₄ and R₃₉ each independently represent an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group or cyano group;
v and w each independently represent an integer of 0 to 4;
R₃₅, R₃₆, R₃₇ and R₃₈ each independently represent a hydrogen atom, alkyl group, aryl group, monovalent heterocyclic group, carboxyl group, substituted carboxyl group or cyano group;
Ar₅ represents an arylene group, divalent heterocyclic group or divalent group having a metal complex structure and
when R₃₄ and R₃₉ are present in plural number, they may be the same or different).

14. The light emitting material according to claim 12, wherein the repeating unit of the above-mentioned formula (3) is a repeating unit of the following formula (13): 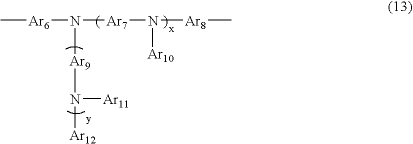
(wherein, Ar₆, Ar₇, Ar₈ and Ar₉ each independently represent an arylene group or divalent heterocyclic group;
Ar₁₀, Ar₁₁ and Ar₁₂ each independently represent an aryl group or monovalent heterocyclic group;
Ar₆, Ar₇, Ar₈, Ar₉ and Ar₁₀ may have a substituent;
x and y each independently represent 0 or 1, and 0≦x+y≦1).

15. The light emitting material according to claim 1, further comprising at least one kind of material selected from a hole transporting material, electron transporting material and light emitting material.

16. An ink composition comprising the light emitting material according to claim 1.

17. The ink composition according to claim 16, wherein the viscosity at 25° C. is 1 to 100 mPa·s.

18. A polymer light emitting device having a layer containing the light emitting material according to claim 1 between electrodes composed an anode and a cathode.

19. A light emitting thin film comprising the light emitting material according to claim 1.

20. An electrically conductive thin film comprising the light emitting material according to claim 1.

21. An organic semiconductor thin film comprising the light emitting material according to claim 1.

22. A polymer light emitting device having an organic layer between electrodes composed of an anode and a cathode wherein the organic layer contains the light emitting material according to claim 1.

23. The polymer light emitting device according to claim 22, wherein the organic layer is a light emitting layer.

24. The polymer light emitting device according to claim 23, wherein the light emitting layer further comprises a hole transporting material, electron transporting material or light emitting material.

25. A sheet light source using the polymer light emitting device according to claim 22.

26. A segment display using the polymer light emitting device according to claim 23.

27. A dot matrix display using the polymer light emitting device according to claim 22.

28. A liquid crystal display using the polymer light emitting device according to claim 22 as back light.

29. An illumination using the polymer light emitting device according to claim 22.
